(19) United States
(12) Patent Application Publication
(10) Pub. No.: US 2015/0310756 A1
(43) Pub. Date: Oct. 29, 2015

(54) SYSTEM FOR SUPPORTING EDUCATION AND INFORMATION TERMINAL

(71) Applicants: Hideki NAKAMURA, Tokyo (JP); Tetsuo NAKANO, Tokyo (JP); Katsuya MIYATA, Tokyo (JP); Yusaku KATSUBE, Tokyo (JP); Masaaki YAMADA, Tokyo (JP)

(72) Inventors: Hideki NAKAMURA, Tokyo (JP); Tetsuo NAKANO, Tokyo (JP); Katsuya MIYATA, Tokyo (JP); Yusaku KATSUBE, Tokyo (JP); Masaaki YAMADA, Tokyo (JP)

(73) Assignee: Hitachi Maxell, Ltd.

(21) Appl. No.: 14/374,826

(22) PCT Filed: Sep. 12, 2012
(86) PCT No.: PCT/JP2012/073249

§ 371 Date: Nov. 6, 2014

(30) Foreign Application Priority Data
Jan. 30, 2012 (JP) 2012-016078

(51) Int. Cl. G09B 7/02; H04L 29/08; H04L 29/06

(52) U.S. Cl. CPC G09B 7/02; H04L 65/403; H04L 67/10

(57) ABSTRACT

A learner's terminal is provided with a time acquiring unit for acquiring time, an input unit capable of carrying out a handwriting input, and answer input history data notifying unit for use in notifying a school server of the time acquired by the time acquiring unit and handwriting input data inputted thereto by the input unit as answer input history data, and the school server is provided with an answer input history data storage unit for storing the answer input history data notified by the learner's terminal and an answer input history data transmitting unit for transmitting the answer input history data stored in the answer input history data storage unit to an instructor's terminal, while the instructor's terminal is provided with an answer screen display unit for displaying a screen at the time of answering in time series based upon the answer input history data transmitted by the answer input history data transmitting unit.

### TECHNICAL FIELD

The present invention relates to a system for supporting education and an information terminal.

### BACKGROUND ART

As a method for supporting school education, a teaching material delivery system, a teaching material delivery device and a teaching material delivery method have been proposed in Japanese Patent Application Laid-Open Publication No. 2002-149842 (Patent Document 1).

### CITATION LIST

### Patent Literature

Patent Document 1: Japanese Patent Application Laid-Open Publication No. 2002-149842

### DISCLOSURE OF THE INVENTION

### Problems to be Solved by the Invention

In recent years, together with developments of informization in daily life, there have been demands for informization in education.

For this reason, an aim of the present invention is to provide an education supporting system and an information terminal that are beneficial for informized education.

### Means for Solving the Problems

To achieve the above-mentioned aim, the present invention uses a configuration described, for example, in the claims.

The invention according to the present application includes a plurality of means for achieving the above-mentioned aim, and one example of its features is having “an education supporting system including a learner's terminal for use by a learner, an instructor's terminal for use by an instructor and a school server capable of communicating with the terminals. The learner's terminal is provided with a time-acquiring means for acquiring time, an input means capable of accepting a hand-writing input, and an answer-input history data notifying means for notifying the school server of the time acquired by the time-acquiring means and the hand-writing input data inputted through the input means as answer input history data. The school server is provided with an answer input history data storage means for storing the answer input history data notified by the learner's terminal and an answer input history data transmitting means for transmitting the answer input history data stored by the answer input history data storage means to the instructor's terminal so that the instructor's terminal is provided with an answer screen display means for displaying a screen at the time of answering in time series based upon the answer input history data transmitted by the answer input history data transmitting means”.

### Effects of the Invention

In accordance with the present invention, it is possible to provide an education supporting system and an information terminal that are beneficial for informized education.

Subjects, configurations and effects other than those described above will be clarified by the following description of embodiments.

### BRIEF DESCRIPTIONS OF THE DRAWINGS

FIG. 1 is a diagram that shows one example of a configuration of an education supporting system;

FIG. 2 is a diagram that shows one example of a functional configuration of a learner's terminal;

FIG. 3 is a diagram that shows one example of a functional configuration of an instructor's terminal of school;

FIG. 4 is a diagram that shows one example of a functional configuration of a parent's terminal;

FIG. 5 is a diagram that shows one example of a functional configuration of an instructor's terminal of a cramming school;

FIG. 6 is a diagram that shows one example of a functional configuration of a school server;

FIG. 7 is a diagram that shows on example of a functional configuration of a publisher server;

FIG. 8 is a diagram that shows one example of a functional configuration of an administration server;

FIG. 9 is a diagram that shows one example of a functional configuration of a cramming-school server;

FIG. 10 is a diagram that shows one example of a functional configuration of an electronic black board;

FIG. 11 is a diagram that shows one example of an initial setting process prior to distribution;

FIG. 12 is a diagram that shows one example of an initial setting process after distribution;

FIG. 13 is a diagram that shows one example of information to be stored by a storage unit of a school server;

FIG. 14 is a diagram that shows one example of server specific information;

FIG. 15 is a diagram that shows one example of information to be stored by a storage unit of a learner's terminal;

FIG. 16 is a diagram that shows one example of terminal specific information;

FIG. 17 is a diagram that shows one example of a normal learning process;

FIG. 18 is a diagram continued from FIG. 17;

FIG. 19 is a diagram continued from FIG. 18;

FIG. 20 is a diagram continued from FIG. 19;

FIG. 21 is a diagram that shows one example of time-table information for a learner;

FIG. 22 is a diagram that shows one example of time-table information for an instructor;

FIG. 23 is a diagram that shows one example of presence/absence information;

FIGS. 24A-24D are diagrams that show display examples of an instructor's terminal and an electronic black board respectively;

FIGS. 25E and 25F are diagrams that show display examples of a learner's terminal, an instructor's terminal and an electronic black board 21 respectively;

FIG. 26 is a diagram that shows one example of a cooperative learning group setting process;

FIG. 27 is a diagram that shows one example of a cooperative learning process;

FIG. 28 is a diagram that shows one example of a process at the time of demonstrating the cooperative learning process;

FIG. 29A is a diagram that shows one example of document data by the learner's own making;

FIG. 29B is a diagram that shows another example of document data by the learner's own making;

FIG. 30 is a diagram that shows one example of group document data;

FIG. 31 is a diagram that shows one example of a test examination process;

FIG. 32 is a diagram that follows FIG. 31;

FIG. 33 is a diagram that shows one example of a test mode setting process;

FIG. 34 is a diagram that shows one example of a test mode releasing process;

FIG. 35 is a diagram that shows one example of a configuration of a system in the school;

FIG. 36 is a diagram that shows one example of an achievement processing;

FIG. 37 is a diagram that shows one example of achievement report card data;

FIG. 38 is a diagram that shows one example of a homework learning process;

FIG. 39 is a diagram that shows one example of published achievement information;

FIG. 40 is a diagram that shows a display example of a homework list;

FIG. 41 is a diagram that shows a display example of a level of achievement for homework;

FIG. 42 is a diagram that shows a display example of leaning history;

FIG. 43 is a diagram that shows one example of a learner information updating process;

FIG. 44 is a diagram that follows FIG. 43;

FIG. 45 is a diagram that shows one example of a learning state registering process;

FIG. 46 is a diagram that shows one example of a system in the school;

FIG. 47 is a diagram that shows one example of a library lending service history registering process;

FIG. 48 is a diagram that shows one example of an achievement information acquiring process;

FIG. 49 is a diagram that shows one example of an achievement information referring process;

FIG. 50 is a diagram that shows one example of an accessing right for achievement information;

FIG. 51 is a diagram that shows one example of a photograph sharing process;

FIG. 52 is a diagram that shows a display example of a plurality of learner's terminals that share photographs;

FIG. 53 is a diagram that shows one example of a text book purchasing process;

FIG. 54 is a diagram that shows one example of a text book managing table;

FIG. 55 is a diagram that shows one example of a reference book purchasing process;

FIG. 56 is a diagram that shows one example of an access-limiting process;

FIG. 57 is a diagram that shows one example of an access-limiting management table;

FIG. 58 is a diagram that shows one example of a functional configuration of a learner's terminal;

FIG. 59 is a diagram that shows one example of a functional configuration of an instructor's terminal in school;

FIG. 60 is a diagram that shows one example of a functional configuration of a school server;

FIG. 61 is a diagram that shows one example of an answer input history displaying process;

FIG. 62 is a diagram that shows one example of an answer input screen displayed on the learner's terminal;

FIG. 63 is a diagram that shows one example of an answering process to be processed in an answer input history data generation unit;

FIG. 64 is a diagram that shows another example of the answering process to be processed in the answer input history data generation unit;

FIG. 65 is a diagram that shows one example of data configuration of answer input history data;

FIG. 66 is a diagram that shows one example of data configuration of the input history data;

FIG. 67 is a diagram that shows one example of input data of the input history data;

FIG. 68 is a diagram that shows another example of input data of the input history data;

FIG. 69 is a diagram that shows the other example of input data of the input history data;

FIG. 70 is a diagram that shows one example of data configuration for calling for answer input history data transmitted from an instructor's terminal;

FIG. 71 is a diagram that shows one example of an answer display screen displayed on the instructor's terminal;

FIG. 72 is a diagram that shows one example of an answer sheet displaying process;

FIG. 73 is a diagram that shows one example of a writing history generation process;

FIG. 74 is a diagram that shows one example of data configuration of writing history data;

FIG. 75 is a diagram that shows one example of an answer sheet display updating process;

FIG. 76 is a diagram that shows one example of a display of seek bars displayed on an instructor's terminal;

FIG. 77 is a diagram that shows one example of an answer sheet display seek updating process;

FIG. 78 is a diagram that shows another example of the answer sheet display seek updating process;

FIG. 79 is a diagram that shows the other example of the answer sheet display seek updating process;

FIG. 80 is a diagram that shows one example of input data of input history data;

FIG. 81 is a diagram that shows one example of a hand-writing input result imaging process;

FIG. 82 is a diagram that shows one example of input data generated by the hand-writing input result imaging process;

FIG. 83 is a diagram that shows one example of a functional configuration of the learner's terminal;

FIG. 84 is a diagram that shows one example of a functional configuration of the school server; and

FIG. 85 is a diagram that shows one example of a functional configuration of the learner's terminal.

### BEST MODE FOR CARRYING OUT THE INVENTION

Referring to the drawings, embodiments according to the present invention will be described.

### Embodiment 1

In the present embodiment, explanations will be given on specific examples of an initial setting process that makes a learner's terminal usable.

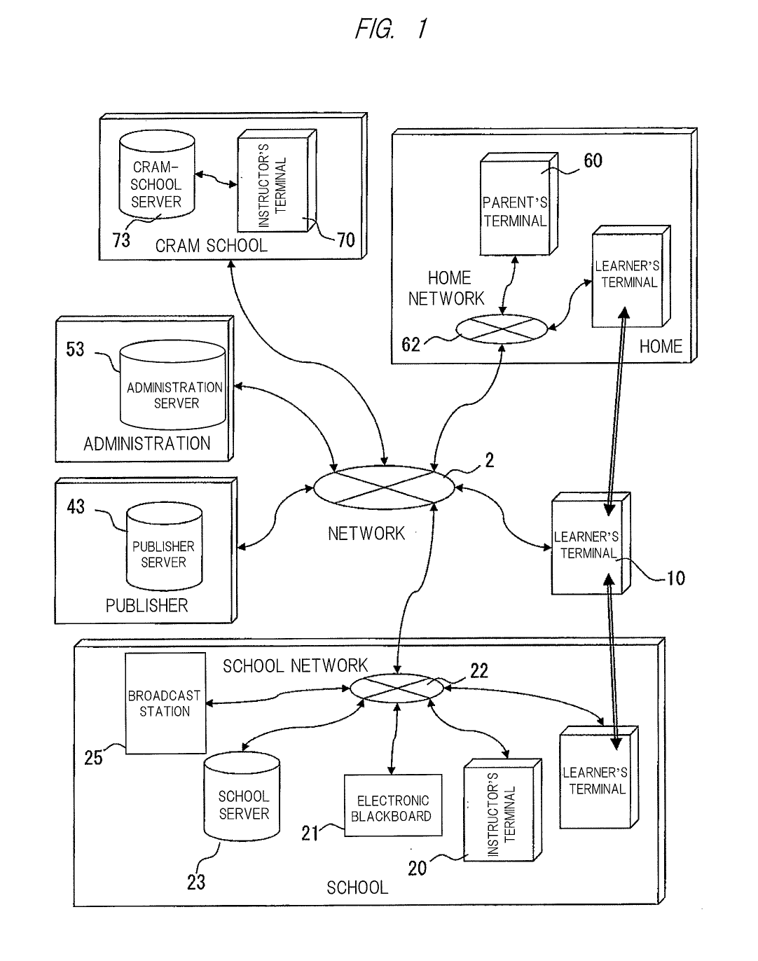

FIG. 1 is a diagram that shows one example of a configuration of an education supporting system relating to the present embodiment.

A network 2 shown in FIG. 1 is a communication network using internet protocols, such as WAN (Wide Area Network), LTE (Long Term Evolution), HSPA (High Speed Packet Access), WiMAX (Worldwide Interoperability for Microwave Access) and the like, and is provided with learner's terminals 10, a network 22 in the school, a home network 62, a publisher server 43, an administration server 53, a cram-school server 73 and the like that are mutually connected to one another and transmit/receive information.

The learner's terminal 10 is a portable information terminal provided with a display means capable of displaying information, an input means capable of inputting information, a communication means capable of communicating with another device or apparatus, a computing means capable of computing information and the like, and is mainly used for allowing children, students and other learners to study. The learner's terminals 10 are connected to the network 2, the network 22 in the school and the home network 62 so as to transmit/receive information.

An instructor's terminal 20 is a portable information terminal provided with the means similar to those of the learner's terminal 10, and is mainly used by instructors in school, such as teachers, professors, lecturers and the like for the purposes of education. The instructor's terminals 20 are connected to the network 22 in the school so as to transmit/receive information.

An electronic blackboard 21, which is provided with a display means, an input means and a communication means or the like, receives an instruction from the learner's terminal 10 or the instructor's terminal 20, and acquires information transmitted from the learner's terminal 10 or the instructor's terminal 20 through the network 22 in the school and carries out a displaying process so as to allow the learners and instructors to refer the information.

The network 22 in the school, which is a communication network dedicated to a school, such as a cable LAN (Local Area Network), wireless LAN, LTE, WiMAX or the like, is mutually connected to the network 2, the learner's terminals 10, the instructor's terminals 20, the electronic blackboard 21 and the school server 23 so as to transmit/receive information.

The school server 23, which is a server dedicated to a school, is connected to the learner's terminals 10, the instructor's terminals 20 and the electronic blackboard 21 or the like through the network 22 in the school so as to transmit/receive information. Additionally, the school server 23 stores text book data, learner's data, instructor's data and the like. The school server 23 is not necessarily required to be installed in a school, and may be installed outside the school, such as a data center or the like. In this case, the school server 23 can be more easily maintained by a business company.

The publisher server 43, which is a server dedicated to a publisher, is connected to the learner's terminals 10, stores text book data and reference book data or the like, and is connected to the learner's terminals 10 through the network 2 so that information is mutually transmitted and received. For example, the publisher server 43 delivers text book data to the learner's terminals 10.

The administration server 53, which is a server dedicated to an administrative office, and provided with a basic resident register network system or the like, and stores management information of the board of education, published information or the like, is connected to the learner's terminals 10, the parent's terminals 60, the instructor's terminals 20 as well as instructor's terminals 70, the school server 23, the publisher server 43 and the cram-school server 73 through the network 2 so as to transmit/receive information.

The parent's terminal 60 is a portable information terminal provided with means similar to those of the learner's terminal 10, and is mainly used by a guardian, such as a parent or the like of the learner. The parent's terminal 60 is connected to the home network 62 so as to mutually transmit/receive information.

The home network 62 is a communication network dedicated to home use, such as a cable LAN, wireless LAN, LTE, WiMAX or the like, and mutually connected to the network 2, the learner's terminals 10 and the instructor's terminals 20 so that information is mutually transmitted and received.

The instructor's terminal 70 is a portable information terminal provided with similar means as those of the learner's terminal 10, and is mainly used by an instructor in a cram-school for the purposes of education in the cram-school. The instructor's terminal 70 is connected to a cram-school server 73 so as to mutually transmit/receive information. The cram-school server 73 is a server dedicated to cram-schools, and stores text book data, learning achievement level information and the like.

A broadcast station 25 is a broadcasting facility capable of broadcasting widely, and connected to the network 22 in the school, and transmits and receives signals for full-segment broadcasting, one-segment broadcasting, or multi-media broadcasting.

Additionally, although not illustrated in the drawings, the instructor's terminal 20 and the parent's terminal 60 may be connected to the network 2. Moreover, in an example of FIG. 1, the instructor's terminal 20 and the parent's terminal 60 are configured so as to be connected to the network 22 in the school and the home network 62; however, not limited by this configuration, these may be connected to the network 2 by using a wireless communication means, such as LTE, WiMAX or the like, for example, in the same manner as in the learner's terminal 10. Moreover, the learner's terminal 10 and the instructor's terminal 20 or the instructor's terminal 70 may be connected to each other by using means for directly carrying out transmitting/receiving processes of information, without using various networks.

Although the learner's terminal 10, the instructor's terminal 20, the parent's terminal 60 and the instructor's terminal 70 of the present embodiment have been explained as portable devices, these are not necessarily required to be portable devices, and may be prepared as stationary devices.

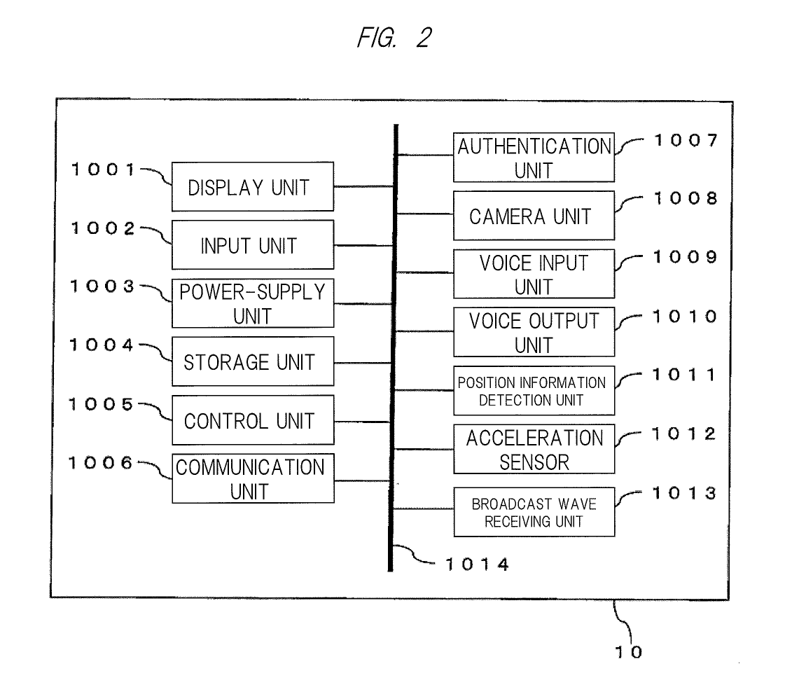

FIG. 2 is a diagram that shows one example of a functional configuration of the learner's terminal 10.

The learner's terminal 10 is provided with a display unit 1001, an input unit 1002, a power supply unit 1003, a storage unit 1004, a control unit 1005, a communication unit 1006, a certification unit 1007, a camera unit 1008, a voice input unit 1009, a voice output unit 1010, a position information detection unit 1011, an acceleration sensor 1012, a broadcast wave receiving unit 1013 and a bus 1014.

The display unit 1001 is composed of a panel, such as a liquid crystal display, an organic EL (Electro-Luminescence) display, an electronic paper, or the like, as well as a driver circuit and the like, and displays desired information (for example, characters, still images, motion images, etc.) under control by the control unit 1005. Additionally, the display unit 1001 may have a plurality of panels capable of displaying respectively different pieces of information.

The input unit 1002 is provided with one or a plurality of key boards, mice, cursor keys and ten keys, or the like, and upon receipt of an operation of the user, it inputs an input signal to the control unit 1005 based upon the operation. Additionally, by generating an input signal based upon a voice recognition, an image recognition, or a gesture recognition or the like, the resulting signal may be inputted to the control unit 1005. Moreover, a configuration, such as a touch panel, in which the display unit 1001 and the input unit 1002 are integrally combined, may be used.

The power supply unit 1003 is composed of a battery, an AC adopter and a charging circuit, or the like, and carries out a power supply to the respective units of the learner's terminal 10 and a charging process to the battery. It also carries out a state confirmation as to whether the learner's terminal 10 is battery-driven or AC-adopter-driven, and a remaining-amount confirmation of the battery.

The storage unit 1004, which is composed of a memory built in the learner's terminal 10, a detachable external memory or the like, stores various kinds of information. For example, it stores an operation-controlling program to be executed by the control unit 1005.

The control unit 1005, which is composed of a CPU (Central Processing Unit), an MPU (Micro Processing Unit) and a DSP (Digital Signal Processor) or the like, controls operations of the entire learner's terminal 10 by executing predetermined operation-controlling programs or the like.

The communication unit 1006, which is provided with wireless communication functions, such as a wireless LAN, Bluetooth (registered trademark), infrared ray communication, IC tag functions, Transfer JET (registered trademark), LTE, HSPA (High Speed Packet Access), EV-DO (Evolution Data Only) and WiMAX, or the like, or cable communication functions, such as Ethernet (registered trademark) or the like, transmits/receives various kinds of information. The wireless communication function includes an antenna and a modulation/demodulation circuit, or the like. The cable communication function includes a connector and a modulation/demodulation circuit, or the like. The information transmitting and receiving operations may be carried out by using a network (2, 22 or 62 in FIG. 1), or may be directly carried out among respective apparatuses without using a network. The communication unit 1006 may be configured in such a manner as to be compatible with a plurality of communication systems.

The authentication unit 1007 carries out an authentication process as to whether a user is a registered user or not by using an authentication system, such as a password authentication, a finger-print authentication, a finger-vein authentication, a handwriting authentication, a face authentication, a voice authentication and an iris authentication, or the like. The authentication unit 1007 is provided with a function for acquiring information inputted by the user for authentication (password, finger-print data, finger-vein data, handwriting data, face image data, voice data, iris data, or the like) in accordance with the authentication system. Depending on the authentication system, certification information may be inputted through the input unit 1002, the camera 1008 or the voice input unit 1009. The authentication unit 1007 is preferably provided with a storage region having a high degree of tamper resistance separated from the storage unit 1004 in order to preliminarily store authentication information of registered users.

The camera unit 1008 is provided with an image-pickup device including optical parts such as a lens or the like and an image processing device or the like. The camera unit 1008 carries out an image pickup process so as to acquire image data, such as still images and motion pictures, under control of the control unit 1005.

The voice input unit 1009 is provided with a microphone or the like, and collects voice signals at the time of communication or the like, and supplies the resulting data to the communication unit 1006.

The voice output unit 1010 is provided with a speaker, an earphone jack and a DAC (Digital Analog Converter) or the like, and carries out a DA conversion on voice signals received from, for example, the communication unit 1006, and discharges the resulting sound through the speaker.

The position information detection unit 1011 acquires information indicating the current position (hereinafter, referred to as “position information”) of the learner's terminal 10 by using the GPS (Global Positioning System), IMES (Indoor Messaging System) or wireless LAN, or the like.

The acceleration censor 1012 acquires information relating to acceleration (hereinafter, referred to as “acceleration information”) of the learner's terminal 10. Based upon the acceleration information thus acquired, it is possible to detect a state (rotating, falling and vibrating states or the like) of the learner's terminal 10.

The broadcast wave receiving unit 1013 is provided with an antenna, a tuner and a decoder, and receives signals, such as full-segment broadcasting signals, one-segment broadcasting signals, or multi-media broadcasting signals, transmitted from the broadcast station 25, and demodulates and decodes the signals. Additionally, in the case when the received signal is encoded, the broadcast wave receiving unit 1013 also carries out a process for decoding the signal.

The bus 1014 forms transmission paths through which respective parts mutually transfer signals.

Additionally, the instructor's terminal 20 in school, the parent's terminal 60 and the instructor's terminal 70 in cram-school have the same functional configurations as those of the learner's terminal 10.

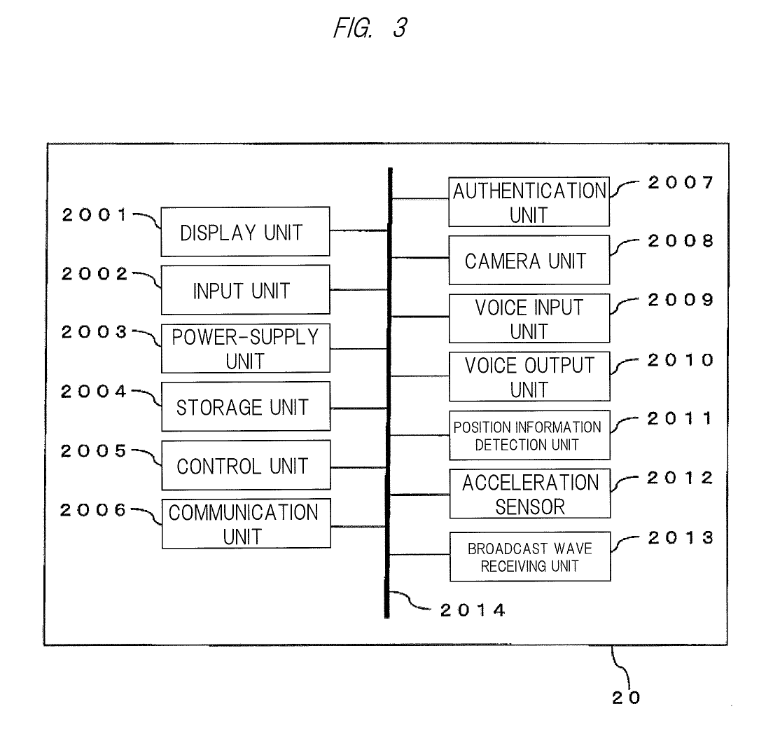

That is, the instructor's terminal 20 is provided with a display unit 2001, an input unit 2002, a power supply unit 2003, a storage unit 2004, a control unit 2005, a communication unit 2006, an authentication unit 2007, a camera unit 2008, a voice input unit 2009, a voice output unit 2010, a position information detection unit 2011, an acceleration sensor 2012, a broadcast wave receiving unit 2013 and a bus 2014 (see FIG. 3). They respectively have the same functions as those of the display unit 1001, the input unit 1002, the power supply unit 1003, the storage unit 1004, the control unit 1005, the communication unit 1006, the authentication unit 1007, the camera unit 1008, the voice input unit 1009, the voice output unit 1010, the position information detection unit 1011, the acceleration sensor 1012, the broadcast wave receiving unit 1013 and the bus 1014. Additionally, it is needless to say that there are differences in that the position information detection unit 2011 acquires the position information of not the learner's terminal 10 but the instructor's terminal 20 and in that the acceleration sensor 2012 acquires the position information of not the learner's terminal 10 but the instructor's terminal 20.

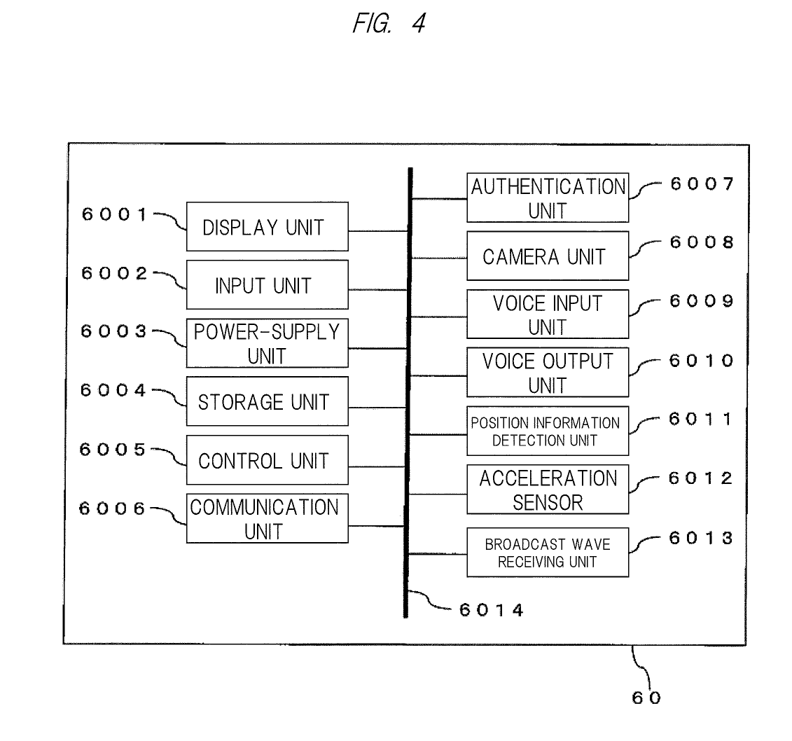

The parent's terminal 60 is provided with a display unit 6001, an input unit 6002, a power supply unit 6003, a storage unit 6004, a control unit 6005, a communication unit 6006, an authentication unit 6007, a camera unit 6008, a voice input unit 6009, a voice output unit 6010, a position information detection unit 6011, an acceleration sensor 6012, a broadcast wave receiving unit 6013 and a bus 6014 (see FIG. 4). They respectively have the same functions as those of the display unit 1001, the input unit 1002, the power supply unit 1003, the storage unit 1004, the control unit 1005, the communication unit 1006, the authentication unit 1007, the camera unit 1008, the voice input unit 1009, the voice output unit 1010, the position information detection unit 1011, the acceleration sensor 1012, the broadcast wave receiving unit 1013 and the bus 1014. Additionally, it is needless to say that, for example, there is a difference in that the position information detection unit 6011 acquires the position information of not the learner's terminal 10 but the parent's terminal 60.

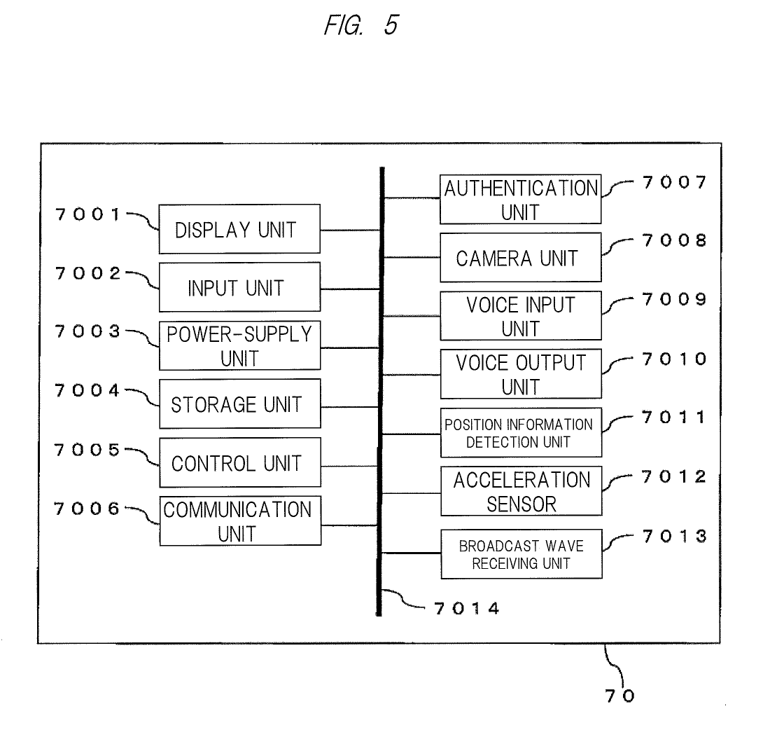

The instructor's terminal 70 is provided with a display unit 7001, an input unit 7002, a power supply unit 7003, a storage unit 7004, a control unit 7005, a communication unit 7006, an authentication unit 7007, a camera unit 7008, a voice input unit 7009, a voice output unit 7010, a position information detection unit 7011, an acceleration sensor 7012, a broadcast wave receiving unit 7013 and a bus 7014 (see FIG. 5). They respectively have the same functions as those of the display unit 1001, the input unit 1002, the power supply unit 1003, the storage unit 1004, the control unit 1005, the communication unit 1006, the authentication unit 1007, the camera unit 1008, the voice input unit 1009, the voice output unit 1010, the position information detection unit 1011, the acceleration sensor 1012, the broadcast wave receiving unit 1013 and the bus 1014.

Additionally, in the following description, when it is not necessary to distinguish the learner's terminal 10, the instructor's terminal 20, the parent's terminal 60 and the instructor's terminal 70, these are sometimes referred to simply as “terminals”.

Moreover, when it is necessary to distinguish one learner's terminal 10 from the other learner's terminals 10, one of them is sometimes referred to as a learner's terminal 10a, with the other being referred to as a learner's terminal 10b. In the same manner, when it is necessary to distinguish one instructor's terminal 20 from the other instructor's terminals 20, one of them is sometimes referred to as an instructor's terminal 20a, with the other being referred to as an instructor's terminal 20b. And when it is necessary to distinguish one school server 23 from the other school servers 23, one of them is sometimes referred to as a school server 23a, with the other being referred to as a school server 23b.

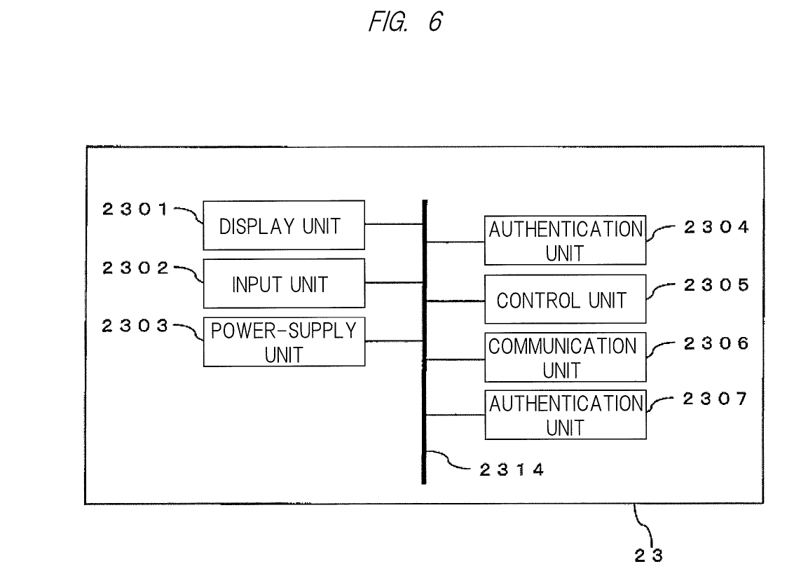

FIG. 6 is a diagram that shows one example of a functional configuration of the school server 23.

The school server 23 includes a display unit 2301, an input unit 2302, a power supply unit 2303, a storage unit 2304, a control unit 2305, a communication unit 2306, an authentication unit 2307 and a bus 2314.

The display unit 2301 is composed of a panel, such as a liquid crystal display or the like, and a driver circuit or the like, and displays desired information (for example, characters, still images and motion pictures, etc.) under control of the control unit 2305. This mainly displays information directed to the server administrator. Additionally, the display unit 2301 may be prepared as a housing other than the school server 23's main body.

The input unit 2302 is provided with one or a plurality of key boards, mice, and cursor keys or the like, and upon receipt of an operation of the user, it inputs an input signal to the control unit 2305 based upon the operation. Additionally, by generating an input signal based upon a voice recognition, an image recognition, or a gesture recognition or the like, the resulting signal may be inputted to the control unit 2305. Moreover, a configuration, such as a touch panel, in which the display unit 2301 and the input unit 2302 are integrally combined, may be used.

The power supply unit 2303 is composed of a battery, an AC adopter and a charging circuit, or the like, and carries out a power supply to the respective units of the school server 23 and a charging process to the battery. It also carries out a state confirmation as to whether the school server 23 is battery-driven or AC-adopter-driven, and a remaining-amount confirmation of the battery.

The storage unit 2304, which is composed of a memory built in the school server 23, a detachable external memory, or the like, stores various kinds of information. For example, it stores an operation-controlling program to be executed by the control unit 2305.

The control unit 2305, which is composed of a CPU, an MPU, a DSP, or the like, controls operations of the entire school server 23 by executing predetermined operation-controlling programs or the like.

The communication unit 2306, which is provided with wireless communication functions, such as a wireless LAN, or cable communication functions, such as Ethernet or the like, transmits/receives various kinds of information. The wireless communication function includes an antenna and a modulation/demodulation circuit, or the like. The cable communication function includes a connector and a modulation/demodulation circuit, or the like. The information transmitting and receiving operations are basically carried out by using a network (2, 22 or 62 in FIG. 1). The communication unit 2306 may be configured in such a manner as to be compatible with a plurality of communication systems.

The authentication unit 2307 carries out an authentication process as to whether a user is a registered user or not by using an authentication system, such as a password authentication, a finger-print authentication, a finger-vein authentication, a handwriting authentication, a face authentication, a voice authentication and an iris authentication, or the like. The authentication unit 1007 is provided with a function for acquiring information inputted by the user for certification (password, finger-print data, finger-vein data, handwriting data, face image data, voice data, iris data, or the like) in accordance with the authentication system.

Additionally, the functional configurations of the publisher server 43, the administration server 53 and the cram-school server 73 are the same as those of the school server 23.

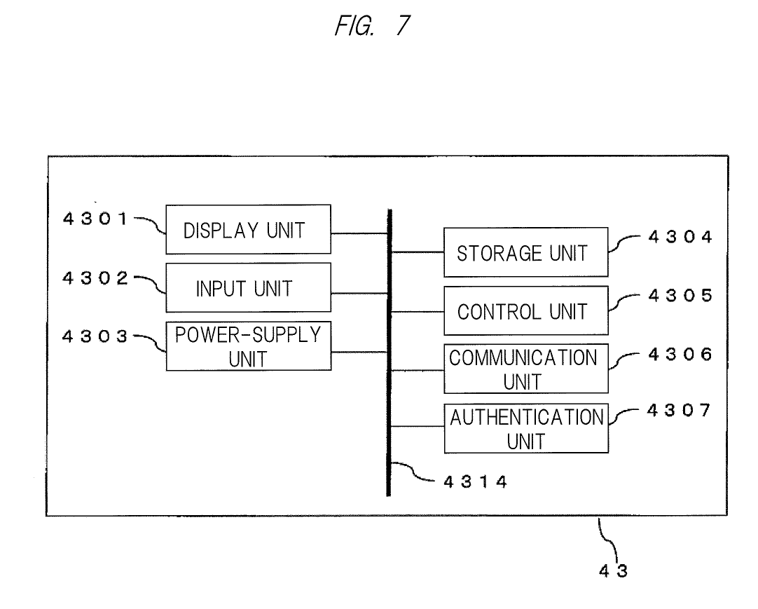

That is, the publisher server 43 is provided with a display unit 4301, an input unit 4302, a power supply unit 4303, a storage unit 4304, a control unit 4305, a communication unit 4306, an authentication unit 4307 and a bus 4314 (see FIG. 7). They respectively have the same functions as those of the display unit 2301, the input unit 2302, the power supply unit 2303, the storage unit 2304, the control unit 2305, the communication unit 2306, the authentication unit 2307 and the bus 2314.

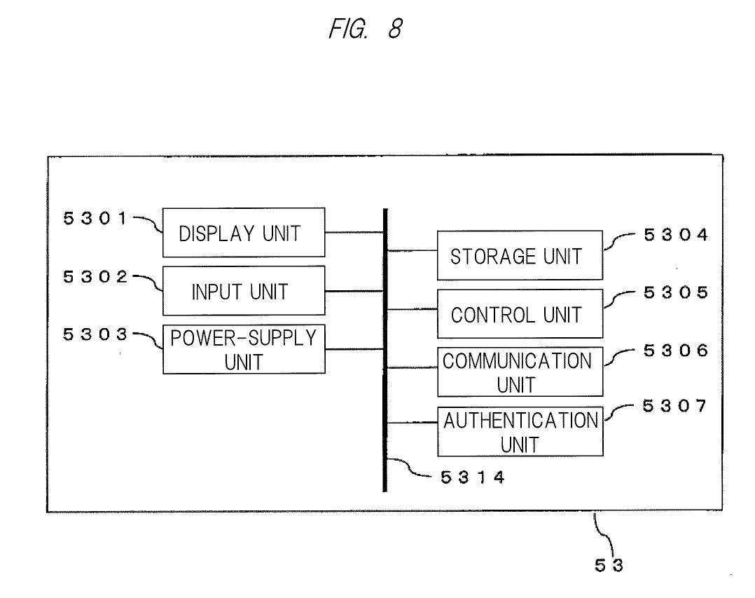

The administration server 53 is provided with a display unit 5301, an input unit 5302, a power supply unit 5303, a storage unit 5304, a control unit 5305, a communication unit 5306, an authentication unit 4307 and a bus 5314 (see FIG. 8). They respectively have the same functions as those of the display unit 2301, the input unit 2302, the power supply unit 2303, the storage unit 2304, the control unit 2305, the communication unit 2306, the authentication unit 2307 and the bus 2314.

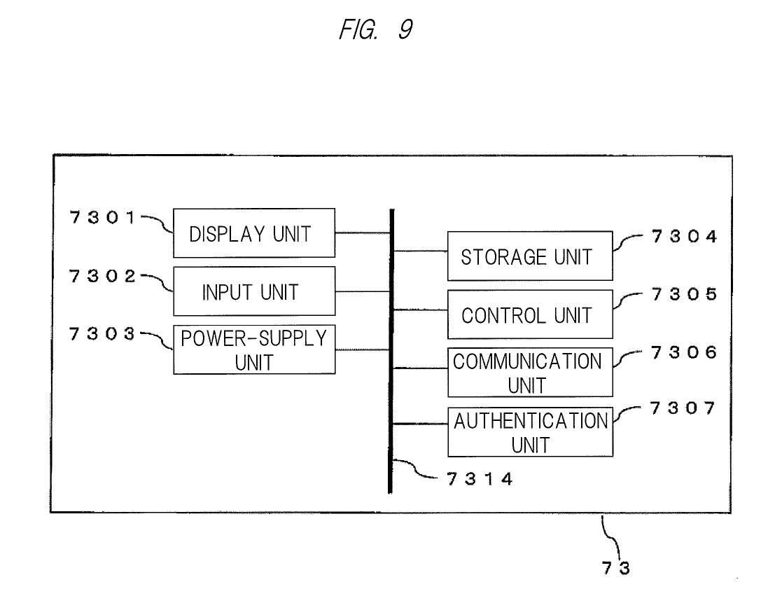

The cram-school server 73 is provided with a display unit 7301, an input unit 7302, a power supply unit 7303, a storage unit 7304, a control unit 7305, a communication unit 7306, an authentication unit 7307 and a bus 7314 (see FIG. 9). They respectively have the same functions as those of the display unit 2301, the input unit 2302, the power supply unit 2303, the storage unit 2304, the control unit 2305, the communication unit 2306, the authentication unit 2307 and the bus 2314.

The storage unit 2304 of the school server 23 stores school specific information, grade specific information, class specific information, learner basic information and learner specific information. Each of these pieces of information has information capable of allowing the authentication unit 2307 to confirm the access right. The access right indicates the presence or absence of the right for utilizing the information or the range thereof, and for example, information relating to the access right is contained in, or added to information to be accessed so as to identify whether or not a predetermined terminal or server can edit the information, or can only refer to the information.

FIG. 13 shows specific examples of the school specific information, grade specific information, class specific information, learner basic information and learner specific information.

The school specific information refers to information inherent to a certain school that specifically includes the name, address, telephone number, and principal name of school, as well as information such as a symbol or the like for distinguishing the school from the others (hereinafter, sometimes referred to as “ID”). Based upon the corresponding information, it becomes possible to identify the school. Additionally, the school specific information may be prepared as an abbreviation of the school name, the name of the chief director of the school, or the like. Moreover, school information, such as a piece of information that fails to identify a specific school when used alone, for example, additional information such as a distinction between public and private schools, or a school board to which the school belongs, may be added thereto.

The grade specific information corresponds to information inherent to a specific grade, such as, more specifically, the name of a grade, the name of the chief of the grade or the like. Based upon the corresponding information, it is possible to identify the grade.

The class specific information, more specifically, corresponds to information inherent to a certain class, such as a class name, a class time schedule, a recommended book list and a contact notebook, or the like. For example, based upon the corresponding information, it is possible to identify the class or to utilize information inherent to the class.

FIG. 13 shows information inherent to a first class in the first grade including a school time schedule, a recommended book list, a contact note and the name of a teacher in charge relating to the first class in the first grade, and it is supposed that pieces of specific information of respective classes including information inherent to the other classes are stored in the storage unit 2304 in the same manner.

The learner basic information is personal information including, such as, more specifically, the name, gender, date of birth, address and emergency contact address of a learner, as well as names of the guardians, or the like, by which the corresponding learner can be identified.

The learner specific information is personal information relating to the learning inherent to a learner, such as a learner ID, a learner ID-use password, achievement information, presence/absence information, health conditions, learning history, reading history, text book data, reference book data, and note data. Different from the learner basic information that is inherently possessed by a learner or guardians (parents), and is basically unchanged, the learner specific information is information that is daily updated by the instructor.

The above-mentioned learner ID refers to an ID by which a learner can be individually identified, and for example, corresponds to a student number, or the like.

The learner ID-use password refers to a password corresponding to the above-mentioned learner ID.

The above-mentioned achievement information refers to information relating to achievements of a learner, and for example, corresponds to learning achievements and learner attitudes required for preparing a school report for achievements.

The above-mentioned presence/absence information refers to information relating to the presence/absence of a learner to/from lessons. For example, the information may include information for use in identifying whether or not a learner has left earlier from classes, or delayed thereto.

The health conditions refer to information relating to health conditions of a learner, and include, for example, the results of a medical health examination, history of injuries and sickness, and blood type of a learner.

The above-mentioned learning history refers to information indicating the history of learning of a learner, and includes, for example, the date and time of learning, the learning hours, the level of advancements for each curriculum and the level of achievements for each subject or the like.

The above-mentioned reading history refers to information indicating the history of borrowed books in the library by a learner, and includes, for example, the titles of books the learner has borrowed, the date of borrowing, and the types thereof.

The above-mentioned text book data refer to information for use in identifying a text book, or electronic information including the contents of a text book (which may include both of them), and include, for example, the title, the table of contents and content data, or the like, of a text book.

The above-mentioned reference book data refer to information for use in identifying a reference book, or electronic information including the contents of a reference book (which may include both of them), and include, for example, the title, the table of contents and contents data, or the like, of a reference book.

The above-mentioned note data refer to electronic information that records achievements made by a learner, or information that specifies such achievements (which may include both of them), and include, for example, document data of one's own making, the title, the name of instructor, the creation date and time and data of the creation place, or the like.

In the present embodiment, the name of a learner is set to “Jiro Yokohama”, and a learner ID is set to “id01”, with the school specific information, grade specific information, class specific information, learner basic information and learner specific information corresponding to id01 being stored, and for each of the learner ID's, the storage unit 2304 stores the corresponding school specific information, grade specific information, class specific information, learner basic information and learner specific information.

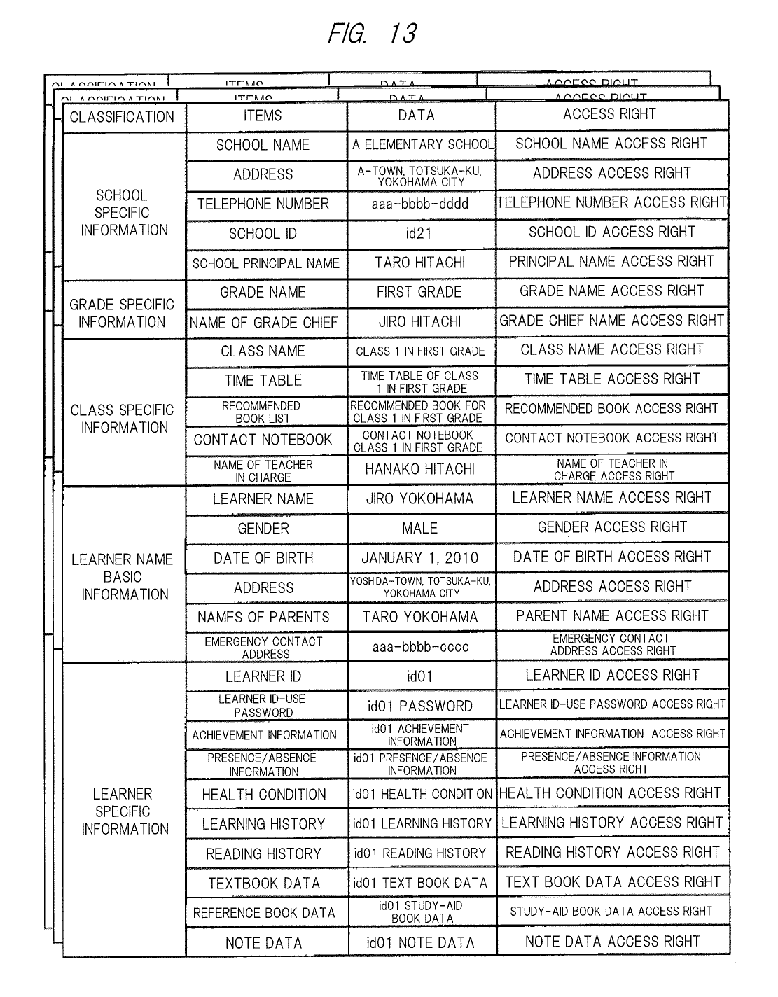

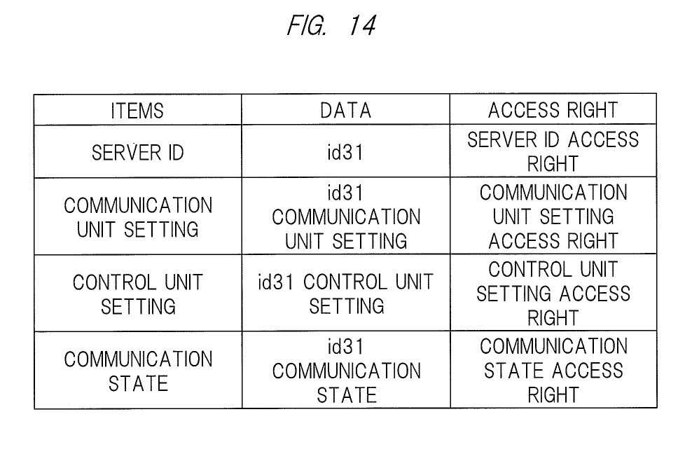

In addition, the storage unit 2304 of the school server 23 stores server specific information. This information includes a piece of information capable of identifying the access right by the use of the authentication unit 2307. FIG. 14 shows a specific example of the above-mentioned server specific information.

The server specific information more specifically includes a server ID, a communication unit setting, a control unit setting and a communication state, or the like, and corresponds to information indicating the inherent settings and states of each of the servers.

The server ID refers to an ID capable of identifying each of servers connected to the network 22 in the school.

The communication unit setting refers to information relating to settings of the communication unit 2306 of the school server 23. More specifically, the settings include the IP address, DNS (Domain Name System), gate way, authentication system, proxy and firewall of the school server 23, which are required for the communication in the network 22 in the school and the communication with the network 2 through the network 22 in the school, and information such as IP addresses, subnet masks, or the like, of the accessible learner's terminals 10.

The above-mentioned control unit setting refers to information relating to settings of the control unit 2305 inside the school server 23. More specifically, the information relates to the setting of the OS (Operating System), the settings of the driver, hardware and software of the respective units, the setting of the OS for the learner's terminal 10 for allowing the learner's terminal 10 to access the school server 23, and settings of the driver, hardware and software of the respective units thereof.

The above-mentioned communication state refers to information relating to the state of the communication unit 2306 inside the school server 23, and more specifically, the communication rate or the like.

In the present embodiment, the server ID of the server 23 in the school is set to id31, and server specific information relating to the id31 is stored by the storage unit 2304.

The storage unit 1004 of the learner's terminal 10 stores school specific information, grade specific information, class specific information, learner basic information and learner specific information. In the same manner as in the school server 23, these pieces of information also have information that allows the authentication unit 1007 to identify the access right.

FIG. 15 shows specific examples of the school specific information, grade specific information, class specific information, learner basic information and learner specific information to be stored by the storage unit 1004. Since these pieces of information are basically the same as those stored in the storage unit 2304, the specific explanation thereof will be omitted.

In the present embodiment, the learner ID having the name of the learner “Jiro Yokohama” is set to the id01, and the pieces information including the school specific information, grade specific information, class specific information, learner basic information and learner specific information corresponding to the id01 are stored in the storage unit 1004.

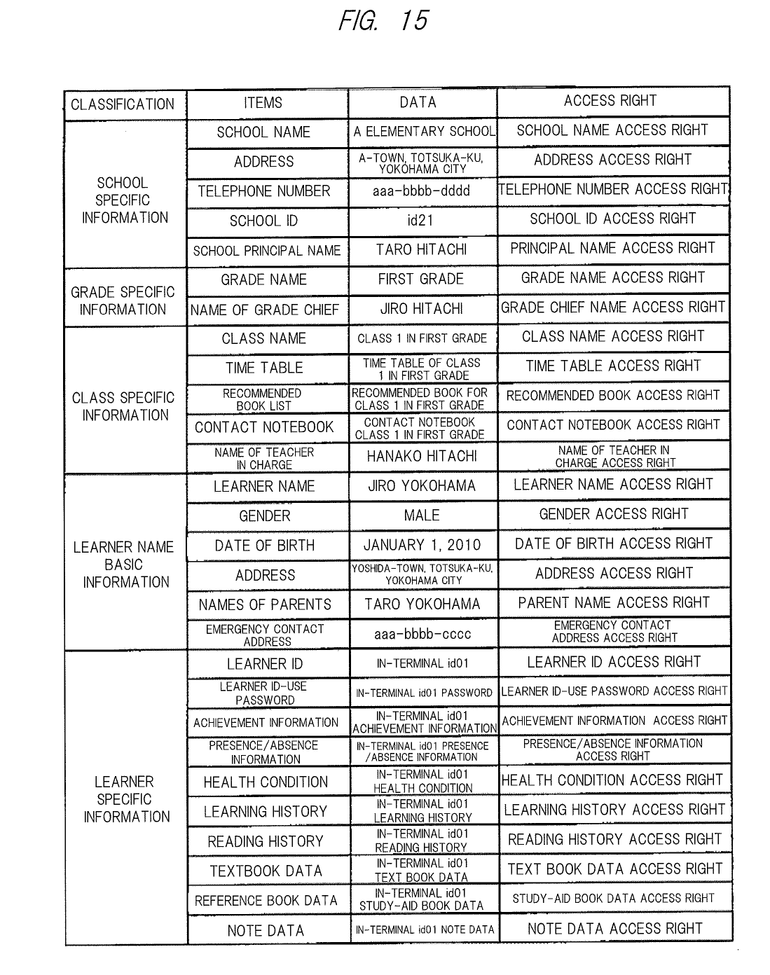

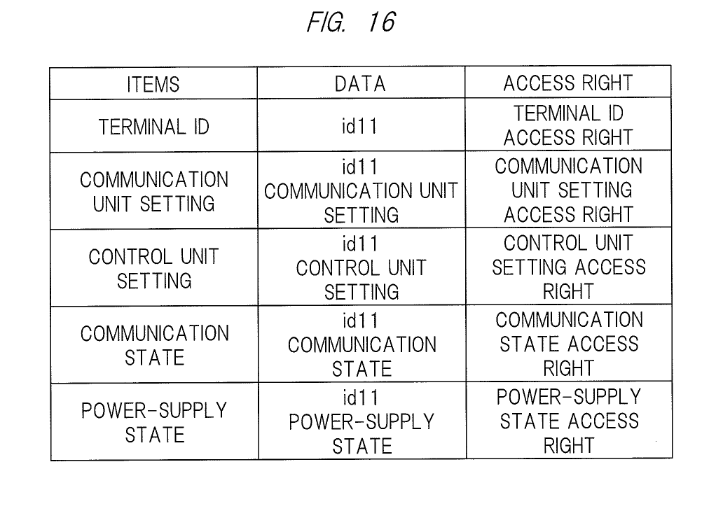

Moreover, the storage unit 1004 stores terminal specific information. In the same manner as in the school server 23, this information also possesses a piece of information that allows the authentication unit 1007 to identify the access right. FIG. 16 shows a specific example of the above-mentioned terminal specific information.

The terminal specific information more specifically includes a terminal ID, a communication unit setting, a control unit setting, a communication state and a power-supply state, or the like, and corresponds to information indicating the inherent settings and states of the respective terminals.

The terminal ID refers to an ID capable of identifying each of individual learner's terminals 10.

The above-mentioned communication unit setting refers to information relating to settings of the communication unit 1006 of the learner's terminal 10. More specifically, the settings include the IP address, DNS, gate way, authentication system, proxy and firewall of the school server 23, and relate to pieces of information, such as IP addresses and subnet masks or the like of a learner's terminal 10, as well as information for use in carrying out communication with the network 22 in the school, communication with the network 2 through the network 22 in the school, communication with the home network 62 and communication with the network 2 through the home network 62.

The above-mentioned control unit setting refers to information relating to settings of the control unit 1005 of the learner's terminal 10. More specifically, the setting includes the OS setting for the learner's terminal 10 that allows the learner's terminal 10 to access the school server 23 and the driver, hardware and software settings of the respective units.

The above-mentioned communication state refers to information relating to the state of the communication unit 1006 inside the learner's terminal 10, and more specifically, the communication rate or the like.

The above-mentioned power supply state refers to information relating to the state of the power supply unit 1003 inside the learner's terminal 10, and more specifically, corresponds to the presence or absence of the AC power supply connection, the remaining amount of the battery, or the like.

In the present embodiment, the terminal ID of the learner's terminal 10 is set to id11, and terminal specific information corresponding to the id11 is stored in the storage unit 1004.

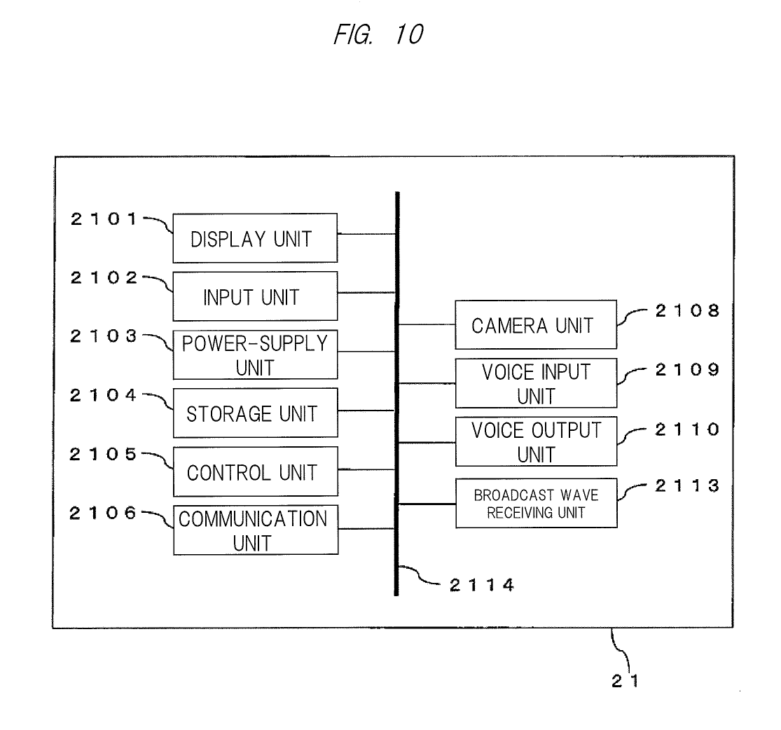

FIG. 11 is a diagram that shows one example of an initial setting process prior to distribution.

Prior to the distribution to a learner, each learner's terminal 10 is subject to required setting processes mainly directed by the school server 23 or in cooperation therewith.

First, upon turning on the power supply (S001), the learner's terminal 10 reads a driver, and activates the OS (S002). As shown in FIG. 1, the school server 23 and the learner's terminal 10 are connected to the network 22 in the school through a cable or a wireless line, and the learner's terminal 10 is thus registered by the network 22 in the school as a terminal before initialization, and brought into a state capable of carrying out only required communications.

Next, the school server 23 transmits an initializing request to the terminal before initialization (S003). Upon receipt of the initializing request, the learner's terminal 10 is transferred to an initializing mode in which the basic setting, the administrator registration and the basic software setting of the learner's terminal 10 can be carried out.

Next, the administrator registration is carried out so that the learner's terminal 10 can be changed in settings by the administrator of the network 22 in the school by the remote control (S004).

Next, basic settings are carried out thereon (S005). In this case, in order to carryout settings of terminal specific information of the learner's terminal 10 shown in FIG. 16, among the communication unit settings and control unit settings shown in FIG. 14, those settings required for accessing to the school server 23 are transmitted to the learner's terminal 10 so that terminal specific information is set.

Next, the transmission and setting of the basic software are carried out (S006).

Specific examples of the basic software include security software capable of carrying out a virus detection and the like, filtering software for use in limiting inappropriate opinions, displays and the like and managing software for use in communicating with the school server 23 so as to manage information required for learning. With respect to the security software, the security software is transmitted from the school server 23 to the learner's terminal 10 so that the learner's terminal 10 executes the installing process thereof. After the installation, the learner's terminal 10 carries out initial settings required for the security software. For example, the receiving setting of definition information for virus retrieval, the setting of retrieval date and time, the setting of a reporting method at the time of a virus detection and the like are carried out.

With respect to the filtering software, the filtering software is transmitted from the school server 23 to the learner's terminal 10 so that the learner's terminal 10 executes the installing process thereof. After the installation, the learner's terminal 10 carries out initial settings required for the filtering software. For example, the settings of words, documents and internet sites on which the limitation is imposed are carried out.

With respect to the managing software, the managing software is transmitted from the school server 23 to the learner's terminal 10 so that the learner's terminal 10 executes the installing process thereof. After the installation, the learner's terminal 10 carries out initial settings required for the managing software. For example, as pieces of information required for carrying out services necessary for learning, the settings of school specific information, class specific information and learner specific information are carried out.

In the above-mentioned settings, the school specific information, the grade specific information, the class specific information, the learner basic information and the learner specific information preliminarily stored in the storage unit 2304 of the school server 23 are transmitted to the learner's terminal 10, and the corresponding settings are carried out.

The learner's terminal 10 stores the respective pieces of information thus transmitted in the storage unit 1004.

FIG. 15 shows specific examples of the respective pieces of information stored in the storage unit 1004 of the learner's terminal 10. For example, in the case when the learner's terminal 10 that is the terminal prior to initialization is used by a learner of the first class in the first grade, the contents of the class specific information corresponding to the first class in the first grade of FIG. 13 are stored by the storage unit 1004.

In the case when, for example, the user of the learner's terminal 10 corresponding to the terminal prior to initialization is “Jiro Yokohama”, since the learner ID is id01, the contents of the learner specific information corresponding to id01 are stored in the storage unit 1004. When normally stored, the learner basic information id01 stored in the storage unit 2304 indicated by FIG. 13 and the learner basic information id01 inside the terminal stored in the storage unit 1004 shown in FIG. 15 have the same contents. That is, the learner basic information corresponding to “Jiro Yokohama” indicated by data of the names of the learners inside the learner basic information corresponding to id01 stored in the storage unit 2304 and the learner basic information corresponding to “Jiro Yokohama” indicated by data of the names of the learners inside the learner basic information stored in the storage unit 1004 are coincident with each other.

In the same manner, the learner ID, learner ID-use password, achievement information, presence/absence information, health condition, learning history and reading history are stored in the storage unit 1004. The achievement information and the health condition are not necessarily required to be coincident with each other strictly between the school server 23 and the learner's terminal 10. For example, in the case when the achievement information stored in the school server 23 is managed by the school (that is, instructors) relating to school report, curriculum guidance and the like, and contains inappropriate information to be disclosed to the learner, the school server 23 may exclude these pieces of information from the achievement information, and transmit the resulting data to the learner's terminal 10 so that the storage unit 1004 stores the data.

Next, the transmission of teaching materials for learning and settings thereof are carried out (S007). More specifically, based upon the above-mentioned class specific information, the school server 23 transmits data relating to teaching materials, such as text book data, note data, reference book data and the like, to the learner's terminal 10, and the learner's terminal 10 executes settings so as to make these data usable.

Next, settings of several pointers are carried out (S008). More specifically, the learning server 23 allows the instructor to transmit the several pointers to the learner's terminal 10 for the learner, and the learner's terminal 10 stores these. Additionally, the several pointers refer to matters for the user to attend, that is, for example, tutorial data for using and storing method of the learner's terminal 10, matters that require attention at the time of entering school as well as at the time of coming to school and leaving school, and permissions for use of various pieces of software, etc. Additionally, it is not necessarily required for the instructor to transmit only the matters that require attention by the learner to the learner's terminal 10, and guidance or the like directed to the parent may be included therein.

Next, a setting confirming test for confirming whether the settings have been so far carried out correctly is carried out (S009). More specifically, the school server 23 requests the learner's terminal 10 to transmit the contents of the various settings, and upon receipt of the request, the learner's terminal 10 transmits the stored contents of settings to the school server 23. Then, the contents of the settings transmitted by the learner's terminal 10 and received by the school server 23 are collated with the contents set by the school server 23. As the result of this collation, when the two contents are coincident with each other, the power supply of the learner's terminal 10 is turned off manually or automatically, assuming that the initialization has been completed (S010). In the case when, as the result of the collation, the contents of settings stored in the school server 23 are not coincident with the contents of settings stored in the learner's terminal 10, the school server 23 informs the administrator or the like of this fact. Then, if there is any problem in the settings of the learner's terminal 10, such a learner's terminal 10 is disposed as an initially defective product. More specifically, the corresponding learner's terminal 10 is not distributed to a learner, and is subjected to a check-up process for any defect or the like of hardware, and if it can be repaired, the terminal is repaired and again subjected to the initializing process.

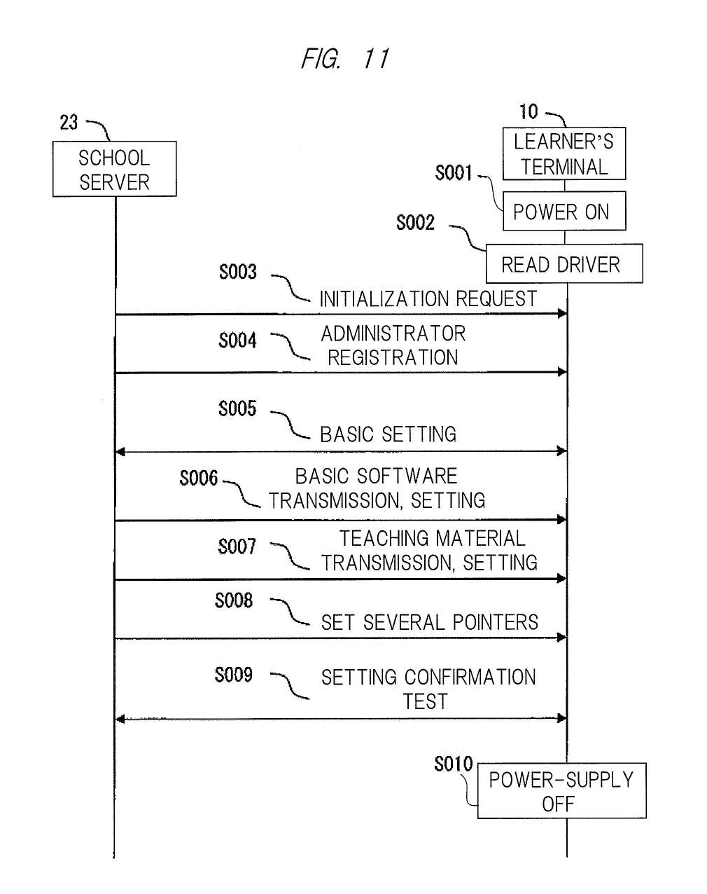

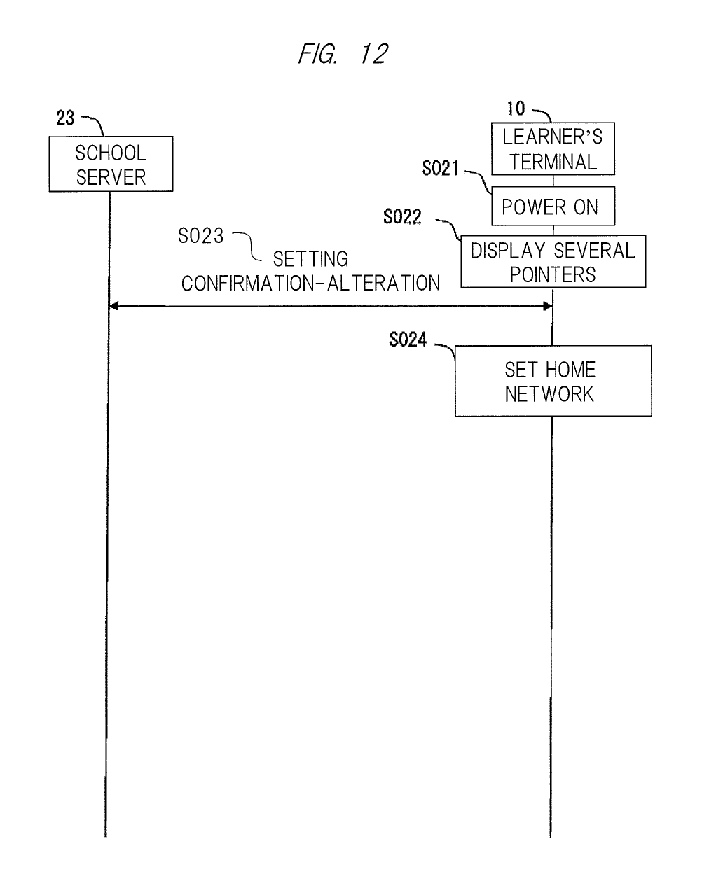

FIG. 12 is a diagram that shows one example of an initial setting process after the distribution.

Upon turning on the power supply (S021), the learner's terminal 10 displays the aforementioned matters that require attention (S022).

Next, the learner's terminal 10 displays the school specific information, class specific information, learner basic information and learner specific information so as to allow the learner to confirm whether or not any mistake exists, and make a change, if necessary (S023). In this case, a password changing process may be carried out. The learner's terminal 10 transmits the contents of the change to the school server 23.

Next, settings are executed on the home network 62 (S024). More specifically, upon setting terminal specific information on the communication unit, settings on the communication unit required for communication in the home network 62 are carried out. If necessary, the setting required for the connection to the network 2 may be carried out.

The initial setting process after distribution is completed as described above so that the learner's terminal 10 is brought into a normally usable state. The normally usable state refers to a state in which the learner is allowed to use all the functions of the learner's terminal 10, such that, for example, the learner can attend a class through the network 22 in the school, and view the aforementioned text book data and note data.

As described above, since optimal settings to be used inside the network 22 in the school can be positively prepared on the learner's terminal 10 prior to being distributed to the learner, it becomes possible to preliminarily prevent an initial defect from occurring thereon. Moreover, since teaching materials suitable for the learner can be transmitted to the learner's terminal 10, smooth introduction of electronic text books and reference books or the like can be carried out.

### Embodiment 2

Next, the following description will discuss embodiment 2 of the present invention. Additionally, in the present embodiment, the same configurations, functions, elements and the like as those of the aforementioned embodiment are used within a required range.

FIG. 10 is a diagram that shows one example of a functional configuration of an electronic blackboard 21.

The electronic blackboard 21 is provided with a display unit 2101, an input unit 2102, a power supply unit 2103, a storage unit 2104, a control unit 2105, a communication unit 2106, a camera unit 2108, a voice input unit 2109, a voice output unit 2110, a broadcast wave receiving unit 2113 and a bus 2114.

The display unit 2101 is composed of a panel, such as a liquid crystal display, a plasma display, an organic EL display and an electronic paper, or the like, as well as a driver circuit or the like, and displays desired information (for example, characters, still images, motion images, etc.) inputted through the communication unit 2106 under control by the control unit 2105. Additionally, the display unit 2101 may be composed of a projector and a screen on which the output from the projector is projected.

The input unit 2102 is provided with an indicator positional sensor that detects a position on the display unit 2101 indicated by the user through a contact by an electronic pen or a finger. For example, there are methods in which a position of a pressure applied onto a pressure sensitive touch panel is detected and in which an electronic pen with a built-in coil is used and by an inductive current generated when the electronic pen moves, the position and movement of the electronic pen are read, as well as an infrared-ray image sensor method, an infrared-ray image sensor method (with an ultrasonic wave transfer method used in combination) and an infrared-ray shield detection method or the like. In a separated manner, a keyboard, a mouse, a cursor key and various operation buttons, or the like may be installed. In any of the cases, upon receipt of an operation by the user, the input signal derived from the operation is inputted to the control unit 2105. Additionally, an input signal may be inputted by using a voice recognition, an image recognition, a gesture recognition or the like.

The power supply unit 2103, which is composed of a battery, an AC adopter and a charging circuit or the like, carries out a power supply to the respective units of the electronic blackboard 21 and a charging process to the battery. It also carries out a state confirmation as to whether the electronic blackboard 21 is battery-driven or AC-adopter-driven, and a remaining-amount confirmation of the battery.

The storage unit 2104, which is composed of a memory built in the electronic blackboard 21, a detachable external memory or the like, stores various kinds of information. For example, it stores an operation-controlling program to be executed by the control unit 2105.

The control unit 2105, which is composed of a CPU, an MPU and a DSP or the like, controls operations of the entire electronic blackboard 21 by executing predetermined operation-controlling programs or the like.

The communication unit 2106, which is provided with wireless communication functions, such as a wireless LAN, Bluetooth, infrared ray communication, IC tag functions, Transfer JET, HDMI (High-Definition Multimedia Interface), LTE, HSPA, EV-DO and WiMAX or the like, or cable communication functions, such as Ethernet or the like, transmits and receives various kinds of information. The wireless communication function includes an antenna and a modulation/demodulation circuit, or the like. The cable communication function includes a connector and a modulation/demodulation circuit, or the like. The information transmitting and receiving operations may be carried out by using a network (2, 22 or 62 in FIG. 1), or may be directly carried out among respective apparatuses without using a network. The communication unit 2106 receives screen data from an apparatus connected thereto through a wireless line or a cable, and transmits the resulting data to the display unit 2101. The communication unit 2106 may be configured in such a manner as to be compatible with a plurality of communication systems.

The camera unit 2108 is provided with an image-pickup device and an image processing device or the like. The camera unit 2108 carries out an image pickup process so as to acquire image data, such as still images and motion pictures, under control by the control unit 2105.

The voice input unit 2109 is provided with a microphone or the like, and collects voice signals, and stores (records) the resulting data in the storage unit 2104.

The voice output unit 2110 is provided with a speaker, an earphone jack and a DAC or the like, and carries out a DA conversion on data stored (recorded) in the storage unit 2104, and discharges the resulting sound through the speaker.

The broadcast wave receiving unit 2113 is provided with an antenna, a tuner and a decoder, and receives signals, such as full-segment broadcasting signals, one-segment broadcasting signals, or multi-media broadcasting signals, transmitted from the broadcast station 25, and demodulates and decodes the signals. Additionally, in the case when the received signal is encoded, it also carries out a process for decoding the signal.

The bus 2114 forms transmission paths through which respective units mutually transfer signals.

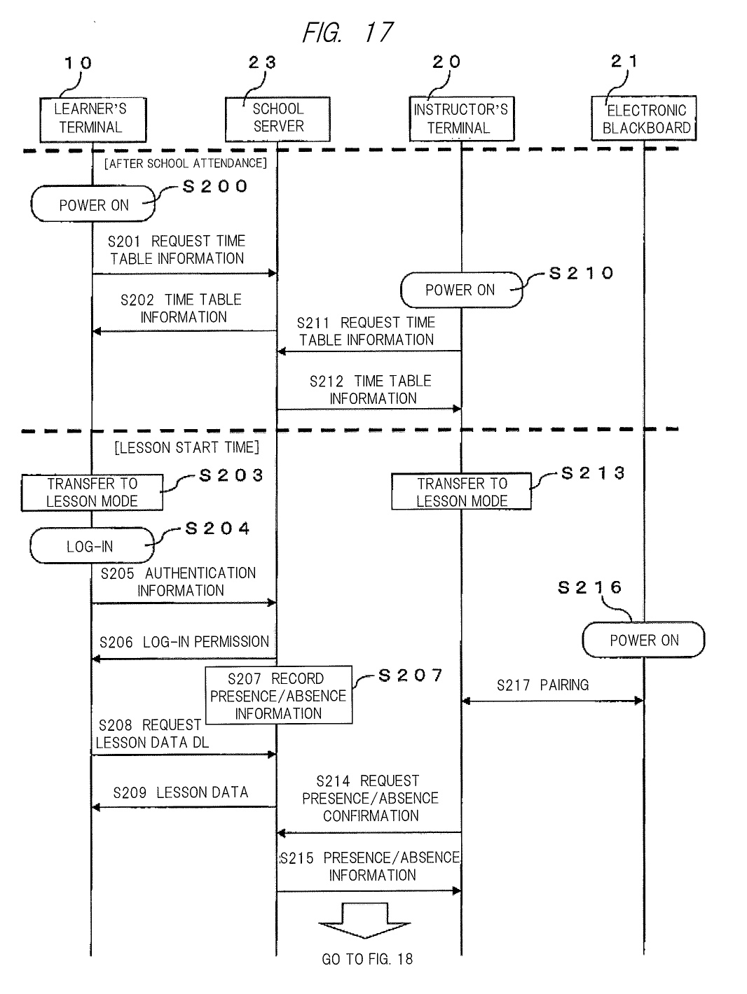

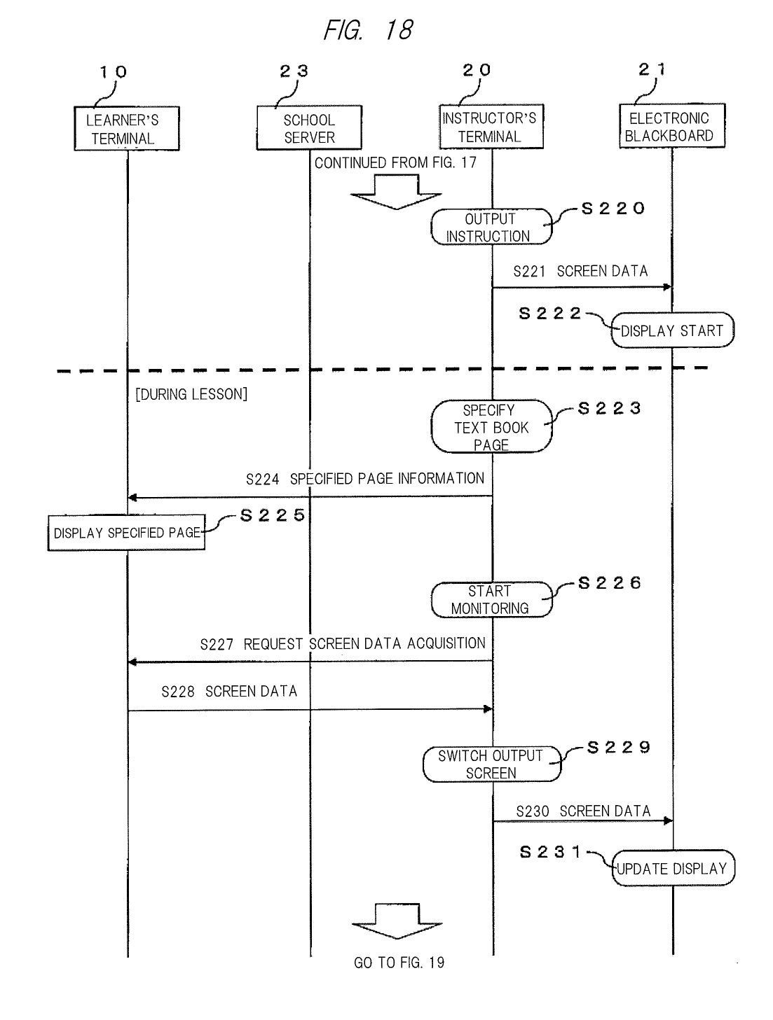

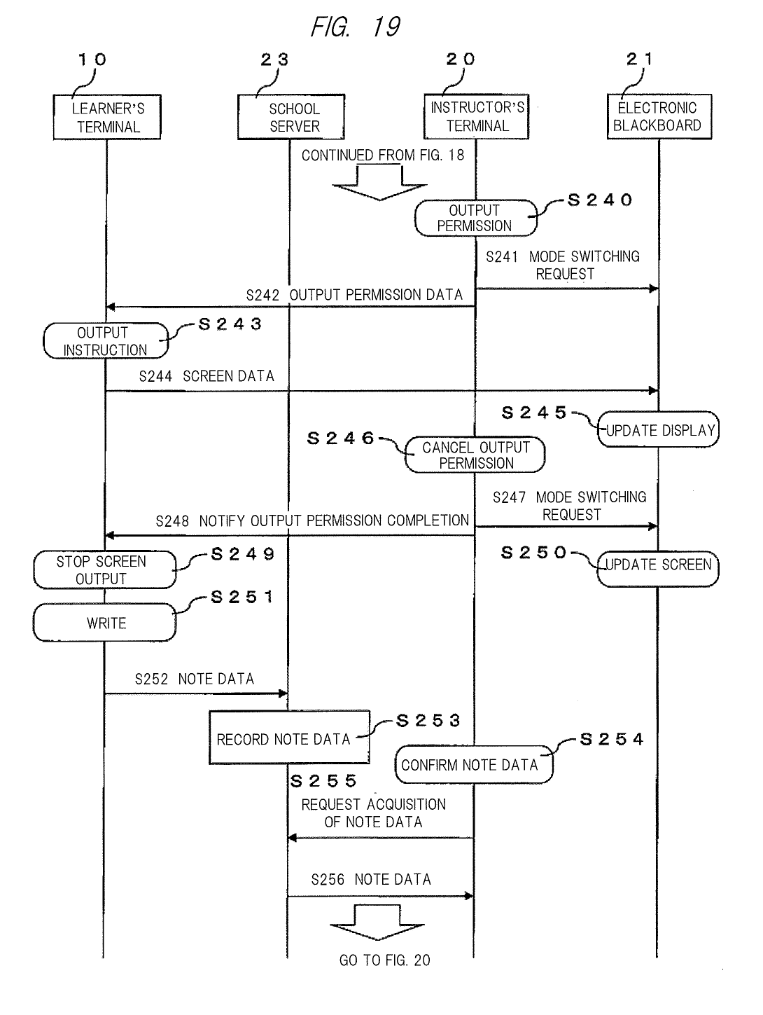

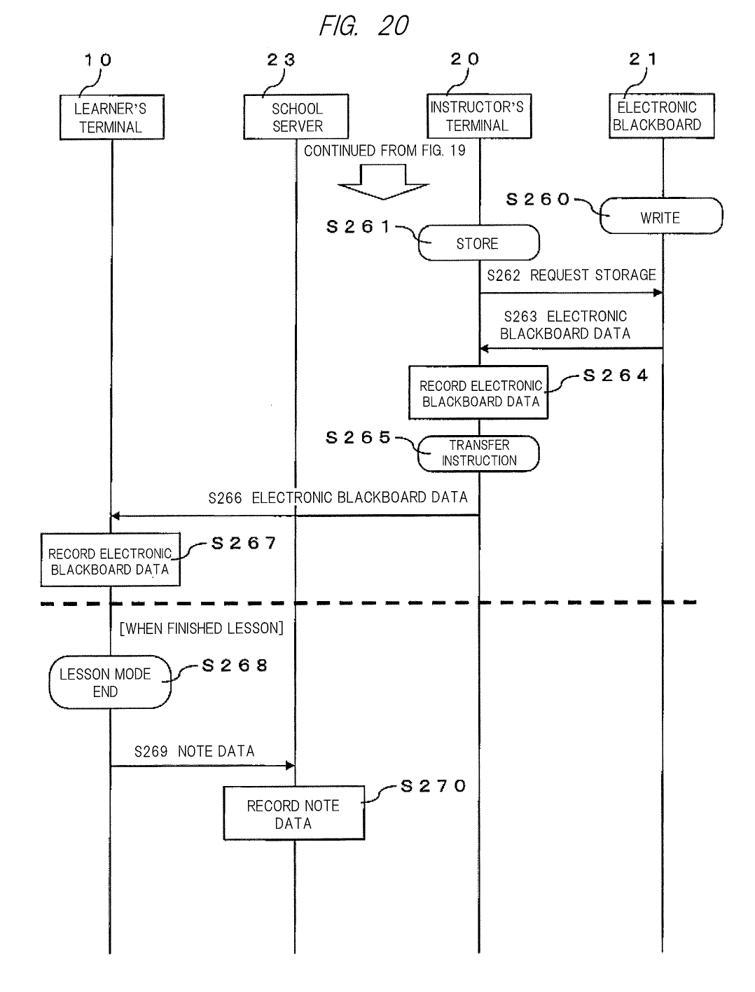

FIGS. 17 to 20 are diagrams that show one example of a normal learning process.

First, after coming to school, when the learner carries out a process for turning on the power supply of the learner's terminal 10, for example, in the classroom of his own (S200), the learner's terminal 10 is connected to the network 22 in the school, and transmits a request for time-table information to the school server 23 (S201). The request for time-table information refers to a request for time-table information (to be described later) to the school server 23. The time-table information request includes the learner ID; however, in place of the learner ID, the name of a learner or the name of a class by which the time table information of the learner can be specified may be used.

Upon receipt of the time-table information request, the school server 23 reads out time-table information corresponding to the received learner ID from the storage unit 2304, and transmits the resulting information to the learner's terminal 10 (S202). FIG. 21 shows one example of the time-table information for the learner. The time-table information for the learner refers to information relating to a time table for a lesson that the learner using the learner's terminal 10 needs to take. The time-table information of the present embodiment includes the starting time of the lesson, the ending time of the lesson, the name of the teaching subject, the name of an instructor in charge, an ID for specifying a text book to be used in the lesson, information concerning which page the corresponding class is started from, an ID for specifying a reference book to be used in the lesson and an address information (URL, a folder name, etc.) of a server to be used in the corresponding lesson. In addition to these, the information may include IDs and the like indicating text books, reference books and other teaching materials that should not be used in the lesson. Basically, the time-table information includes a time table for the one corresponding day (schedule information for activities in the school) in the class to which the learner belongs; however, this may include information corresponding to one week, or information of another class.

Additionally, not limited to the case in which the power charging operation is carried out after the learner has come to school, another case is considered in which the learner comes to school, with the learner's terminal 10 that has been turned on being brought with the learner. In this case, the learner manually carries out an operation required for acquiring the time-table information, and by using this operation as a trigger, the learner's terminal 10 may transmit the request for time-table information to the school server 23. Alternatively, by using only the fact that the learner's terminal 10 is connected to the network 22 in the school as the trigger, the learner's terminal 10 may automatically transmit the request for time-table information to the school server 23. With this arrangement, the user-friendliness of the system can be improved. In order to detect the fact that the learner's terminal 10 is connected to the network 22 in the school, a method is proposed in which, for example, when the connection is made by using a wireless communication, such as a wireless LAN, by reading beacon information transmitted by an access point (base station) and recognizing that information contained therein corresponds to a predetermined value, an authentication process or the like is carried out on the access point, and when a waiting state or a belonging state has been made correctly, this state is regarded as a connected state to the network 22 in the school.

The same is true for the instructor's terminal 20, and in the case when, after coming to school, the instructor carries out a process for turning on the power supply of the instructor's terminal 20, for example, in the teacher's room (S210), the instructor's terminal 20 is connected to the network 22 in the school, and transmits a request for time-table information to the school server (S211). The time-table information request includes the instructor ID; however, in place of the instructor ID, the name of an instructor or the name of a class by which the time table information of the instructor can be specified may be used.

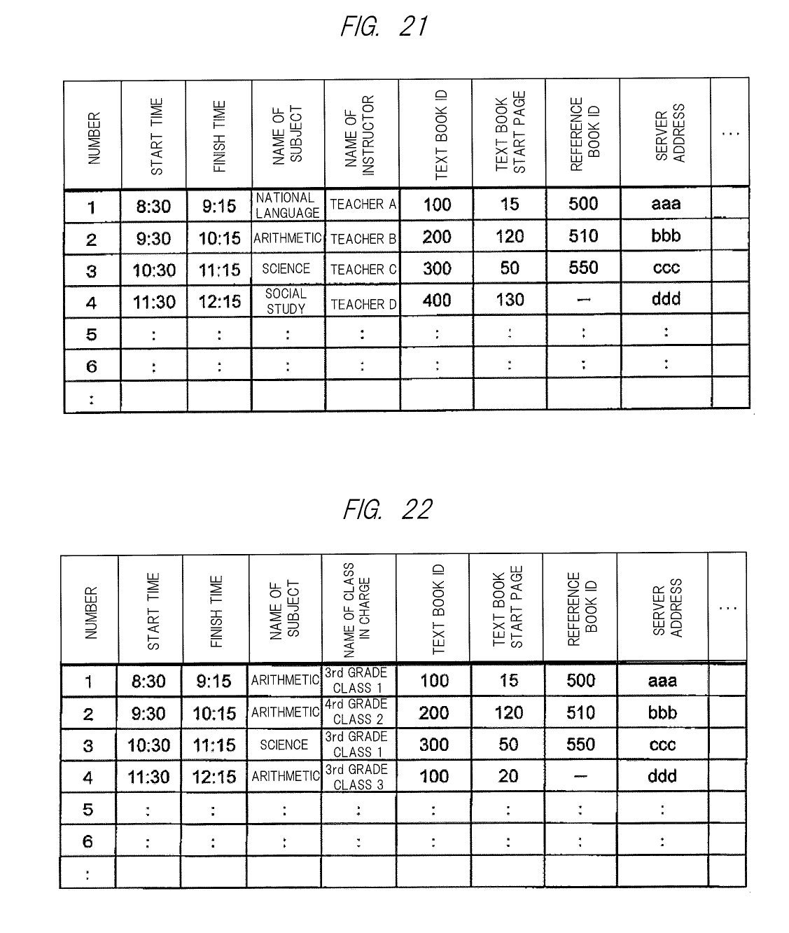

Upon receipt of the time-table information request, the school server 23 reads out time-table information corresponding to the received instructor ID from the storage unit 2304, and transmits the resulting information to the instructor's terminal 20 (S212). FIG. 22 shows one example of the time-table information for the instructor. The time-table information for the instructor includes the starting time of the lesson, the ending time of the lesson, the name of the teaching subject and the name of a class in charge relating to the lesson to be executed by the instructor using the instructor's terminal 20, as well as an ID for specifying a text book to be used in the class, information concerning from which page the corresponding class is started, an ID for specifying a reference book to be used in the class and an address information (URL, a folder name, etc.) of a server to be used in the corresponding class. In addition to these, the information may include IDs and the like indicating text books, reference books and other teaching materials that should not be used in the class. Basically, the time-table information includes a list of classes, teaching subjects and time table of which the instructor takes in charge on the one corresponding day; however, this may include information corresponding to one week, pieces of information for respective classes, or information of another instructor. With respect to a method for acquiring the time-table information in the case when the instructor comes to school, with the instructor's terminal 20 that has been turned on being brought with the instructor, the same processes as those of the learner's terminal 10 are carried out.

Additionally, the time-table information transmitted by the school server 23 is stored in the storage unit 1004 of the learner's terminal 10 or the storage unit 2004 of the instructor's terminal 20 in a manner so as to be possibly updated.

Based upon the time-table information received in S202, when the lesson starting time has come, or when a predetermined time before the lesson starting time has been reached, it is automatically transferred to a lesson mode for a predetermined teaching subject (S203). The lesson mode of the learner's terminal 10 means a state in which the learner is allowed to execute processes required for receiving a lesson by using the terminal, that is, for example, processes for opening text book data, note data and reference book data (that is, data is read out from the storage unit 1004 by the control unit 1005 and displayed by the display unit 1001), for refraining from opening data that have nothing to do with the lesson, for confirming the remaining amount of the battery, and for confirming whether or not the state of the learner's terminal 10 is normal. Since the learner's terminal 10 functions in cooperation with the time-table information preliminarily acquired, and automatically prepares for the next lesson, it is possible to provide a convenient system for the user.

Additionally, the transferring process to the lesson mode of the learner's terminal 10 may be executed based upon an operation by the learner. In this case, it is possible to meet a request of the learner who has a will for carrying out preparation for the lesson from the time earlier than the predetermined time before the lesson starting time.

Thereafter, the learner's terminal 10 urges the learner to carry out a log-in operation, and when the learner carries out the log-in operation (S204), the learner's terminal 10 transmits authentication information to the school server 23 (S205). The authentication information mentioned here means information to be inputted for identity verification, and may be prepared as a learner ID and a learner ID-use password, or as biological information (finger print, finger vein, voiceprint, or the like) for authentication of the learner. When the received authentication information is compared with the learner specific information and the identity verification is ensured, the school server 23 informs the learner's terminal 10 of the log-in permission (S206) so that the log-in of the learner's terminal 10 onto the school server 23 is completed. Then, by the storage unit 2004 of the school server 23, presence/absence information indicating the presence of the learner to the corresponding lesson is recorded (S207).

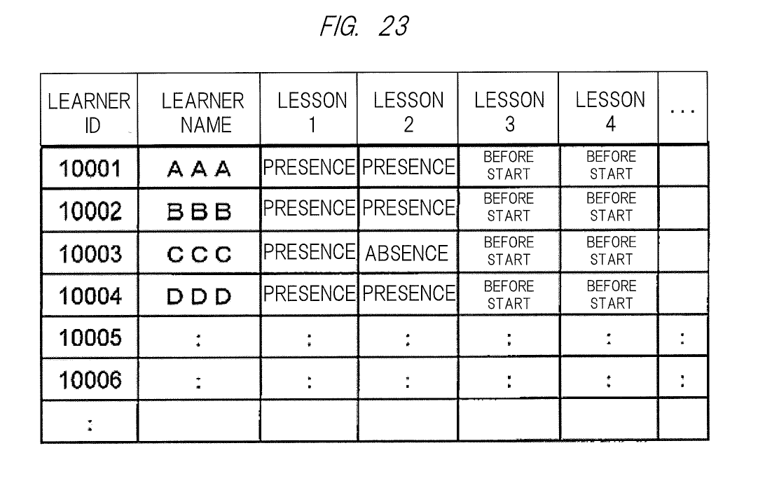

FIG. 23 shows one example of the presence/absence information. The presence/absence information of the present embodiment includes an ID for use in specifying a learner, the name of the learner, and the presence/absence state to the respective lessons (information indicating the presence or absence to or from the lesson, or the state before the start of the lesson). When the school server 23 recognizes that the log-in of the learner has been completed correctly, it updates the information indicating the presence/absence state to the corresponding lesson from “the state before the lesson” to “presence”. When the completion of the identity verification of the learner has not been recognized even after the lesson starting time, or when no log-in is carried out by the learner and the fact is informed by the learner's terminal 10, the school server 23 updates the presence/absence information from “the state before the lesson” to “absence”.

When, in spite of an attempt carried out by the learner, the learner's terminal 10 fails to log-in the school server 23, it urges the learner to retry the log-in process, or carries out a display indicating that the log-in is failed. Moreover, the information to be recorded in S207 may additionally include the submitting state of homework and the state of the learner's terminal 10 (remaining amount of battery, the result of virus check, or the like). In this case, in S205, these pieces of information may be transmitted together with the authentication information.

Upon receipt of a notice for log-in permission, the learner's terminal 10 issues a download request for required data for the corresponding lesson to the school server 23 (S208). The data required for the lesson refer to memos prepared for the corresponding lesson by the instructor and note data stored in the school server 23 by the learner himself or herself. Upon receipt of the download request, the school server 23 transmits the requested data to the learner's terminal 10 (S209).

On the other hand, 145, based upon the time-table information received in S212, when the lesson starting time has come, or when a predetermined time before the lesson starting time has been reached, the instructor's terminal 20 is also automatically transferred to a lesson mode for a predetermined teaching subject (S213). The lesson mode of the instructor's terminal 20 means a state in which the instructor is allowed to execute processes required for executing a lesson by using the terminal, that is, for example, processes which allow the instructor to download a list of learners of the class of which the instructor takes in charge at that time from the school server 23, and to download setting information relating to devices (access point for wireless communication, electronic blackboard, or the like) for use in the class of which the instructor takes in charge. Since the instructor's terminal functions in cooperation with the time-table information preliminarily acquired, and automatically prepares for the next lesson, it is possible to provide a convenient system for the user.

Additionally, the transferring process to the lesson mode of the instructor's terminal 20 may be executed manually, that is, based upon an operation by the instructor, in the same manner as in the transferring process to the lesson mode of the learner's terminal 10.

When the instructor enters the classroom, if the power supply of an electronic blackboard 21 has been turned on (S216), the instructor's terminal 20 possessed by the instructor and the electronic blackboard 21 are allowed to carryout a pairing process (S217). In this case, the pairing process refers to a process for setting the electronic blackboard 21 so as to output a screen of the instructor's terminal 20. For example, in the case when the instructor's terminal 20 and the electronic blackboard 21 are wireless-connected to each other, a method is proposed in which, by allowing the instructor's terminal 20 to broadcast-transmit peripheral apparatus searching data (including address information of the instructor's terminal 20), the blackboard 21 that has received the resulting data transmits response data (including address information of the electronic blackboard 21) and by allowing the instructor's terminal 20 to receive the resulting data, the pairing process is executed. For example, in the case when the instructor's terminal 20 and the blackboard 21 are cable-connected to each other, a method is proposed in which by physically connecting these by a display cable, the pairing process is executed.

Thereafter, when the instructor's terminal 20 transmits a presence/absence information confirming request (S214) to the school server 23, the school server 23 transmits the presence/absence information to the instructor's terminal 20 (S215). In order to allow the school server 23 to determine which lesson of which learner the presence/absence information should be transmitted about, the presence/absence information confirming request includes information indicating the class and lesson, or information indicating the learner. Moreover, the information transmitted to the instructor's terminal 20 by the school server 23 in S215 may additionally include the submitting state of homework and the state of the learner's terminal 10 (remaining amount of battery, the result of virus check, or the like).

Moreover, in the case when a predetermined operation is carried out by the instructor so that the instructor's terminal 20 receives a screen output instruction (S220), the screen data of the instructor's terminal 20 are transmitted to the electronic blackboard 21 that has been paired therewith in S217 (S221), and a display unit 2101 of the electronic blackboard 21 displays the corresponding data (S222). The transmission of the screen data in S221 is not necessarily carried out singly one by one, but it may be continuously carried out until the instructor executes a predetermined process so as to allow the instructor's terminal 20 to give a screen output stopping instruction. In this case, the screen data correspond to, for example, a video input signal, an HDMI signal, or a signal similar to these signals. In addition, data formed by capturing the contents displayed by the instructor's terminal 20 (still image data) may also be used.

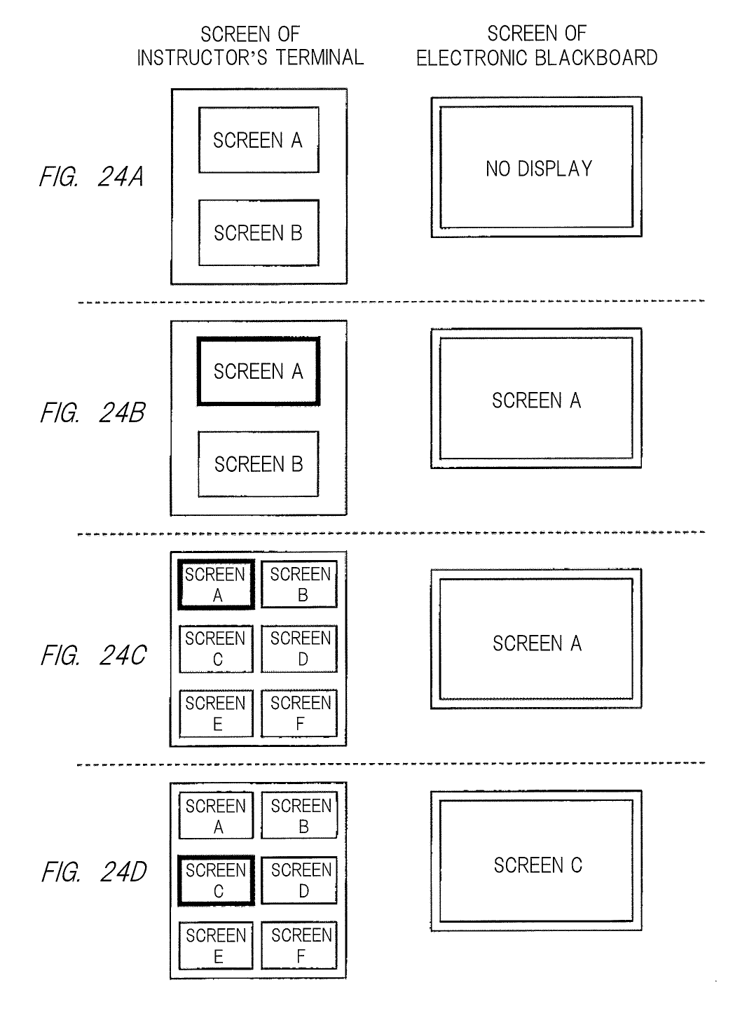

Additionally, FIG. 24 shows display examples of the instructor's terminal 20 and the electronic blackboard 21 respectively. In this case, it is supposed that on the screen of the instructor's terminal 20, screen data (screen data A: screen data that can be shown to the learner) showing an opened state of a text book and screen data (screen data B: screen data that should not be shown to the learner) showing an opened state of a teaching material for the instructor are displayed. Before the screen output instruction in S220, since no screen data to be outputted are given, nothing is shown on the screen of the electronic blackboard 21 (FIG. 24A). When the screen output instruction is given to screen A in S220, screen data A are displayed on the screen of the electronic blackboard 21 (FIG. 24B).

In the case when the instructor's terminal 20 has received an instruction for opening a predetermined page of the text book (S223), the instructor's terminal 20 simultaneously transmits specified page information to the learner's terminals 10 inside the class (S224). The specified page information includes information for specifying a text book and information for indicating the number of page to be opened. Upon receipt of the specified page information, the learner's terminals 10 open the specified page of the specified text book (S225). Since the specified page of the text book can be opened on the display unit 1001 of each of the learner's terminals 10 by the operation of the instructor, it becomes possible to prevent the learners from failing to listen to the instruction of the instructor to be frustrated.

Moreover, when the instructor's terminal 20 has received an operation for starting a monitor of the screen of each of the learner's terminals 10 in the class (S226), the instructor's terminal 20 transmits a screen data acquiring request to the learner's terminals 10 inside the class (S227). The screen data acquiring request may be simultaneously transmitted to all the learner's terminals 10 inside the class, or may be transmitted to only the learner's terminals 10 (one or a plurality of the terminals) specified by the instructor terminal 20. Additionally, in the case when the instructor's terminal 20 transmits the screen data acquiring request to the plural learner's terminals 10, by transmitting the request not simultaneously, but with deviations in timing, it becomes possible to prevent congestion of the transmitting path (in particular, in the case of wireless communication).

Upon receipt of the screen data acquiring request, the learner's terminal 10 transmits its screen data to the instructor's terminal 20 (S228). The screen data mentioned here correspond to, for example, a video input signal, an HDMI signal, or a signal similar to these signals. In addition, data formed by capturing the contents displayed by the instructor's terminal 20 (still image data) may also be used. In the learner's terminals 10, by transmitting the screen data to the instructor's terminal 20 periodically or only when the display contents are updated, it becomes possible to prevent congestion of the transmitting path (in particular, in the case of wireless communication) even in the case when monitoring processes are carried out on the plural learner's terminals 10. In this manner, by freely monitoring the contents displayed by the learner's terminals 10 by the use of the instructor's terminal 20, the instructor makes it possible to confirm whether or not each of the learners is progressively answering practice problems. That is, the instructor can confirm which learner is insufficient in understanding in real time so that it is possible to effectively execute instructions.

Moreover, in the case when upon receipt of a selection operation of the output screen, with the contents displayed by the learner's terminal 10 being monitored, the instructor's terminal 20 thereby receives the switching operation of the output screens (S229), the screen data of the instructor's terminal 20 are transmitted to the electronic blackboard 21 paired therewith in S217 (S230) so that the electronic blackboard 21 is allowed to display the displayed contents of the learner's terminal 10 that are displayed on the instructor's terminal 20 (S231). The transmission of the screen data in S230 is not necessarily carried out singly one by one, but it may be continuously transmitted until the instructor executes a predetermined process so as to allow the instructor's terminal 20 to give a screen output stopping instruction.

FIG. 24C shows a display example of the instructor's terminal 20 after receiving the screen data of the learner's terminal 10 in S228. In addition to the screen data (screen data A) showing an opened state of a text book, screen data (screen data B, C, D, E and F) of the plural learner's terminals 10 can be displayed simultaneously. On the electronic blackboard 21, no screen data of the learner's terminal 10 are displayed, with the screen data A the screen output operation of which has been preliminarily carried out being still displayed. In the case when, in S229, the output screen switching operation is carried out as shown in screen C, the screen data C are displayed on the screen of the electronic blackboard 21 (FIG. 24D); additionally, when an operation for outputting data of a plurality of screens is carried out in S229, specified plural screens may be displayed on the screen of the electronic blackboard 21.

In this manner, since an arrangement is made such that the displayed contents of the learner's terminal 10 selected by the instructor are displayed on the electronic blackboard 21 that can be commonly observed by learners in the class, based upon the operation of the instructor, it becomes possible to carry out effective lesson operations, for example, so as to allow the learners to mutually debate with one another.

Moreover, in the case when the instructor's terminal 20 receives an operation for giving an output permission onto the electronic blackboard 21 to the learner's terminal 10 (S240), the instructor's terminal 20 transmits a mode-switching request to the electronic blackboard 21 (S241) so as to transmit output permission data relative to the electronic blackboard 21 to the specified learner's terminal 10 (S242). The mode-switching request includes address information and device authentication information of the learner's terminal 10 to which the output permission is given. The output permission data include address information and device authentication information of the electronic blackboard 21.

In the case when the learner's terminal 10 receives the operation for giving the output permission to the electronic blackboard 21 (S243), the learner's terminal 10 transmits screen data of the learner's terminal 10 to the electronic blackboard 21 specified by the output permission data (S244) so that the electronic blackboard 21 displays the corresponding data (S245). At this time, between the learner's terminal 10 and the electronic blackboard 21, the identity verification may be carried out by using the aforementioned authentication information. The transmission of the screen data in S244 is not necessarily carried out singly one by one, but it may be continuously carried out until the learner's terminal 10 receives a screen output stopping instruction. In this case, the screen data correspond to, for example, a video input signal, an HDMI signal, or a signal similar to these signals. In addition, data formed by capturing the contents displayed by the learner's terminal 10 (still image data) may also be used.

In this manner, since the arrangement is made such that the displayed contents of the learner's terminal 10 are displayed on the electronic blackboard 21 so as to be commonly observed by learners in the class, based upon the operation of the learner, it becomes possible to carry out effective lesson operations, for example, so as to allow the learners to mutually debate with one another.

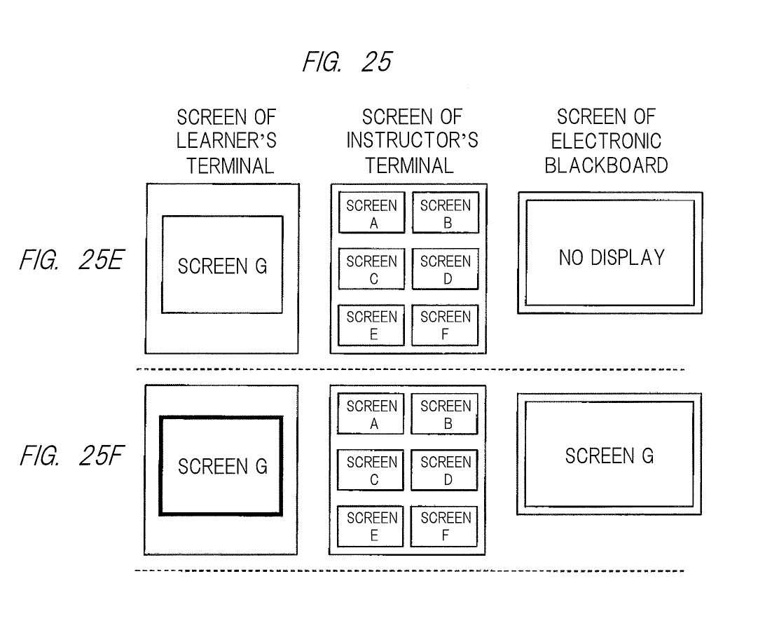

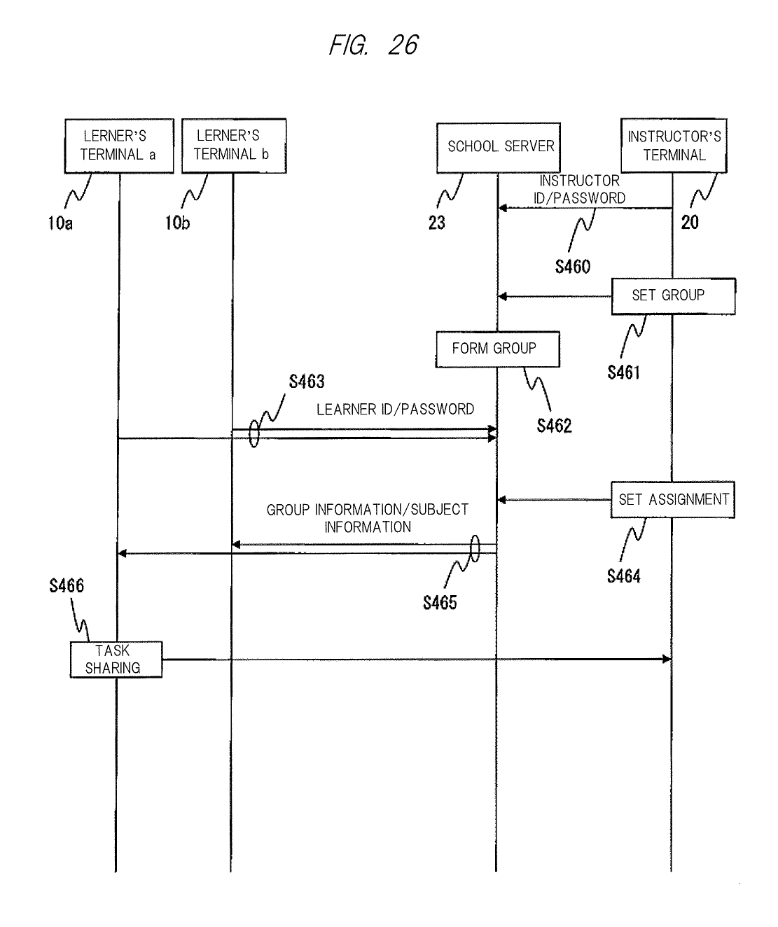

In the case when the mode is switched in S241, nothing is displayed on the electronic blackboard 21 (FIG. 25E). When the output operation is carried out in S243, the screen data (screen data G) of the learner's terminal 10 are displayed on the electronic blackboard 21 (FIG. 25F).

In the case when the instructor's terminal 20 receives an operation for removing the output permission onto the electronic blackboard given to the learner's terminal 10 (S246), the instructor's terminal 20 transmits a mode-switching request to the electronic blackboard 21 (S247) so that an output permission finishing notice relative to the electronic blackboard is transmitted to the specified learner's terminal 10 (S248). The mode-switching request includes address information of the learner's terminal 10 to which the output permission has been given and address information of the instructor's terminal 20. Upon receipt of the output permission finishing notice, the learner's terminal 10 stops the transmission of screen data (S249). Upon receipt of the mode-switching request, the electronic blackboard 21 displays screen data transmitted from the instructor's terminal 20, or alternatively, no display is given (S250). That is, a state shown in FIG. 24C or FIG. 25E is maintained.

Moreover, each learner may freely write a question or an opinion to the instructor on the learner's terminal 10 during the lesson (S251). These include, for example, matters about which the learner failed to ask a question to the instructor orally, information indicating the level of understanding of the lesson (such as “well understood”, “not understood this point at all”, or the like), or an answer to a practice problem delivered by the instructor during the lesson. The contents of the written matters are transmitted to the school server 23 (S252) together with the date and time of the entry, information of the person of the entry, and the like, and the school server 23 stores these as note data (S253). The learner's terminal 10 may transmit the contents to the school server 23 each time the learner writes in, or may transmit the contents to the school server 23 every time a predetermined period of time has elapsed.

When the instructor carries out an operation for confirming the note data on demand (S254), the instructor's terminal 20 transmits a note data acquiring request to the school server 23 (S255), and the school server 23 transmits the note data to the instructor's terminal 20 (S256).

Thus, the instructor can confirm the level of understanding on the lesson of each learner in real time. Moreover, by accumulating these data, it is possible to confirm the learning history of each of the learners.

Moreover, the instructor or the learner may directly write onto the electronic blackboard 21 during the lesson (S260). When the instructor's terminal 20 receives an operation for storing the contents written in the electronic blackboard 21 (S261), the instructor's terminal 20 transmits a data storing request to the electronic blackboard 21 (S262) so that the electronic blackboard 21 transmits captured data on the screen of the electronic blackboard to the instructor's terminal 20 (S263). Additionally, the electronic blackboard 21 may be designed to accept the operation for storing the contents written therein. Upon receipt of the captured data on the screen of the electronic blackboard, the instructor's terminal 20 stores the data (S264).

When the instructor's terminal 20 receives an operation for transferring the captured data on the screen of the electronic blackboard stored in S264 to the learner's terminal 10 (S265), the instructor's terminal 20 transmits the captured data on the screen of the electronic blackboard to the learner's terminal 10 (S266) so that the learner's terminal 10, which has received the data, stores the data (S267).

Additionally, without allowing the instructor's terminal 20 to store the captured data on the screen of the electronic blackboard, the electronic blackboard 21 or the school server 23 may be designed to store the data.

With this arrangement, since the contents written onto the electronic blackboard 21 during the lesson are delivered to the learner's terminal 10 possessed by each of the learners, the learner can effectively use the data for review.

When the learner's terminal 10 receives an operation for finishing the lesson mode (S268), the learner's terminal 10 finishes the lesson mode, and transmits note data written during the lesson to the school server 23 (S269). The finish of the lesson mode may be automatically carried out by the learner's terminal 10 based upon the time-table information. However, the lesson might be extended in some cases; therefore, a display for urging the learner to finish the lesson mode is given, and in the case when the operation for stopping the finish of the lesson mode has not been carried out within a predetermined period of time, the lesson mode may be automatically finished. With this arrangement, the learner's terminal 10 can be used more conveniently.

Upon receipt of the note data, the school server 23 records the note data (S270).

### Embodiment 3

Next, the following description will discuss embodiment 3 in accordance with the present invention. More specifically, explanations will be given to an example for a cooperative learning process in which a plurality of learners mutually teach one another and learn with one another by using the learner's terminals 10.

The present embodiment will be explained by exemplifying a cooperative learning group in which a plurality of learners form a group and each group partially executes one of subjects. Additionally, the present embodiment has the same configurations, functions, elements and the like as those of the aforementioned embodiment, within a required range. FIG. 26 is a diagram that shows one example of a cooperative learning setting process.

An instructor ID and an instructor-use password are inputted to an instructor's terminal 20, and a log-in is made to the school server 23 through a network 22 in the school (S460).

The instructor's terminal 20 transmits group settings composed of pieces of information including the number of people in each group set by the instructor and the number of groups or the like, to the school server 23 (S461).

Based upon the group settings transmitted from the instructor's terminal 20, the school server 23 forms groups (S462). More specifically, the school server 23 forms or specifies a title of the group, names of learners forming the group and ID's of the learners for each of the groups.

A learner's terminal 10a and a learner's terminal 10b that belong to the same group are allowed to log-in the school server 23 individually by using the learner ID and the learner ID-use password (S463).

The instructor's terminal 20 transmits pieces of subject information, such as learning time, degree of difficulty, contents of learning and common format or the like determined by the instructor to the school server 23 (S464). In this case, the common format refers to file formats having the same font, the same character size, the same form, pattern, configuration and the like.

The school server 23 delivers the name of a group to which the learners belong, learner specific information of the respective learners belonging to the same group, the above-mentioned subject information, or the like, to the learner's terminals 10a and 10b (S465).

The learner's terminal 10a, which is possessed by one of the learners who becomes the representative of the group as a result of a meeting among the learners, transmits tasks partially shared by the respective learners to the instructor's terminal 20 (S466).

As described above, a group-forming process can be quickly carried out so as to execute cooperative learning by a plurality of learners.

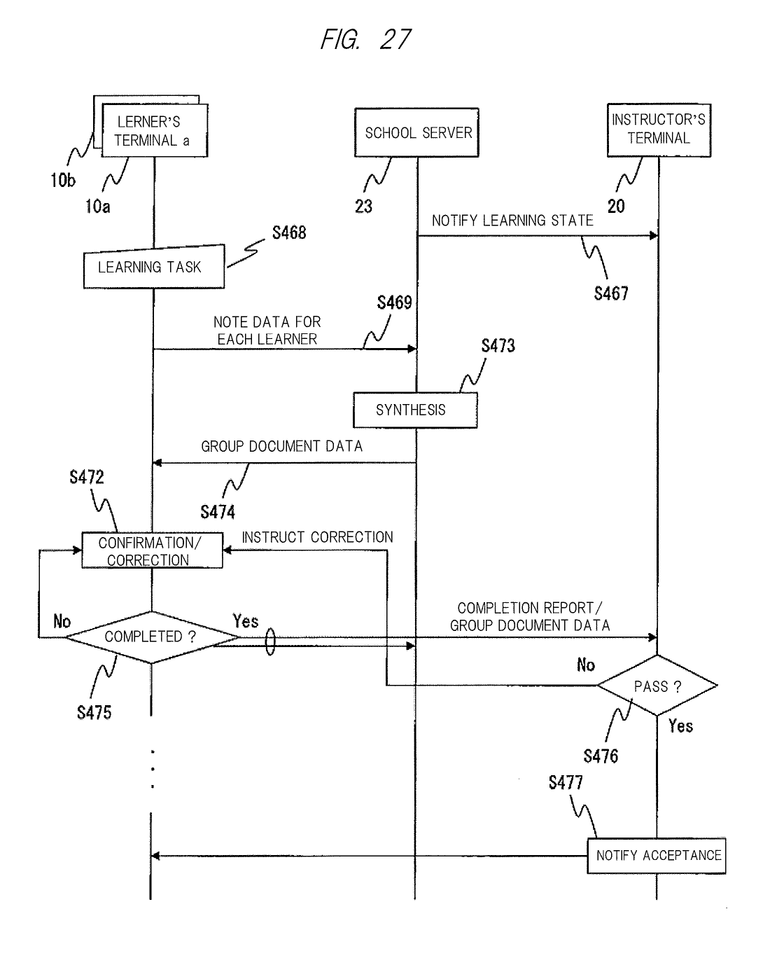

FIG. 27 shows one example of the cooperative learning process, and explanations will be given thereto.

The school server 23 transmits a group-forming state, a task-sharing state, note data for each of the learners, synthesized note data and the like to the instructor's terminal 20 (S467).

The learning task is started by the learners using the learner's terminals 10 (S468).

After the learning task by the learners, the learner's terminals 10 transmit note data including their own making document data having a common format inside the learner specific information to the school server 23 (S469).

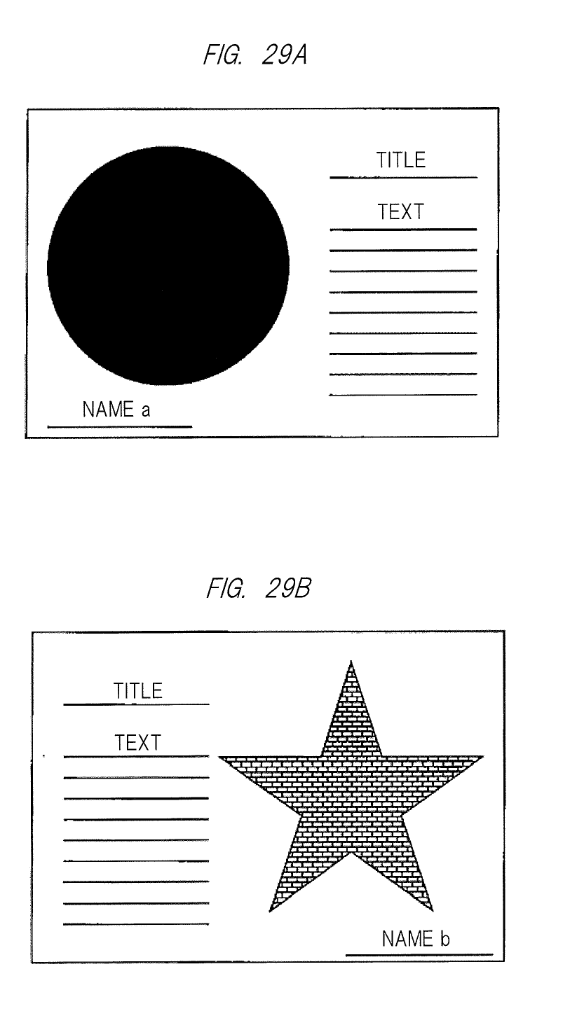

FIGS. 29A and 29B show one example of their own making document data corresponding to the note data inside the learner specific information. FIG. 29A shows his or her own making document data formed by the learner's terminal 10a. FIG. 29B shows his or her own making document data formed by the learner's terminal 10b. The own making document data are data composed of a title, a name, a text and charts, which are different from one another depending on the learners.

The school server 23 synthesizes their own making document data transmitted by the respective learners so that group document data are formed (S473). The group document data are data formed by synthesizing note data of the learners or their own making document data, which correspond to achievements of the cooperative learning. Additionally, the reading and writing access right for the group document data is given only to, for example, learners belonging to the corresponding group or the instructor, and the others cannot edit the data. More specifically, in the case when the group document data are stored in the storage unit 2004 of the school server 23, information for allowing only the learners and instructor belonging to the group that has made the achievements to read and write the data is added thereto. By reference to this information, even in the case when, for example, a learner's terminal used by a learner of another group attempts to read the information stored in the storage unit 2004 of the school server 23, the school server 23 is made to refuse the attempt.

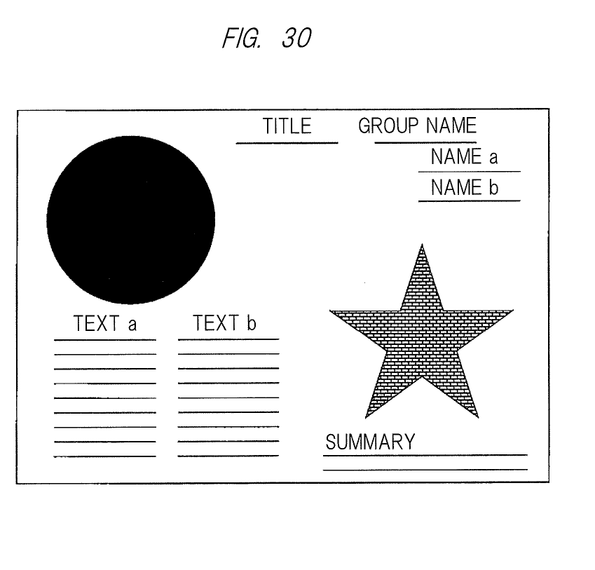

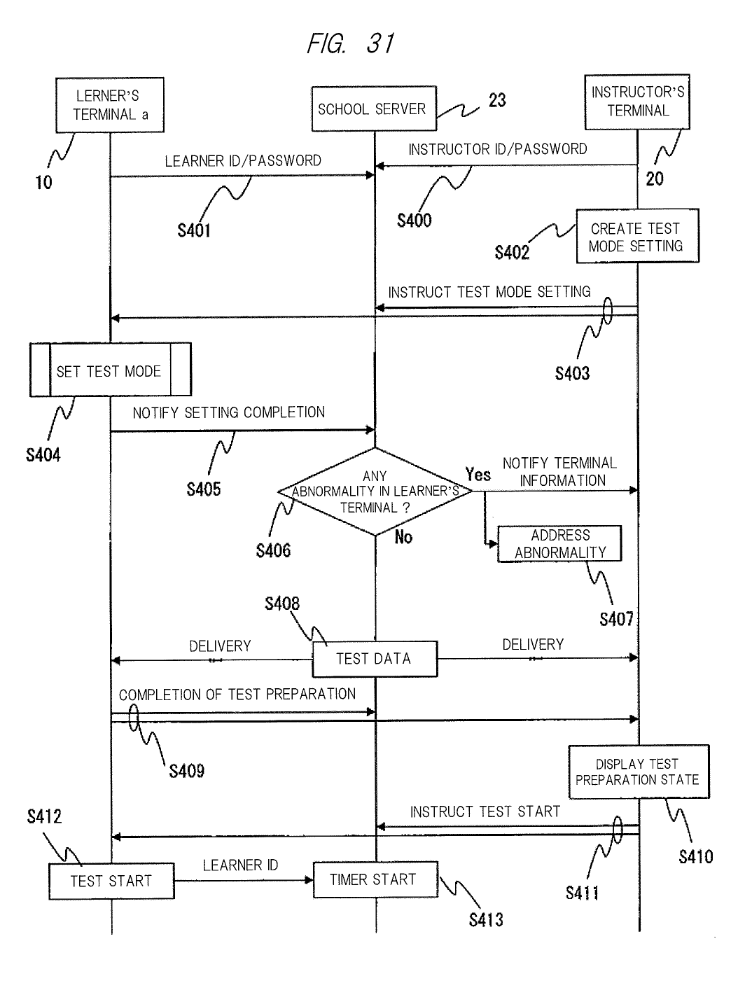

The school server 23 transmits the synthesized group document data to the learner's terminals 10a and 10b (S474). FIG. 30 shows a display example of synthesized group document data. Their own making document data shown in FIG. 29A and FIG. 29B are synthesized with each other so that the learner names, group names and date or the like are added thereto.

In the case when group document data are determined as being uncompleted by the learners of the learner's terminals 10a and 10b or by either one of the learners (S475: No), the sequence waits for a correction of the note data by the learner, and the correction is carried out thereon (S472). When the data are determined as being completed (S475: Yes), a completion report of the group document data is transmitted to the school server 23 and the instructor's terminal 20, and the learner's terminal 10 waits for the decision of success or failure made by the instructor and given through the instructor's terminal 20.

Next, the decision of success or failure about the group document data is given by the instructor (S476). In the case of failure (S476: No), an instruction for correction is transmitted to the learner's terminals 10a and 10b. In the case of success (S476: Yes), the instructor's terminal 20 transmits a notice of success to the learner's terminals 10a and 10b (S477).

By using the above-mentioned method, it becomes unnecessary for the learners to synthesize a plurality of their own making document data so as to form group document data; therefore, it is possible to provide a convenient method for the user.

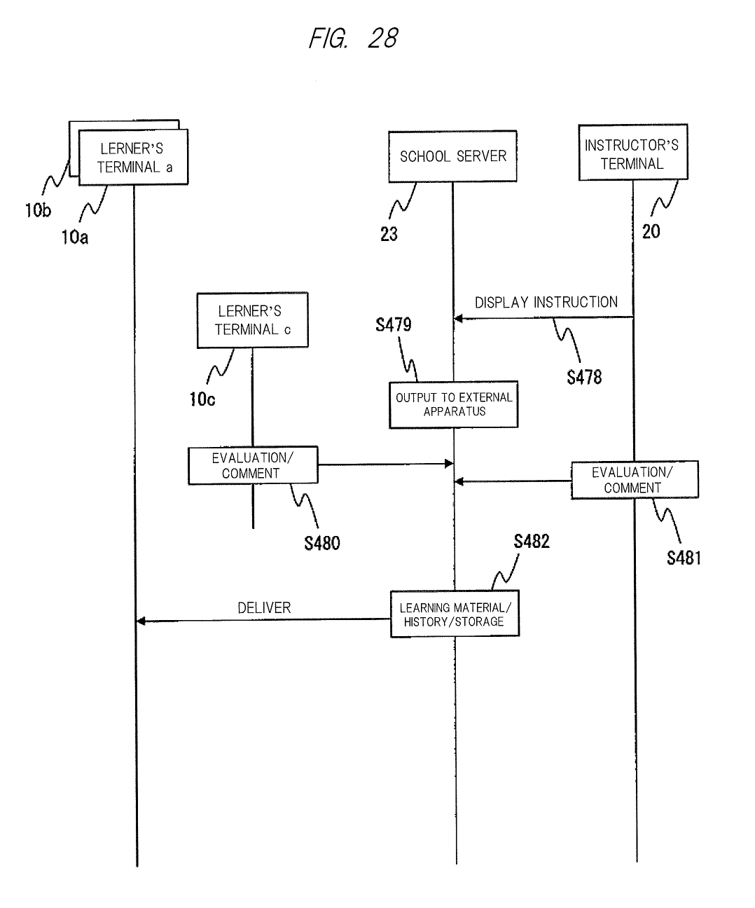

FIG. 28 is a diagram showing one example of a publishing process of the cooperative learning.

In this case, a learner's terminal 10c is a learner's terminal 10 that does not belong to the same group as that of the learner's terminal 10a and the learner's terminal 10b; however, its log-in to the school server 23 has already been made, and its identify verification has been completed.

The instructor's terminal 20 transmits an intention for displaying group document data of a desired group to the school server 23 (S478).

Upon receipt of the instruction from the instructor's terminal 20, the school server 23 gives an instruction for outputting the corresponding their own making document data to an external output apparatus, such as the electronic blackboard 21, a projector, a printer or the like (S479).

The learner's terminal 10c and the instructor's terminal 20 transmit evaluation and comments to the school server 23 (S480 and S481).

The school server 23 stores the learner specific information such as note data and a learning history or the like, and informs the learner's terminal 10a and 10b of the contents of the storage (S483).

In the present embodiment, a plurality of learners form one group, and tasks for one subject are shared by using the respective learner's terminals 10 so that it is possible to carry out a cooperative learning process. Moreover, by using the common format, note data formed by the learners can be easily synthesized with one another.

### Embodiment 4

Next, the following description will discuss embodiment 4 in accordance with the present invention. More specifically, explanations will be given to an example in which learners take a test by using learner's terminals 10 in school, and the results of scores are obtained. Additionally, the present embodiment has the same configurations, functions, elements and the like as those of the aforementioned embodiments are used within a required range.

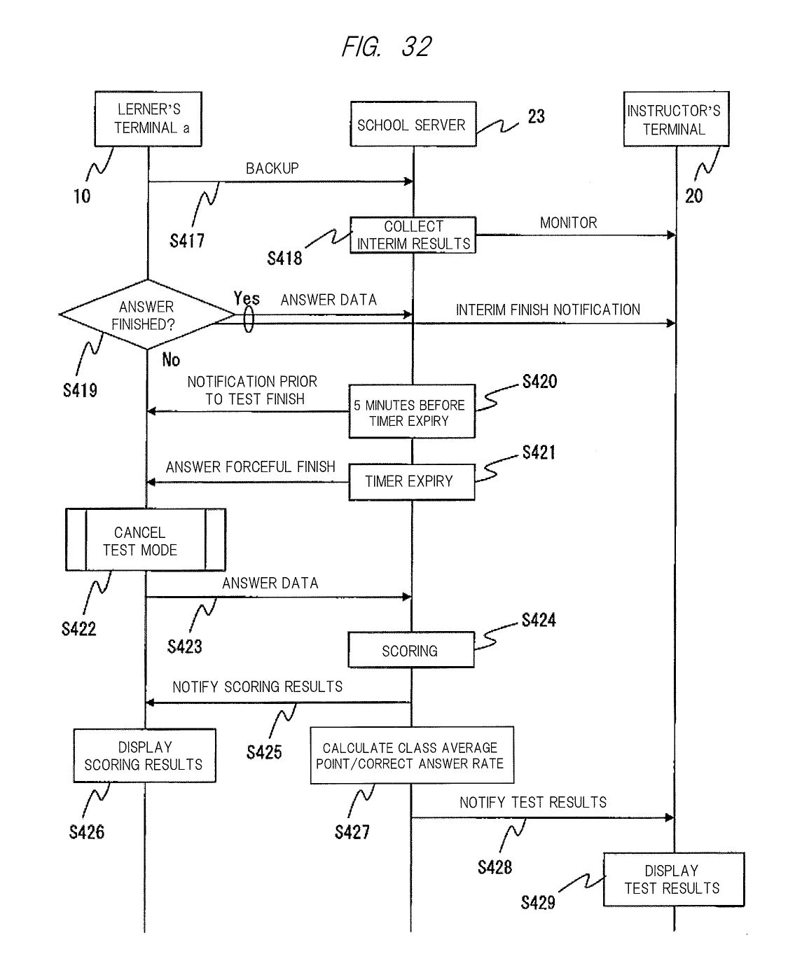

FIGS. 31 and 32 are diagrams that show one example of a test receiving process.

An instructor's terminal 20 is allowed to log-in the school server 23 by using an instructor ID and an instructor-use password (S400).

A learner's terminal 10 is allowed to log-in the school server 23 by using a learner ID and a learner-use password (S401).

The instructor's terminal 20 carries out settings, such as a test ID, a test required time setting, a text book viewing limitation, limitations for activating applications (computers) or the like, a web retrieval availability setting, a web retrieval range setting, a leaving midway availability setting, a scribbling availability setting, a setting at the time of an error in the learner's terminal, a setting for answer backup, and the like (S402).

The instructor's terminal 20 transmits a test-mode setting instruction to the learner's terminals 10 and the school server 23 (S403).

The learner's terminal 10 analyzes test setting information contained in the test-mode setting instruction. The test setting information includes the test title, the test ID, a test required period of time, and pieces of limitation information, such as the impossibility of viewing a text book, the impossibility of activating an application and the impossibility of web retrieval.

The school server 23 has data composed of the test title, the test ID, subjects, problems, an answer sheet template and the like.

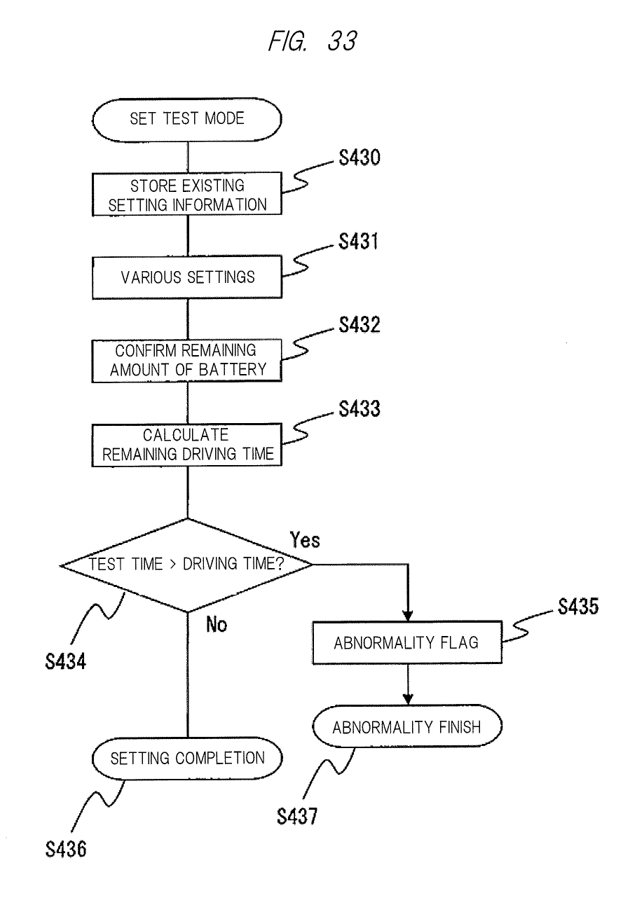

Referring to FIG. 33, the following description will explain a test mode setting process (S404) to be executed when the learner's terminal 10 receives a test mode setting instruction from the instructor's terminal 20 in detail.

The learner's terminal 10 stores the current setting state in the storage unit 1004 as the existing setting information (S430).

Next, various settings are carried out, which include the impossibility of operating the camera unit 1008, the impossibility of operating the voice output unit 1010, the impossibility of viewing text books, the impossibility of activating an application and the impossibility of web retrieval, or the like (S431).

After completion of the various settings, the control unit 1005 confirms the remaining amount of the battery of the power-supply unit 1003 (S432) so that the remaining driving time of the learner's terminal 10 is calculated based upon the battery remaining amount (S433).

The test period of time corresponding to the test answering time included in the test mode setting instruction of the instructor's terminal 20 is compared with the above-mentioned driving time (S434).

In the case when the test period of time exceeds the driving time (S434: Yes), the control unit 1005 puts an abnormal flag, thereby completing the sequence in an abnormal state (S435).

In the case when the test period of time is below the driving time (S434: No), the control unit 1005 completes the test mode setting (S436).

Next, the learner's terminal 10 transmits a notice of setting completion to the school server 23 (S405) so that the school server 23 determines any abnormal state occurring in the learner's terminal 10 based upon the presence or absence of the abnormal flag (S435) (S406). If there is any abnormality (S406: Yes), the school server 23 informs the instructor's terminal 20 of the terminal specific information so that the reactivation of the learner's terminal 10 is carried out or an abnormality addressing process, such as an exchange to a substitute terminal or the like, is carried out by the instructor (S407).

If there is no abnormality (S406: No), the school server 23 delivers test data corresponding to the test ID to the learner's terminal 10 and the instructor's terminal 20 (S408). Additionally, the contents of the test are not displayed at this time.

Upon receipt of a predetermined operation by each of the learners who are ready for taking the test, the learner's terminal 10 informs the school server 23 and the instructor's terminal 20 of the fact that the learners are ready for the test (S409).

Based upon the operation of the instructor, the instructor's terminal 20 displays test data, or a preparation state for the test of each of the learners and the like (S410). Upon receipt of a predetermined operation by the instructor who has determined that it is possible to start the test, the instructor's terminal 20 transmits a test starting instruction to the school server 23 and the learner's terminal 10 (S411).

Upon receipt of the instruction for starting the test from the instructor's terminal 20, the learner's terminal 10 starts displaying the contents of the test data and transmits the learner ID to the school server 23 (S412).

The school server 23 receives the test starting instruction, and starts a timer (S413). The contents of the test are displayed by the learner's terminal 10 so that the learner carries out an answering process.

The learner's terminal 10 transmits the answer data to the school server 23 each time the test answer has been made (S417). By transmitting the answer data for each answer, even when there is an abnormal state such as freeze on the learner's terminal 10, the school server 23 is allowed to hold the answers of the learner. Not limited to this arrangement, the answer data may be transmitted for each period of time, and by changing the transmission timing in each learner's terminal 10, it becomes possible to reduce the communication traffic. Additionally, the answer data transmitted to the school server 23 are held by the school server 23 in such a manner as to allow the learner to correct the data, if desired.

The school server 23 collects the answering state of the learner's terminal 10, for example, interim reports, such as the answering time for each problem, or the like, while the instructor's terminal 20 monitors the answering state on demand (S418). By freely monitoring the screen of each learner's terminal 10 by using the instructor's terminal 20, the instructor can confirm, for example, what degree the answering process of the test of each learner has proceeded to. That is, the instructor can confirm which learner is insufficient in the degree of understanding in real time so that it becomes possible to instruct more effectively.

Upon receipt of a test answering finish operation based upon an operation by the learner (S419: Yes), the learner's terminal 10 transmits the answer data to the school server 23, and also transmits an interim finish notice to the instructor's terminal 20.

In the case of having no test answering finish operation (S419: No), the school server 23 transmits the fact that it is five minutes before the test finish time to the learner's terminal 10, five minutes before the timer finish time (S420).

At the timer finish time, the school server 23 gives a request for a forceful answering finish to the learner's terminal 10 (S421). Upon receipt of the request for a forceful answering finish, the learner's terminal 10, for example, displays a notice, such as “test time finish” or the like, on the display unit 1001 of the learner's terminal 10, and tries not to accept the operation for answering from the learner. Thereafter, the learner's terminal 10 carries out a test mode releasing process for releasing the test-mode setting (S422).

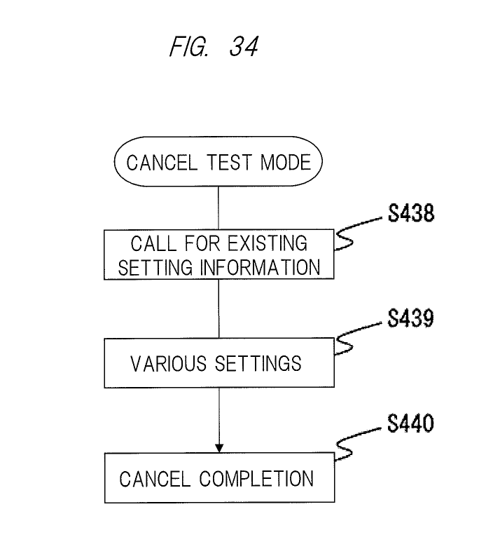

FIG. 34 is a diagram that shows one example of the test mode canceling process.

The learner's terminal 10 calls for terminal setting information stored in the storage unit 1004 at the time of the test-mode setting process (S438). Then, it carries out the same settings as those various settings carried out at the time of the test-mode setting process (S439) so that the test mode setting is canceled (S440).

After releasing the test-mode setting, the learner's terminal 10 transmits the answer data to the school server 23 (S423).

By referring to the correct answers preliminarily stored, the school server 23 carries out scoring processes on the answer data transmitted by each of the learner's terminals 10 (S424).

After completion of the scoring processes, the school server 23 notifies the corresponding learner's terminal 10 of the resulting scores (S425) so that the learner's terminal 10 displays the resulting scores (S426).

After completion of the scoring processes of the test, the school server 23 calculates the average score of the class, the rates of right answers or the like (S427), and notifies the instructor's terminal 20 as information of the test scores (S428).

The instructor's terminal 20 displays the class specific information, such as the average score of the class, the rates of right answers or the like (S429).

Additionally, in the present embodiment, the impossibility of voice output and the impossibility of viewing a text book are imposed by limitation information; however, the present embodiment is not limited by these. For example, only one portion of text book data may be permitted to view, or may be inhibited to view. Moreover, these settings may be given depending on the respective learners.

Moreover, the abnormality check of the learner's terminal 10 is carried out by the school server 23 in S406; however, the present embodiment is not limited by this. For example, a self-checking process may be carried out by the learner's terminal 10.

Furthermore, with respect to the scoring process, an automatic scoring process is carried out by the school server 23 and the results are transmitted to the learner's terminal 10; however, the present embodiment is not limited by this. For example, the automatic scoring process may be carried out either by the learner's terminal 10 or by the instructor's terminal 20, or the scoring process may be started by an operation of the instructor. By allowing the school server 23 to carry out the scoring process, it is possible to reduce the processing load of the learner's terminal 10 or the instructor's terminal 20. On the other hand, by allowing the learner's terminal 10 to carry out the scoring process, it becomes possible to carry out the scoring process even outside the network. By allowing the instructor's terminal 20 to carry out the scoring process, it becomes possible to carry out a scoring process even in the case of a subject, such as pictures or the like, that requires a difficult judgment, and also to add comments or the like thereto properly; thus, it becomes possible to give detailed instructions.

Furthermore, with respect to the display of the results of the scoring process and the display of the test results, the school server 23 notifies the learner's terminal 10 of these displays; however, the present embodiment is not limited by these. For example, these may be notified to the learner's terminal 10 by the instructor's terminal 20 through an operation of the instructor. Thus, it becomes possible to prevent unnecessary information from being published to the learners.

In the present embodiment, since it is possible to limit unnecessary functions against the instructor's intention at the time of having a test, unfair deeds of the learners can be prevented. Moreover, since an abnormality check, such as a battery trouble or the like, is preliminarily carried out on the terminal, the possibility of any intervention of a test can be reduced. Furthermore, by setting a timer on each of the learners, the test receiving time can be evenly set.

### Embodiment 5

Next, the following description will discuss embodiment 5 in accordance with the present invention. In the present embodiment, explanations will be given to a specific method for evaluating achievements of learners. Additionally, in the present embodiment, the same configurations, functions, elements and the like as those of the aforementioned embodiments are used within a required range.

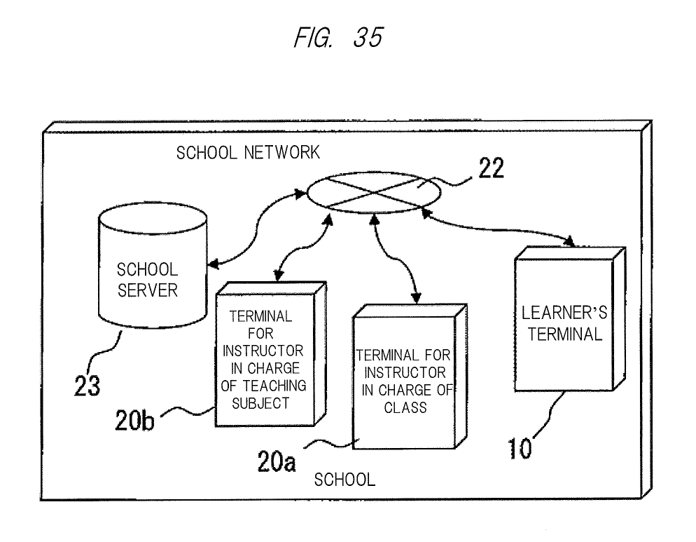

FIG. 35 shows one example of a system inside school. In the network 22 in the school of the present embodiment, an instructor's terminal 20a for the instructor in charge of a class and an instructor's terminal 20b for an instructor in charge of a specific subject are connected to each other, and the other structures are the same as those of FIG. 1. Additionally, in the following description, for convenience of explanation, only one instructor's terminal 20b for an instructor in charge of a specific subject is used however, since there are a plurality of subjects normally, with a plurality of instructors in charge of those subjects being present, there are a plurality of instructor's terminals for instructors in charge of those subjects.

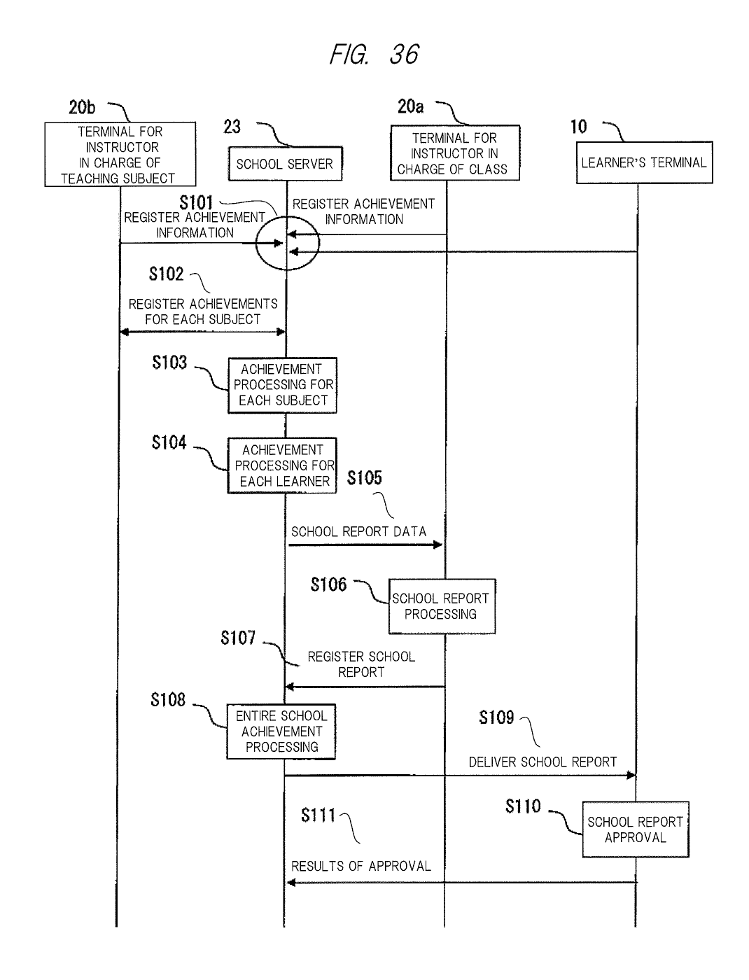

FIG. 36 is a diagram showing one example of a process for processing achievements.

Each of the learner's terminals 10, the instructor's terminal 20a for the instructor in charge of the class and the instructor's terminal 20b for the instructor in charge of a subject register pieces of achievement information required for processing the achievements in the school server 23 (S101).

The above-mentioned pieces of achievement information include, for example, information for use in evaluating learning achievements including test achievements for the respective subjects, information for use in evaluating learning attitudes and information for use in evaluating cooperativeness in the organization, which are pieces of information required for evaluating achievements for the respective subjects and general achievements of each of the learners.

Additionally, the timing at which the achievement information is registered is dependent upon the contents of the achievement information, and, for example, in the case when, upon evaluating learning achievements, test achievements are specifically used, the registering process may be carried out at the timing in which the results of scores after the test are stored in the learner's terminal 10. In the case when, upon evaluating learning attitudes, the number of remarks in a lesson are specifically used, by using the voice input unit 1009 in the learner's terminal 10, the number of remarks is measured, and the result of measurements can be registered in the school server 23 as the number of remarks.

In addition, after completion of the lesson of each subject, the instructor's terminal 20b for the instructor in charge of the subject may register the learning attitudes. Moreover, at the time of the completion of lessens of one day, the instructor's terminal 20a for the instructor in charge of the class may resister the cooperativeness in the organization of each learner. Furthermore, the amount of communications with the other learners in the class is measured by the communication unit 1006, and the amount of communication of each day and communication partners may be stored in the storage unit 1004 as a communication state; thus, since it is considered that as the amount of communications and the communication partners become greater, more communications are ensured, these may be registered as information for use in evaluating the cooperativeness in the organization.

Next, the instructor in charge of a subject confirms the achievement information of the subject in charge, and corrects the information, if necessary, by using the instructor's terminal 20b for the instructor in charge of the subject, and then registers the information (S102).

Next, the school server 23 executes an achievement processing for each of the subjects (S103). The achievement processing for each of the subjects more specifically includes processes for taking statistics of achievements of the respective subjects for each of the classes and for forming the achievement for each subject of each learner as the achievements for each different subject. These processes can be said as processes for calculating the achievements to be written in a school report for each of the learners.

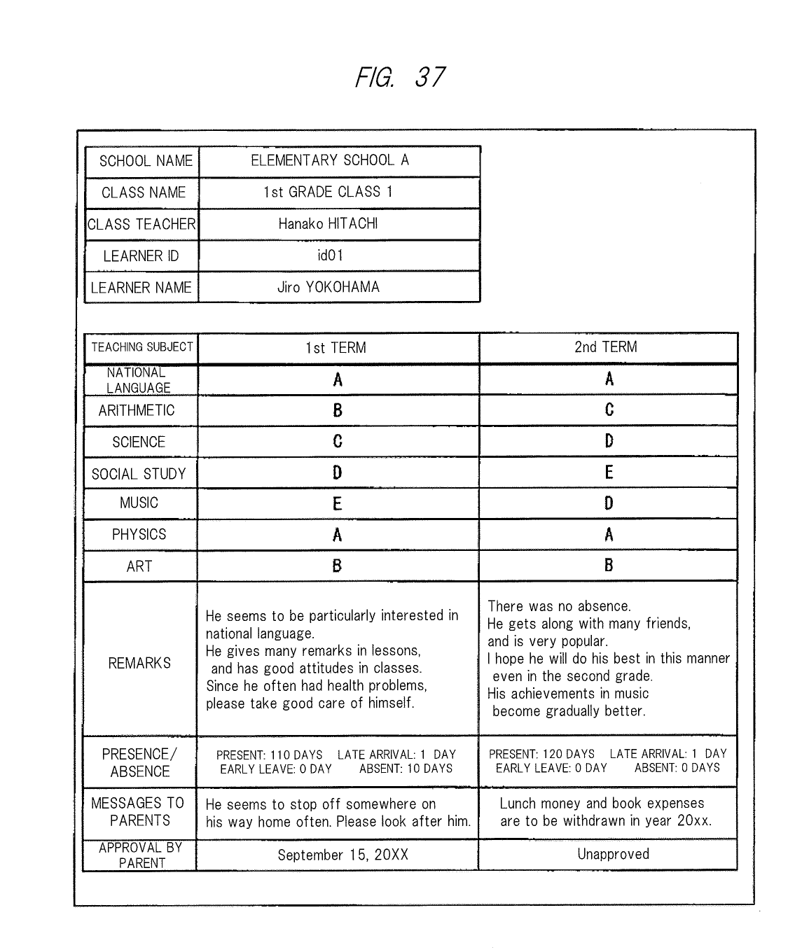

Next, the school server 23 executes the achievement processing for the individual learner (S104). In the achievement processing for the individual learner, more specifically, based upon the above-mentioned achievements for the respective subjects calculated separately for the respective subjects and the above-mentioned achievement information, school report data to be notified to each of the learners as general achievements are formed. FIG. 37 shows a specific example of the school report data. The school report data include the school specific information, the grade specific information, the class specific information, the learner basic information and the learner specific information, and also include, for example, the school name, the class name, the name of the instructor in charge, the learner ID, the learner name, achievements of the respective subjects, observations, the presence/absence information, contact matters to the parent and the approval of the parent. The observations refer to matters that are extracted from the achievements for the individual subjects and the achievement information as specifically noted information, and automatically generated. For example, the above-mentioned communication state is acquired from the achievement information upon evaluating cooperativeness in the organization, and as the result of statistical processes, in the case when the deviation value in the communication state is very good, a written sentence, such as “this student communicates with many friends and is very popular”, or the like, is automatically generated. In addition, from the presence/absence information, a sentence, such as “no absence” or the like, is automatically generated.

Next, the school server 23 transmits the school report data thus generated to the instructor's terminal 20a for the instructor in charge of the class (S105).

Upon receipt of the above-mentioned school report data, the instructor's terminal 20a for the instructor in charge of the class carries out a school-report forming process (S106). More specifically, the school-report forming process includes a display of school report data as well as a confirming process and a describing process of observations by the instructor, and the instructor in charge of the class corrects the school report data, if necessary, and registers the data in the school server 23 (S107).

The school server 23 carries out the total school achievement processing based upon the school report data of the learners of the total school (S108). More specifically, the statistical data in school for achievements of the learners that belong to the school are calculated. The statistical data in school more specifically correspond to statistical data, such as the average in school of the rate of presence and the average of the individual grade of test achievements in common throughout the nation, that are calculated, with desired learners belonging to the school being used as a population.

Next, the school server 23 transmits the school report to the learner's terminal 10 (S109). Then, upon receipt of the school report, the learner's terminal 10 allows the parents to approve the school report (S110). The method for approving the school report is carried out by, for example, allowing the parent to input a password known only by the parent as a trigger. Moreover, at the time of the approval, information that only the parents can view may be displayed.

Next, the learner's terminal 10 transmits the result of approval to the school server 23 (S111). The result of approval refers to information indicating that the parent has confirmed the contents of the school report and approved them, and for example, the information may be taken into the school report together with the date of the input of the password and the electronic signature of the parent obtained through the password input, and transmitted to the school server 23. That is, it is only necessary that the fact that the school report approval process has been completed normally is transmitted to the school server 23.

By using the above-mentioned processes, the sequence of the achievement processing can be positively carried out without imposing so many loads to the instructor in charge of a subject, the instructor in charge of the class and the parents.

Moreover, it is not necessarily required to carry out the achievement processing for each of the subjects, the achievement processing for each of the learners and the achievement processing for the entire school at the above-mentioned timing as shown in FIG. 36, and these may be carried out at any desired timing, as long as the required achievement information has been registered in the school server 23.

### Embodiment 6

Next, the following description will explain an embodiment 6 in accordance with the present invention. More specifically, the explanation will be given by exemplifying a case in which a learner carries out homework in home by using the learner's terminal 10. Additionally, in the present embodiment, the same configurations, functions, elements and the like as those of the aforementioned embodiments are used within a required range.

Moreover, in the present embodiment, the explanation will be given on the assumption that note data, text book data and reference book data or the like are stored in the school server 23.

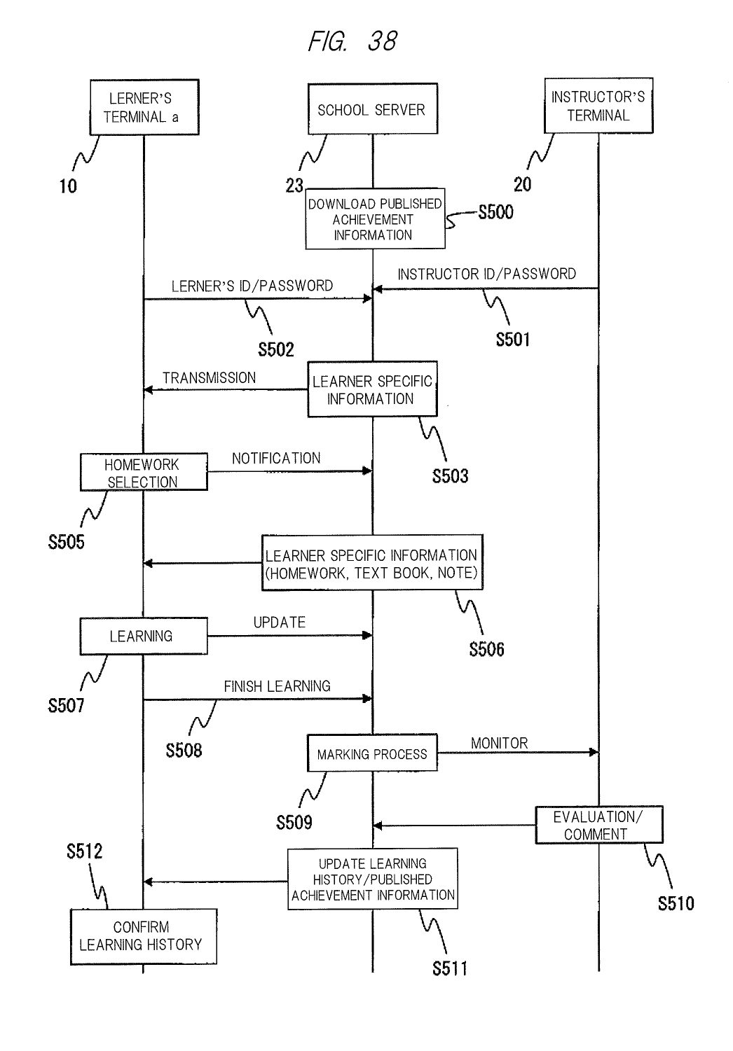

FIG. 38 is a diagram that shows one example of a homework learning process.

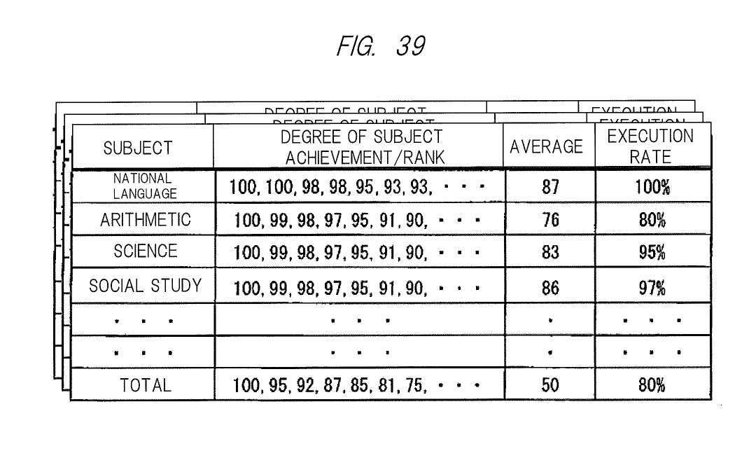

The school server 23 downloads published achievement information from an administration server 53 managed by an administration organization (S500). FIG. 39 shows an example of the published achievement information. The published achievement information refers to a set of achievement information transmitted from the school server 23 within a region in one of the national areas or a specific prefectural area, and is more specifically composed of subjects, the degree of subject achievement, the ranking, the average and the rate of execution, or the like, and since the learner is allowed to recognize the ranking in the nation, the comparison from the average, and how many learners exist in the learning by the use of execution rate, it becomes possible to enhance learner's motivation to learn. Additionally, the published achievement information may be respectively obtained for each grade as well as for year class. Moreover, it is supposed that the published achievement information corresponds to the degree of achievement for learning; however, not limited to this. For example, the information may be prepared not as the degree of achievement, but as the scores of tests. Additionally, in the case when the published achievement information includes such personal information as to identify the learner, it is suitable not to publish the information to the public. However, with respect to some students who achieved excellent results, their names, changed names, or the like may be published. This case sometimes devotes to the improvement of learner's motivation to learn.

Next, the instructor's terminal 20 accepts the instructor's ID and the instructor's ID password based upon the operation of the instructor, and is allowed to log-in the school server 23 through the network 2 and the network 22 in school (S501).

The learner's terminal 10 accepts the learner's ID and the learner's ID password based upon the operation of the learner, and is allowed to log-in the school server 23 through the home network 62, the network 2 and the network 22 in school (S502).

The school server 23 transmits the learner specific information corresponding to the learner ID to the learner's terminal 10 (S503).

The learner's terminal 10 displays the learning history inside the learner specific information, and the learner selects homework information and informs the school server 23 of the fact (S505).

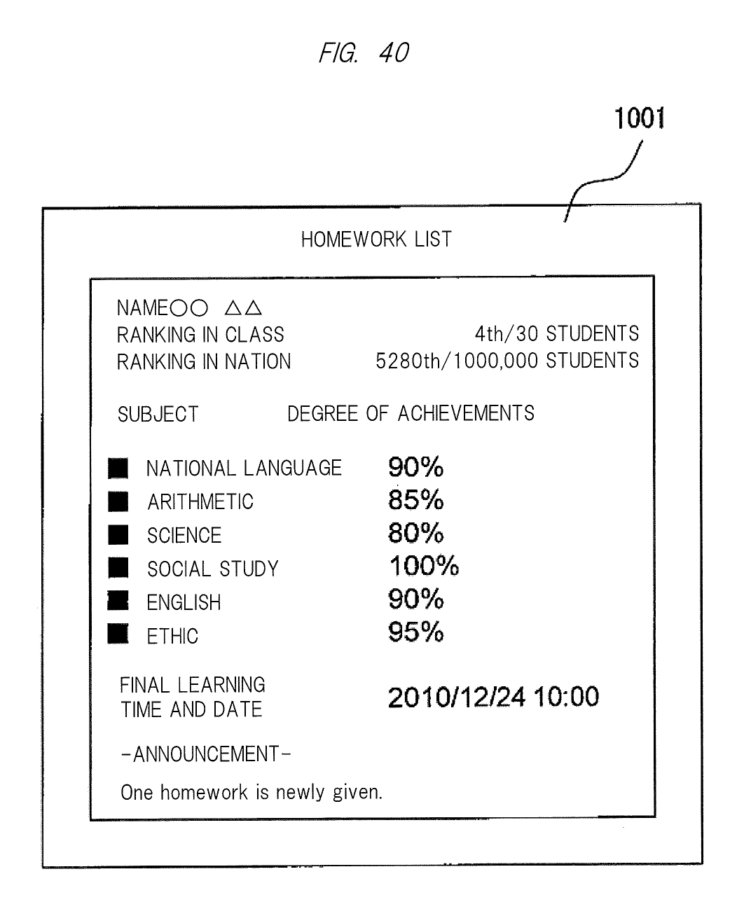

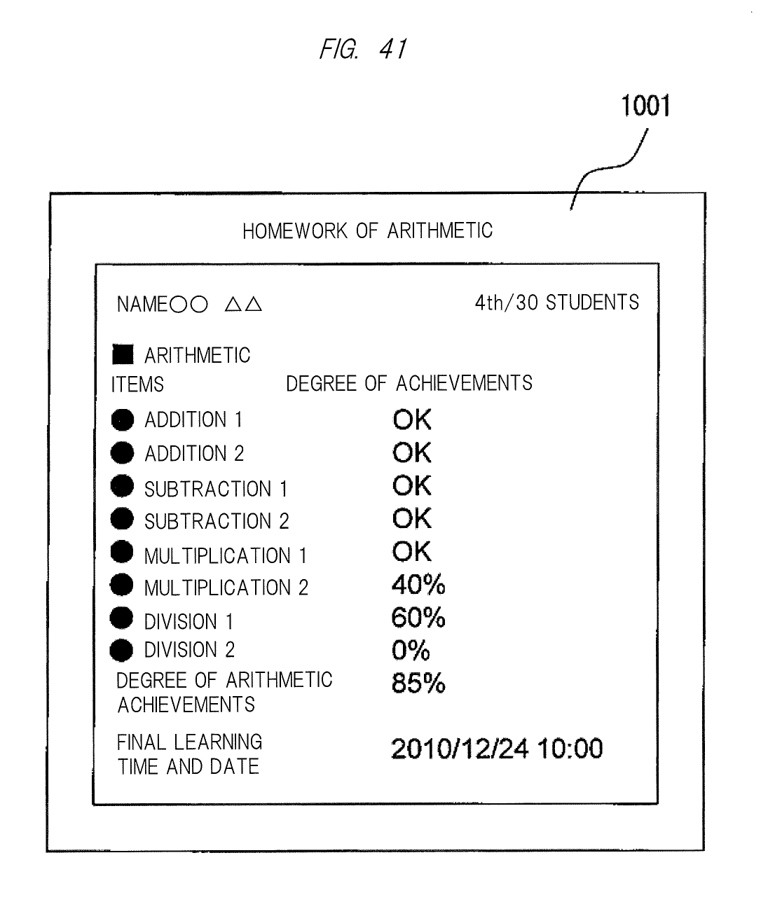

The following description will discuss the selection of the homework. FIG. 40 is a diagram showing a display example of a homework list. This homework list is displayed by the display unit 1001 of the learner's terminal 10, and the learner is allowed to view pieces of information, such as the name, the ranking in the class, the ranking in the nation, the degree of achievements for the respective subjects, the time and date of the last learning, and notice or the like, by using different information for each of the learners. For example, the notice displays the updating state for each class unit and new homework delivery information, or the like. In the case when the learner selects arithmetic, a display shown in FIG. 41 is given to the display unit 1001 of the learner's terminal 10 so that items of arithmetic homework and the degree of achievements are displayed. When the learner selects an unachieved item, the corresponding homework is downloaded to the storage unit 1004 of the learner's terminal 10 from the school server 23 so that the homework can be done.

The school server 23 transmits required information, such as note data, text book data and reference book data or the like, to the learner's terminal 10 from the corresponding learner specific information (S506).

During the learner is working, the learner's terminal 10 transmits data for use in backup to the learning server 23 each time an answer is made (S507).

Based upon the operation by the learner, the learner's terminal 10 transmits the fact that the learning process by the learner is finished and the resulting answer data to the school server 23 (S508).

The school server 23 carries out scoring processes on the answer data (S509).

The instructor's terminal 20, which can monitor the learner specific information and the class specific information, transmits evaluation and comments inputted by the instructor to the school server 23 (S510).

The school server 23 updates the learner specific information and published achievement information, and transmits the corresponding data to the learner's terminal 10 (S511).

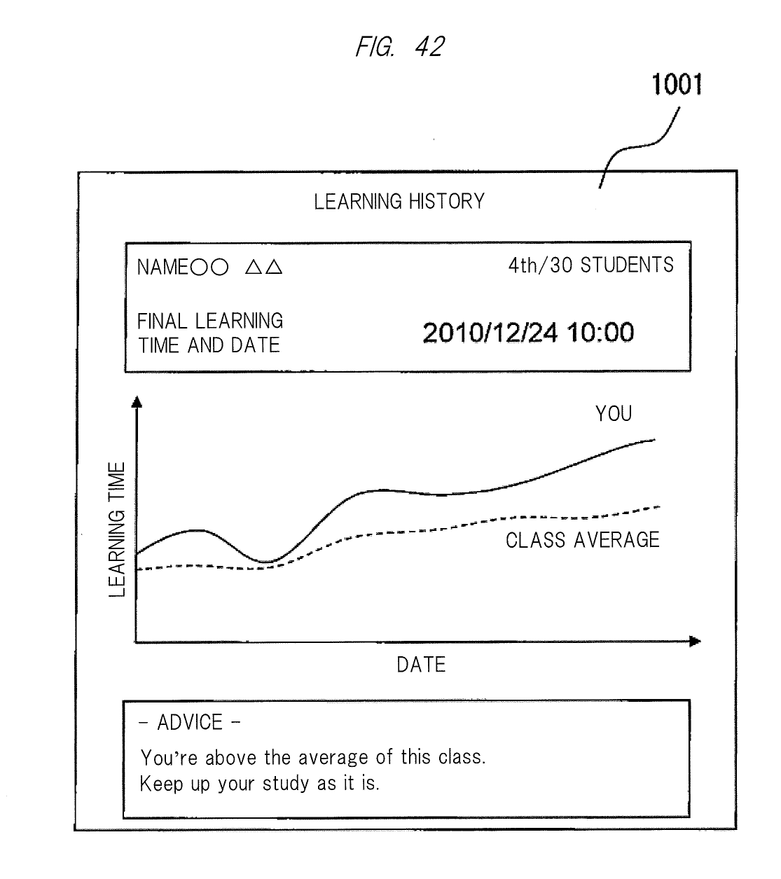

A display shown in FIG. 42 is given to the display unit 1001 of the learner's terminal 10 so that the learner confirms the class advancement state inside the class specific information and the learning history inside the learner specific information, or the like (S512).

Additionally, in the present embodiment, by exemplifying the use inside home, the learner's terminal 10 is allowed to access the school server 23 through the home network 62 and the network 2; however, the present embodiment is not limited by this arrangement. For example, as shown in FIG. 1, by allowing it to access the school server 23 through the network 2 serving as a high-speed wireless communication, such as LTE, WiMAX, or the like, it becomes possible to carry out the learning process regardless of the network 62 in home. Moreover, in the present embodiment, the school server 23 executes the scoring processes; however, the present embodiment is not limited by this arrangement. For example, the scoring processes may be carried out by the learner's terminal 10 or the instructor's terminal 20, or another method may be used in which the parent, the instructor, or the like directly carries out the scoring processes.

Moreover, in the example of the homework, the ranking or the like is calculated among the school servers 23 of the respective schools; however, in the case of a text book purchased by an individual person, a text and the like made by an individual cram school, or the like, the management thereof may carried out by the corresponding publisher server or cram-school server.

In the present embodiment, even at a site other than the school, the learner may access the school server 23 and can learn, and since comparisons with the degree of achievements in the class and with the average in the nation can be made, it is possible to enhance the motivation to learn. Moreover, since the school server 23 executes scoring processes, it becomes possible to reduce the school work load of the instructor. Furthermore, since the instructor is allowed to confirm the advancement state in the class, the comparisons with the average in the nation, or the like, on the network 2 or the network 22 in school, it becomes possible to give effective instructions to the learners.

### Embodiment 7

Next, the following description will explain an embodiment 7 in accordance with the present invention. Additionally, in the present embodiment, the same configurations, functions, elements and the like as those of the aforementioned embodiments are used within a required range.

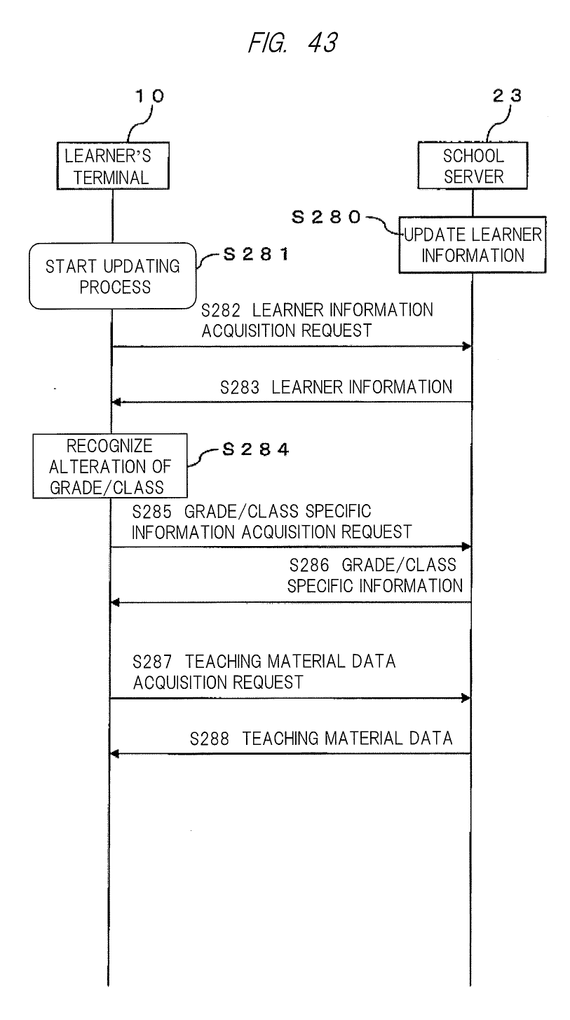

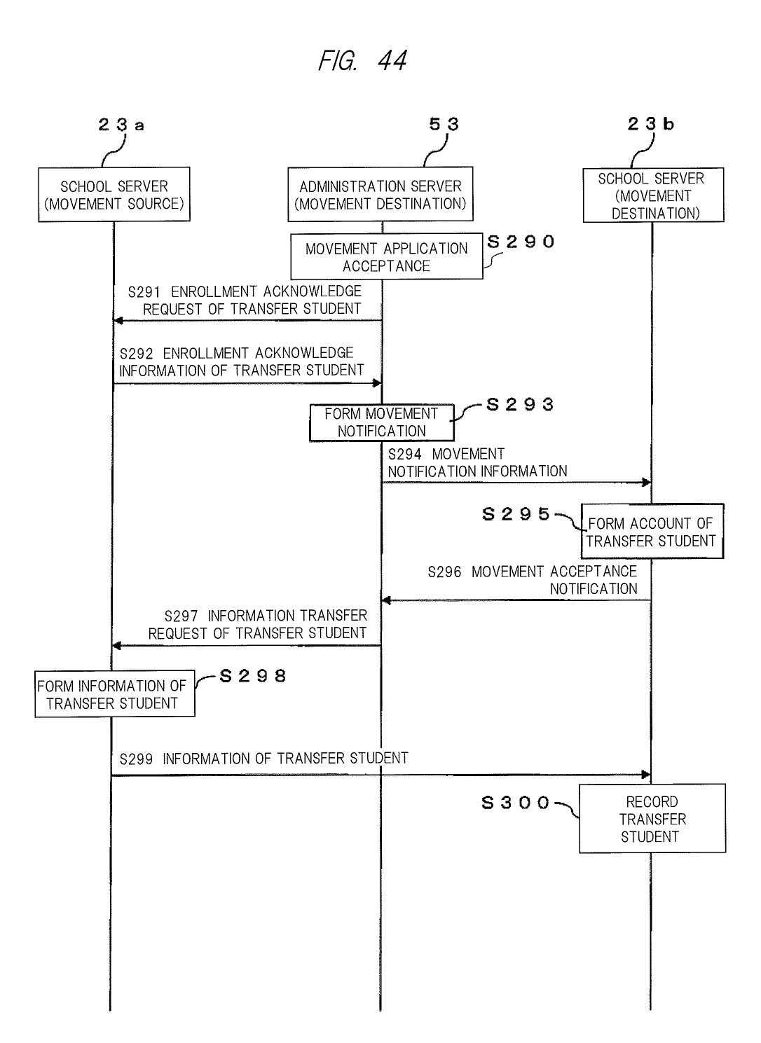

FIGS. 43 and 44 are diagrams that show one example of a learner information updating process.

During the period when the fiscal year changes, the instructor updates information relating to the learners in accordance with the class advance state of the learners on the school server 23 (S280). For example, the instructor rewrites the information of the grade and the information of the class to which each of the learners belongs.

In this state, when the learner's terminal 10 receives an update starting process for the learner's terminal 10 (S281), the learner's terminal 10 transmits a learner information acquiring request to the school server 23 (S282). Here, the update starting process refers to a process for starting downloads of setting information for a new grade and a new class, text book data, or the like, and more specifically, this process corresponds to a process for pushing down “an update starting button”. Upon receipt of the learner information acquiring request, the school server 23 transmits the learner information to the learner's terminal 10 (S283). Additionally, it is supposed that when no changes are made in the grade and the class to which the learner belongs, no learner information acquiring request is transmitted.

In the case when, upon receipt of the learner information, the learner's terminal 10 recognizes that the information of the grade and the information of the class to which the learner belongs have been updated (S284), it requests to acquire the specific information of the grade to which the learner belongs and the specific information of the class to which he or she belongs (S285). When the school server 23 receives the request for the pieces of specific information of the grade and class, it transmits the pieces of specific information of the grade and class to the learner's terminal 10 (S286). The specific information of the grade and class includes, for example, information of member names of the new class, time-table information of the new class, information relating to peripheral devices placed in the new class (device ID, device name, address information, and the like), a list of text books and other teaching materials to be used in the new class, and the like. Moreover, the specific information of the grade and the class may include font data for each of the grades (there are Chinese characters to be learned in each grade and the font data are formed by taking these into consideration). Upon receipt of these, the learner's terminal 10 can reflect the data to the font data inside the learner's terminal 10. With this arrangement, the convenience for the user can be improved.

Successively, based upon the specific information of the grade and the class thus received, the learner's terminal 10 transmits a request for acquiring teaching material data (S287). Upon receipt of the request for acquiring teaching material data, the school server 23 transmits the teaching material data to the learner's terminal 10 (S288). Additionally, the learning server 23 may be designed to execute steps of S283, S286 and S288 simultaneously.

In the case when the learner moves to another school, the parent of the learner places a movement application procedure in the corresponding local government office of the movement place, and the fact of filing the movement application procedure is recorded in the administration server 53 (S290). This record includes information indicating the ID, the grade information and the school in the original place of the learner who moves to another school. When the fact of filing the movement application procedure has been recorded, the administration server 53 transmits the enrollment acknowledge request of the transfer student to the school server 23a of the school of the original place (S291). Prior to this, if necessary, an authentication process is carried out between the school server 23a and the administration server 53. As to where the school is the original place of the transfer student is, the information included in the movement application procedure may be utilized, or the local administration server 53 may store and manage a data base in which each learner and the school to which the learner belongs are made associated with each other, and may find out the school to which the learner currently belongs based upon the learner ID of the transfer student. Upon receipt of the enrollment acknowledge request of the transfer student, the school server 23a transmits the enrollment acknowledge information of the transfer student to the administration server 53 (S292).

When the current enrollment state of the transfer student is confirmed based upon the enrollment acknowledge information of the transfer student thus received, the administration server 53 forms movement notice information (S293). The movement notice information includes the learner basic information, such as the name, gender, date of birth, address, names of the parents and emergency contact address, or the like of the transfer student. The administration server 53 has a list of schools that are under the management. The list of schools includes the names of schools, the names of the representatives, the contact telephone number, the contact address and the total number of learners, or the like. The administration server 53 selects an optimal transfer school for the transfer student from the list of schools, and transmits the movement notice information thus formed to the school server 23b of the corresponding school (S294). Prior to this, if necessary, an authentication process is carried out between the school server 23b and the administration server 53. Upon receipt of the movement notice information, the school server 23b forms a transfer student account (S295). The transfer student account is made associated with the learner basic information. After forming the transfer student account, the school server 23b transmits a transfer acceptance notice to the administration server 53 (S296).

Upon receipt of the transfer acceptance notice, the administration server 53 transmits a transfer student information transferring request to the school server 23a (S297). The transfer student information transferring request includes address information of the school server 23b to which the transfer student information is transferred and the authentication information thereof. Upon receipt of the transfer student information transferring request, the school server 23a forms transfer student information (S298). The transfer student information includes the achievement information, health information, and learning history or the like of the transfer student. After forming the transfer student information, the school server 23a transmits the transfer student information to the school server 23b (S299). Upon receipt of the transfer student information, the school server 23b records the data (S300).

With the above-mentioned arrangement, even when moving to another school, it is only necessary for the parent of the transfer student to place the corresponding procedure in the local government office (administration server), and it is not necessary to go to the school of the original place or to the school in the transfer place to carry out the procedure so that the convenience for the user can be improved.

### Embodiment 8

Next, the following description will explain an embodiment 8 in accordance with the present invention. In the present embodiment, the explanation is given to an example in which learning states of learners are collected for each class or each grade and reported to instructors in the school. Additionally, in the present embodiment, the same configurations, functions, elements and the like as those of the aforementioned embodiments are used within a required range.

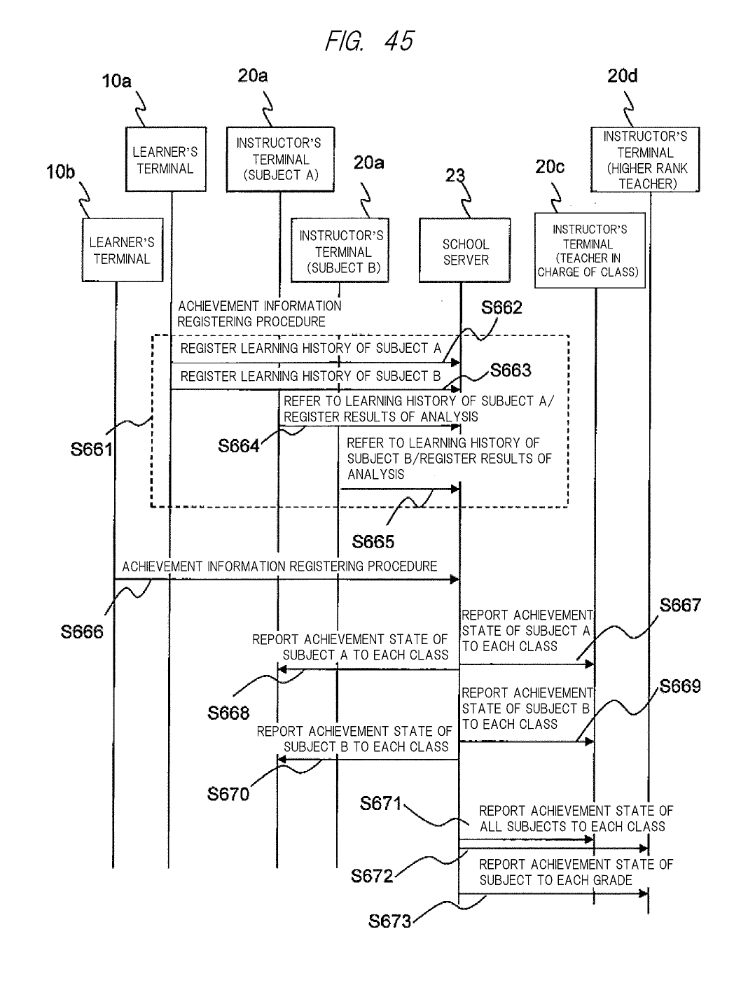

FIG. 45 is a diagram that shows one example of a learning state registering process in which, in a block diagram shown in FIG. 1, an instructor of each subject analyzes a learning state and registers the result of the analysis, and then reports the achievement state for each class or each grade.

The achievement information registering procedure for each of the learners is carried out in the following manner by using the learner's terminal 10 possessed by each learner. A certain learner registers a learning history for each subject to the school server 23 by using the learner's terminal 10a (S662 and S663). The instructor in charge of subject A refers to the learning history of the learner, and registers the results of analysis for the learning state of each learner, that is, the proceeding state and the degree of understanding or the like, of the learning, to the school server 23 (S664). In the same manner, the instructor in charge of subject B registers the results of analysis for the learning state of each learner with respect to subject B to the school server 23 (S665). By executing the above-mentioned sequence of procedures of S662 to S665 in every-day lessons, the registering process of the achievement information of the learner is carried out (S661). Moreover, with respect to another learner, the registering process of the achievement information is carried out in the same manner (S666).

Based upon the achievement information accumulated as described above, the school server 23 carries out the report of the achievement information regularly, for example, every term end, every month, or the like, or at a predetermined point of time. The report of the achievement information is carried out for each subject, and for example, in the case of subject A, the results of collections carried out for each class are reported to the instructor in charge of the class, as well as to the instructor in charge of subject A (S667 and S668). Moreover, in the case of subject B, the results of collections are reported to the instructor in charge of subject B as well as to the instructor in charge of the class (S669 and S670).

With respect to the results of collected achievements for the entire subjects for each class, the report is given to the instructor in charge of class, and also to an instructor in the higher class, such as the chief of the grade or the head teacher (S671 and S672). With respect to the results of collected achievements for the entire grade, the report is given to an instructor in the higher class (S673).

Thus, with respect to the learning states for each class or each grade, since the report is given to the instructor in charge of class or an instructor in the higher class, without giving so much troubles to the instructor in charge of the subject, it is possible to improve the efficiency of the task for managing the achievement information.

### Embodiment 9

Next, the following description will explain an embodiment 9 in accordance with the present invention. In the present embodiment, the explanation is given to an example in which, when a learner utilizes any facility inside the school, the school server 23 manages the history of the use. Additionally, in the present embodiment, the same configurations, functions, elements and the like as those of the aforementioned embodiments are used within a required range.

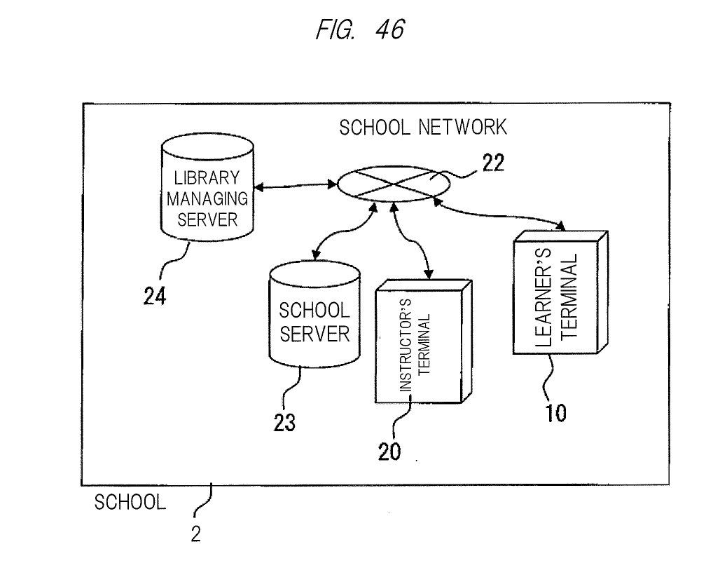

FIG. 46 is a diagram that shows one example of a school system. To the network 22 in school of the present embodiment, a library managing server 24 is connected. The library managing server 24 records or manages pieces of information about books stored in the library inside the school, that is, the names of books and the publisher's names of books, the date of issue, classification of books, information about the contents thereof, or the like, so as to allow learners or the like to retrieve the books by utilizing the information. Moreover, the management of the lend record is executed on the books that have been stocked, and upon lending books, information managements on information such as the name of the lent book, the borrower, the date of lend and the lending period, or the like are carried out.

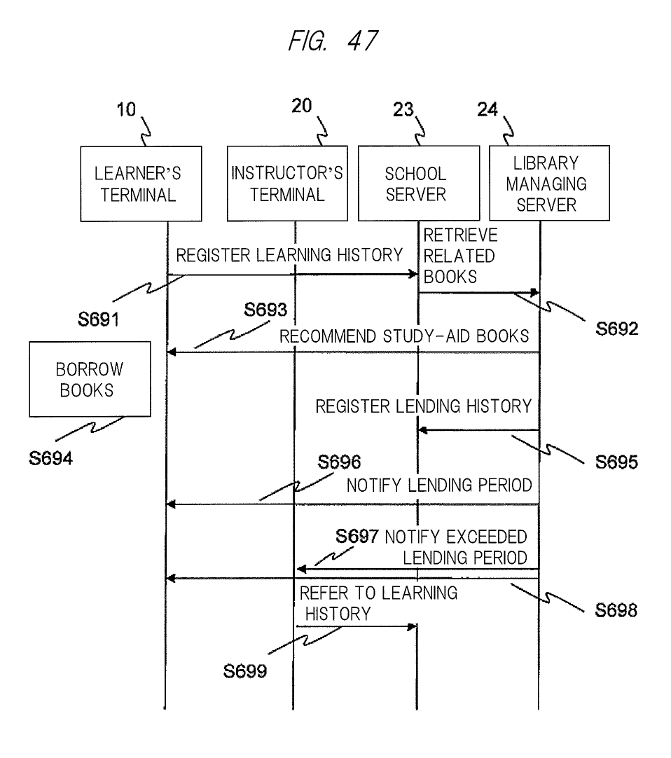

FIG. 47 is a diagram that shows one example of a library lending history registering process in which the school server 23 registers the lending history of a book and which is referred to by the instructor together with the learning history.

Based upon an operation of the learner, the learner's terminal 10 registers the learning history to the school server 23 for each of subjects (S691). Based upon the learning history thus registered, the school server 23 allows the library managing server 24 to retrieve books relating to the contents of the leaning in accordance with the contents of a subject under the learning and key words or the like contained therein (S692). By transmitting the information relating to books picked up as a result of the retrieval to the learner's terminal 10, the library managing server 24 informs the learner of recommended reference books (S693). In the case when the learner who received the recommendation borrows those books (S694), based upon an operation or the like of a librarian, the library managing server 24 stores information relating to the book lend, such as the title, the time and date of the lend, the lending period, and the name and the learner ID of the learner, or the like, of a book that is borrowed, as a book lending history, and registers the information in the school server 23 (S695).

When the lending period comes closer, the library managing server 24 transmits the corresponding fact to the learner's terminal 10, and informs the learner, that is, the borrower, of the fact that the lending period has come closer (S696). In the case when the lending period has been exceeded, the library managing server 24 transmits the fact that the lending period has been exceeded to the learner's terminal 10 and the instructor's terminal 20, and informs the learner, that is, the borrower, and the instructor who takes supervising responsibility of the corresponding fact (S697 and S698).

The instructor's terminal 20 accesses to the school server 23, and by displaying the book lending history that has been registered, the instructor refers to the book lending history together with the learning history so that he or she confirms the engaging state of the learner for the learning (S699).

In the present embodiment, since the instructor can refer to the reading history of the learner together with the learning history thereof, he or she can confirm the engaging state of the learner for the learning in more detail. Moreover, the learner is allowed to receive recommendation of books that are determined based upon the learning history of him or her by the library managing server 24 so that it becomes possible to easily specify books suitable for the learner.

### Embodiment 10

Next, the following description will explain an embodiment 10 in accordance with the present invention. In the present embodiment, the explanation is given to an example in which, when a learner in a school also goes to a cram school or a preparatory school (hereinafter, referred to simply as “cram school”) or has a home teacher, the instructor of the cram school, the home teacher or the instructor outside the school (hereinafter, sometimes, referred to as “instructor outside the school”) is allowed to share achievement information of the learner commonly with the school. Additionally, in the present embodiment, the same configurations, functions, elements and the like as those of the aforementioned embodiments are used within a required range.

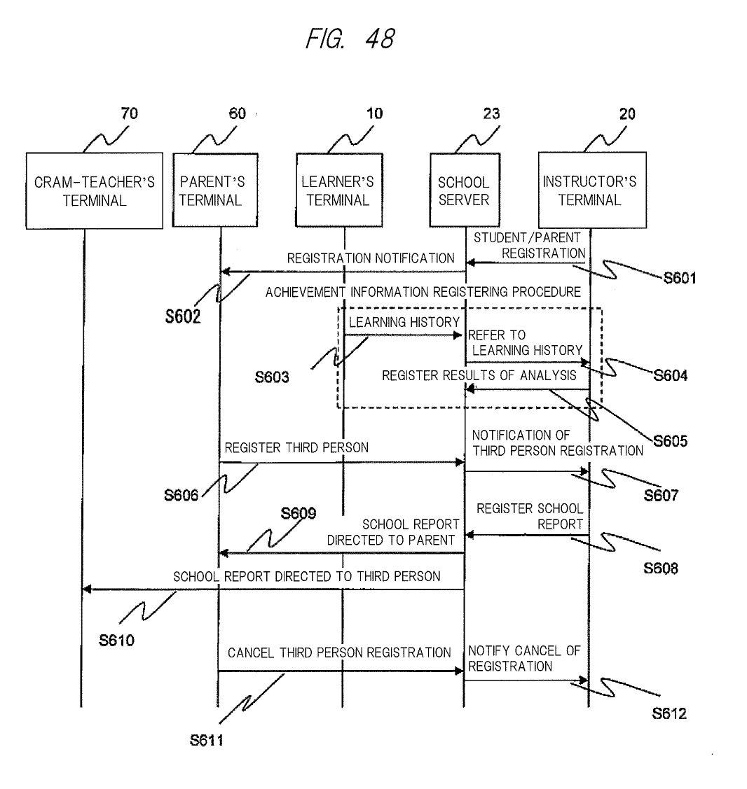

FIG. 48 is a diagram that shows one example of an achievement information acquiring process by which an instructor of a certain cram school, that is, an instructor out of the school, can acquire achievement information of a learner.

First, at the time when learners enter a school, or at the time of the start of each fiscal year or each term, based upon an operation of an instructor of the school, such as a teacher or the like thereof, the school server 23 forms a storage region for achievement information for each of the learners (S601). After the formation of the region, the school server 23 informs the parent's terminal 60 of the fact that the registering process has been completed, and the parent of the learner is allowed to know the fact (S602). Moreover, the school server 23 is set so that the parent can register a third person other than the parent as a delivery destination for information of the learner.

The learner's terminal 10 transmits a daily learning history to the school server 23 (S603), and the learning history is accumulated by the school server 23. By allowing the instructor's terminal 20 to read out the learning history recorded by the school server 23, the instructor of the school refers to the learning history of each of the learners (S604), and knows the learning advancement state and understanding state of the learner, and by analyzing the respective states, the learning state of the learner, for example, an item that he or she is good at or he or she is not good at for each of the subjects, and degrees thereof are analyzed so that the results of the analyses are transmitted to the school server 23 (S605). The results of these analyses are also accumulated by the school server 23 as the achievement information of the learner. The above-mentioned achievement information registering procedures (S603 to S605) are carried out on demand during daily learning processes as achievement information registering procedures.

In the case when the parent of a learner who goes to a cram school wishes to disclose the achievement information of the learner to an instructor of the cram school, he or she accesses to the school server 23 and registers the instructor of the cram school as a delivery destination of the achievement information through the parent's terminal 60 (S606). Thus, the setting is made so as to deliver the achievement information of the learner also to the registered third person other than the parent. Moreover, the instructor of the school is informed of the fact that the third parson has been registered as described above (S607).

In the case when the instructor of the school informs the parent of the learning state of the learner, for example, when the school report card is distributed, he or she registers the school report card data of the learner in the school server 23 through the instructor's terminal 20 (S608). The school server 23 transmits the school report card data thus registered to the parent's terminal 60 (S609), and also transmits the school report card data to the instructor's terminal 70 of the cram school so that the school report card is also sent to the instructor of the cram school (S610). Additionally, the school report card data to be transmitted may have different contents between those to be distributed to the parent and those to be distributed to the person other than the parent, or these may have the same contents. In the former case, the instructor in school sets the contents of the school report card data to be directed to the respective transfer destinations.

Moreover, in the case when the learner quit the cram school, the parent informs the school server 23 through the parent's terminal 60 so that the instructor of the cram school that has been registered as the delivery destination of the achievement information should be deleted (S611). Upon receipt of this notice, the school server 23 updates the delivery destination of the achievement information so that the delivery of the achievement information of the learner to the instructor of the cram school is stopped. Moreover, the instructor in school is also informed of the fact that the registration has been deleted (S612).

In the present embodiment, since the registration of the instructor outside the school to which the information relating to the learner is disclosed is executed by the parent, it is possible to prevent the risk of disclosing the achievement information of a learner to the other person who is not concerned by the parent. Moreover, since the information to be directed to the parent and the information to be directed to the third person other than the parent are made different from each other, it becomes possible to prevent unnecessary information from being disclosed to persons other than the parent.

Additionally, instead of allowing the parent to register the instructor out of the school (that is, a person) as the subject to which information is disclosed, or in addition to this method, the parent may register an organization such as a cram school, a preparatory school, or the like, as the subject to which the achievement information is disclosed.

### Embodiment 11

Next, the following description will explain an embodiment 11 in accordance with the present invention. In the present embodiment, the explanation is given to an example in which, when a learner in a school also goes to a cram school or a preparatory school or has a home teacher, the instructor outside the school accesses to the school server 23 and refers to the achievement information of the learner. Additionally, in the present embodiment, the same configurations, functions, elements and the like as those of the aforementioned embodiments are used within a required range.

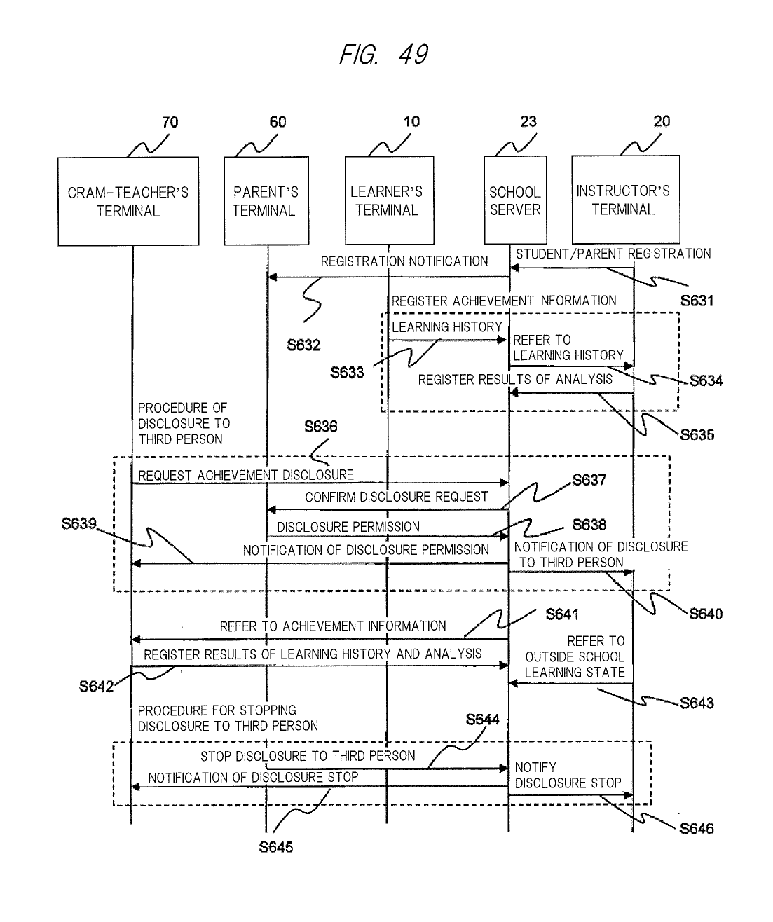

FIG. 49 is a diagram that shows one example of an achievement information referring process by which an instructor of a certain cram school, that is, an instructor outside the school, can refer to the achievement information of a learner, or register the learning state of the learner.

First, at the time when learners enter a school, or at the time of the start of each fiscal year or each term, based upon an operation of an instructor of the school, such as a teacher or the like thereof, the school server 23 forms a storage region for achievement information for each of the learners (S631). After the formation of the region, the school server 23 informs the parent's terminal 60 of the fact that the registering process of an access right has been completed (S632). Moreover, the school server 23 allows the parent's terminal 70 to change the access right inside the school server 23. Thus, the parent himself or herself can refer to the achievement information of the learner or permit to disclose the achievement information of the learner to the third person.

The learner's terminal 10 transmits a daily learning history to the school server 23 (S633), and the learning history is accumulated by the school server 23. By allowing the instructor's terminal 20 to read out the learning history recorded by the school server 23, the instructor of the school refers to the learning history of each of the learners (S634), and knows the learning advancement state and understanding state of the learner, and by analyzing the respective states, the learning state of the learner, for example, an item that he or she is good at or he or she is not good at for each of the subjects, and degrees thereof are analyzed so that the results of the analyses are transmitted to the school server 23 (S635). The results of these analyses are also accumulated by the school server 23 as the achievement information of the learner. The above-mentioned achievement information registering procedures (S633 to S635) are carried out on demand during daily learning processes as the achievement information registering procedures.

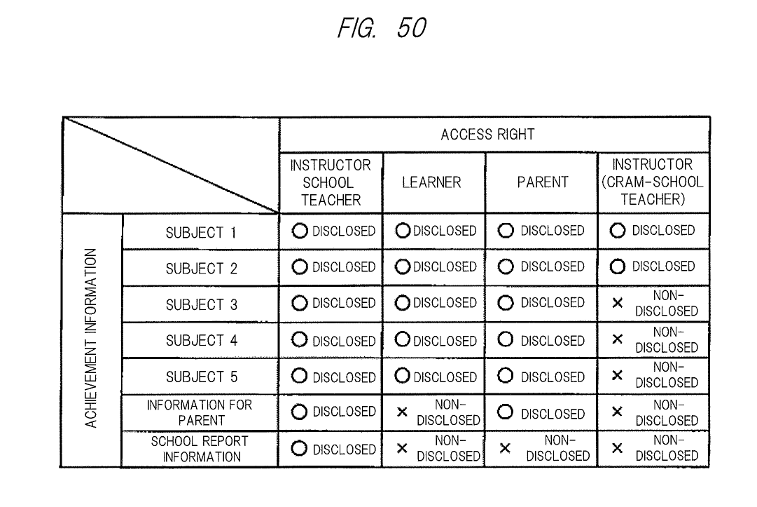

The achievement information of the learner to be accumulated by the school server 23 includes information relating to the access right, and the access right is set and applied to each of pieces of detailed information. FIG. 50 shows one example of the access right for the achievement information. This Figure shows an example in which the disclosure of achievement information relating to subject 1 and subject 2 is permitted to an instructor of a cram school. FIG. 50 shows a state in which the disclosure is permitted to the instructor of a cram school; however, at first, such a setting as not to disclose any items to the third person, such as the instructor outside the school or the like, and after a disclosure procedure to the third person as described below, the disclosure becomes available.

Based upon an operation by an instructor of a cram school, the instructor's terminal 70 transmits a disclosure request for the achievement information of a learner to the school server 23 (S636). For example, the school server 23 is configured such that, on a home page in the Internet opened by the school, by specifying the identification information of a learner, such as, for example, the name, the student number, or the like, the instructor of a cram school can request the disclosure of the achievement information. Upon receipt of the disclosure request, the school server 23 transmits a confirmation request for the disclosure request to the parent's terminal 60 (S637). The parent confirms the fact that the instructor who requested the disclosure of the achievement information belongs to the cram school to which the learner goes, and alters the access right to the achievement information so as to be disclosed to the instructor of the cram school (S638). After the permission of the parent, the school server 23 informs the instructor's terminal 70 of the fact that the disclosure to the instructor of the cram school is permitted (S639). Moreover, it also informs the instructor of the school of the fact that the disclosure to the third person has been permitted (S640). By using the above-mentioned procedures, the procedure for the disclosure to the third person, that is, the instructor of the cram school, is carried out.

Based upon an operation of the instructor of the cram school, the instructor's terminal 70 of the cram school in which the disclosure has been permitted refers to the learning history of the learner stored in the school server 23 (S641) so that the learning advancement state and understanding state are obtained, and also transmits the results of analyses of the learning history or the learning state in the cram school to the school server 23 so as to be accumulated by the school server 23 as the achievement information of the learner (S642). The reference to the achievement information and the registration of the history in steps S641 and S642 are carried out on demand during daily lessens in the cram school. Moreover, the instructor in the school can refer to the achievement information of the learner, and also refer to the learning state of the learner in the cram school (S643).

Moreover, in the case when the learner quit the cram school, in order to execute the stop procedure of the disclosure to achievement information, the parent accesses to the school server 23 and alters the access right so as to stop the disclosure permission executed in step S638 (S644). The result of the stop of the disclosure is notified to the instructor's terminal 70 of the cram school (S645). This is also notified to the instructor's terminal 20 in the school in the same manner (S646).

In the present embodiment, since the parent gives a permission to the disclosure request from the instructor of the cram school, it is possible to prevent the risk of erroneously disclosing the achievement information to a third person with a bad will. Moreover, since the instructor in the cram school is allowed not only to refer to the achievement information, but also to register the learning state in the cram school in the school server, the instructor in the school is allowed to effectively utilize the information so as to improve learning instructions in the school.

### Embodiment 12

Next, the following description will explain an embodiment 12 in accordance with the present invention. In the present embodiment, the explanation will be given to an example in which information is commonly shared between a learner's terminal 10a and a learner's terminal 10b. More specifically, the explanation will be given to an example in which by executing a dedicated commonly-use application, among a plurality of learner's terminals 10 belonging to one group, pieces of information, such as commonly-use photographs or the like, are transmitted and received so as to share the information. Additionally, in the present embodiment, the same configurations, functions, elements and the like as those of the aforementioned embodiments are used within a required range.

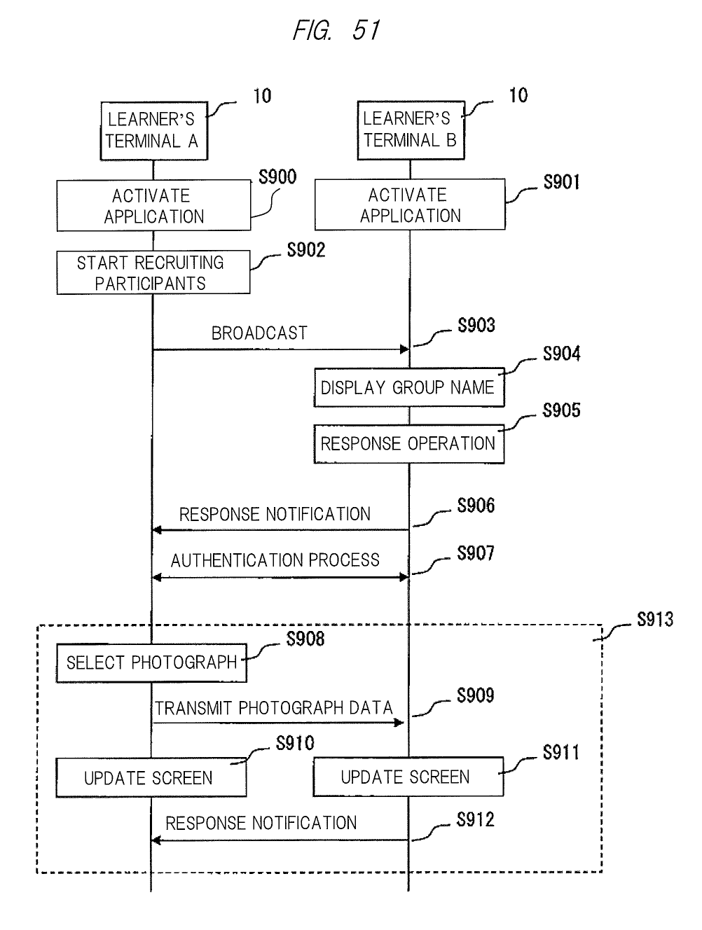

FIG. 51 is a diagram that shows one example of a photograph sharing process in which by allowing the learner's terminal 10a and the learning-use terminal 10b to communicate with each other, photographs are shared.

First, the learner's terminal 10a activates a photograph sharing application (S900). Then, the learner's terminal 10b also activates the photograph sharing application in the same manner (S901).

A button for use in starting the recruitment of participants to a group is displayed on the display unit 1001 of the learner's terminal 10. Moreover, when the button is pressed by the operation of a learner, the learner's terminal 10a starts the process for the recruitment of participants to the group for sharing photographs with one another (S902).

In this case, the process, for example, includes a process for allowing the learner to input a group name or the like for identifying a group in which photographs are shared.

Then, the communication unit 1006 of the learner's terminal 10a transmits a signal for the recruitment of participants directed to the learner's terminal 10b to an unspecified number of learner's terminals 10 by means of broadcasting (S903). In this case, not only the fact that participants are recruited, but also pieces of group information, such as the nickname of the learner's terminal 10a forming the creator of the group, the group name and an IP address of his or her own, or the like, are simultaneously transmitted.

Additionally, after the receipt of the signal for recruiting participants from the learner's terminal 10a, the learner's terminal 10b may activate the photograph sharing application. With this arrangement, the learner of the learner's terminal 10a makes it possible to omit time-consuming processes for preliminarily activating the application, and consequently to improve user-friendliness.

Upon receipt of this signal, the learner's terminal 10b displays the fact that the learner's terminal 10a is recruiting participants to a photograph sharing group (S904). More specifically, by using the nickname and the group name transmitted from the learner's terminal 10a, a message, such as “Participants are being recruited. Would you like to join? Yes/No.”, is displayed.

In response to this, in the case when the learner presses down “Yes” so that the learner's terminal 10b receives the response operation indicating the will to join the group (S905), it transmits a response notice signal for wishing the participation to the group to the learner's terminal 10a (S906) As a result of these processes, the learner's terminal 10a and the learner's terminal 10b carry out authentication processes (S907) so that the communication between the learner's terminal 10a and the learner's terminal 10b is established. In this case, the authentication processes refer to a process for identifying the connection partner for communications, and for example, the same password information is transmitted to both of the sides so that the confirmation is made, with the password being coincident with each other.

Thereafter, when a photograph to be shared is selected by a learner (S908), the learner's terminal 10a transmits the photograph data to the learner's terminal 10b (S909). At this time, in addition to the photograph data, photograph display information indicating the position on the screen on which the photograph is displayed and the size of the photograph is also transmitted. Moreover, the learner's terminal 10a carries out a decoding process on the photograph data, and the photograph having the position and the size corresponding to the photograph display information is displayed on the display unit (S910). Additionally, the learner's terminal 10a may be designed so that, after a lapse of a waiting period of time until the operation for instructing the actual transmission is carried out by the learner since the photograph that is to be shared has been selected by the learner, the photograph data can be transmitted to the learner's terminal 10b.

Moreover, in the learner's terminal 10b received the photograph data and photograph display information, the decoding process is carried out on the photograph data and the photograph is displayed on the display unit 1001 in the same manner (S911). In the case when a normal display is obtained, the learner's terminal 10a transmits a response notice signal to the learner's terminal 10a (S912).

Thereafter, the same processes as those from step S908 to S912 are repeatedly carried out (S913) so that a plurality of photographs can be shared.

Additionally, in this case, the explanation has been given to an example in which photograph data are transmitted from the learner's terminal 10a to the learner's terminal 10b; however, it is of course possible to transmit photograph data from the learner's terminal 10b to the learner's terminal 10a in the same manner.

Moreover, the photograph data to be transmitted may be preliminarily re-sized by the learner's terminal 10. With this arrangement, since the data capacity of the photograph data can be reduced, it is possible to reduce the communication processes required for the data transmitting and receiving processes and also to reduce the displaying processes of the photograph data. Thus, since the displaying speed of the photograph data becomes faster, and since the power consumption can be reduced, the battery life can be made longer. Thus, it becomes possible to improve user-friendliness.

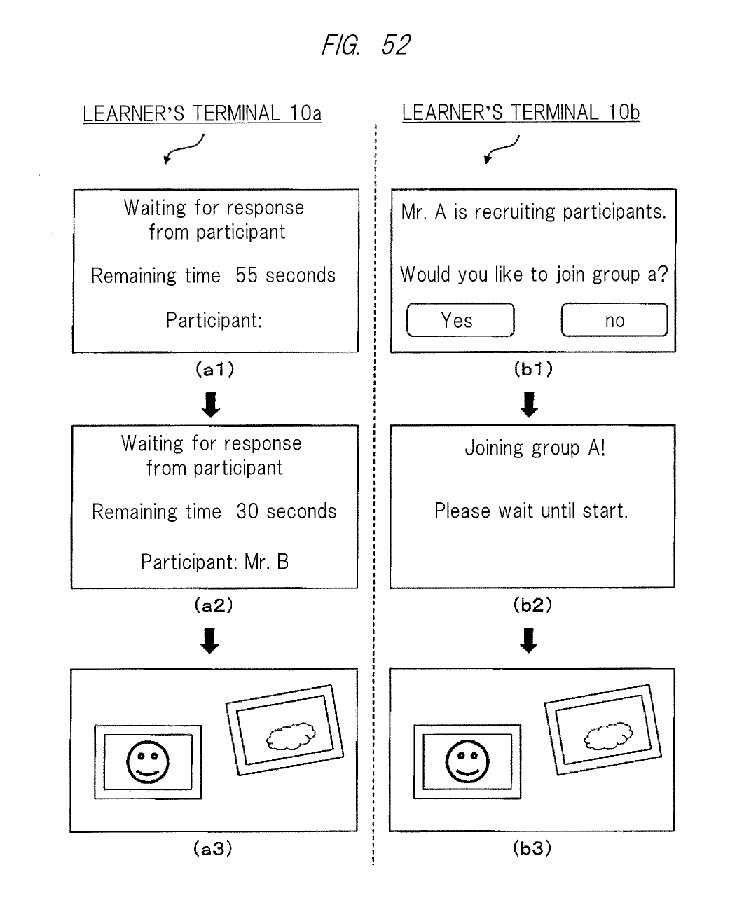

FIG. 52 shows respective display examples of the learner's terminal 10a and the learner's terminal 10b in accordance with the present embodiment.

FIG. 52(a1) shows a screen on which the learner's terminal 10a is recruiting participants, which is directed to the learner's terminal 10b. At this time, FIG. 52(b1) shows a screen displayed by the learner's terminal 10b. In this case, when the learner of the learner's terminal 10b presses down “Yes” so as to join the group, the screen is transferred to a screen shown in FIG. 52 (b2) so that a screen waiting for the start of sharing photographs is displayed. On the other hand, in the learner's terminal 10a, its display is updated to “participant: Mr. B” or the like so that the screen is transferred to a screen indicating that there is a response from the learner of the learner's terminal 10b (FIG. 52(a2)). After a lapse of a predetermined period of time to terminate the recruitment of participants, the screen is transferred to a photograph sharing screen. Then, photograph data transmitted from the learner's terminal 10a and the learner's terminal 10b are displayed on the respective terminals (FIG. 52 (a3), FIG. 52 (b3)).

In this manner, the user of the learner's terminal 10a and the user of the learner's terminal 10b are allowed to share and enjoy the same photographs.

Additionally, in the above-mentioned example, the embodiment has explained a case in which photograph data are shared; however, the embodiment is not limited only by the photograph data. In place of the photograph data or in addition to these, any data, such as text, music, motion pictures and voice data, or the like, may be used as long as those data have a format capable of being displayed by the display device 1001 of the learner's terminal 10, or capable of being outputted from a voice output unit thereof. When text data are shared, comments about photographs can be shared so that the communication becomes more enjoyable, and it becomes possible to improve user-friendliness.

Additionally, in the present embodiment, the explanation has been given to a case in which data are shared by two terminals, that is, the learner's terminal 10a and the learner's terminal 10b; however, three or more terminals may be used. In this case, the process (S909) for transmitting data to be shared may be changed to a process for transmitting data to all the terminals belonging to the group. In this manner, by sharing photographs among many terminals, various kinds of photographs can be viewed, and since the communication becomes further enjoyable, it becomes possible to improve user-friendliness.

### Embodiment 13

Next, the following description will explain an embodiment 13 in accordance with the present invention. In the present embodiment, the explanation will be given to an example in which a learner is allowed to utilize teaching materials, such as a text book, a reference book or the like, by the use of the learner's terminal 10. Additionally, in the present embodiment, the same configurations, functions, elements and the like as those of the aforementioned embodiments are used within a required range.

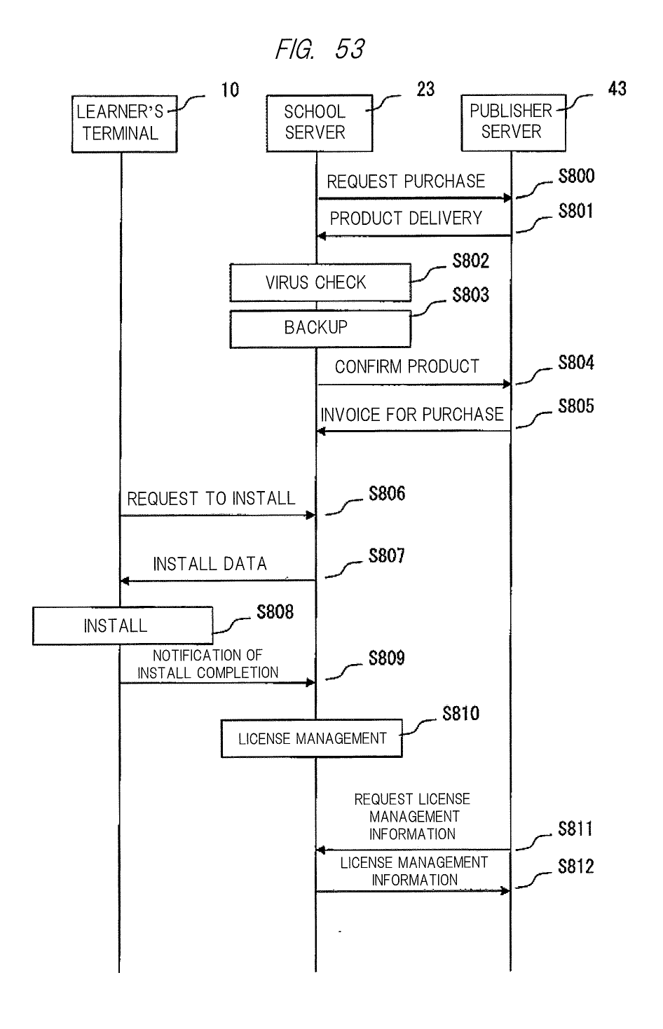

FIG. 53 is a diagram that shows one example of a text book purchasing process in which by receiving text book data or the like from the publisher server 43, the school server 23 delivers the data to the learner's terminals 10 so that the learner's terminals 10 respectively install the data.

First, the school server 23 carries out a purchase request for text book data on the publisher server 43 (S800). The purchase request includes a text book ID that unanimously identifies the text book and the number of licenses, or the like.

The publisher server 43 selects text book data corresponding to the received text book ID, and transmits the corresponding text book data and the license data to the school server 23 (S801). In this case, the license data refer to a product key or the like that is required when the learner's terminal 10 installs the text book data distributed by the school server 23.

Next, the school server 23 carries out a virus check on the received text book data (S802), and when no virus infection is confirmed, the data are stored in the storage unit. At this time, necessary items are additionally written to a text book managing table.

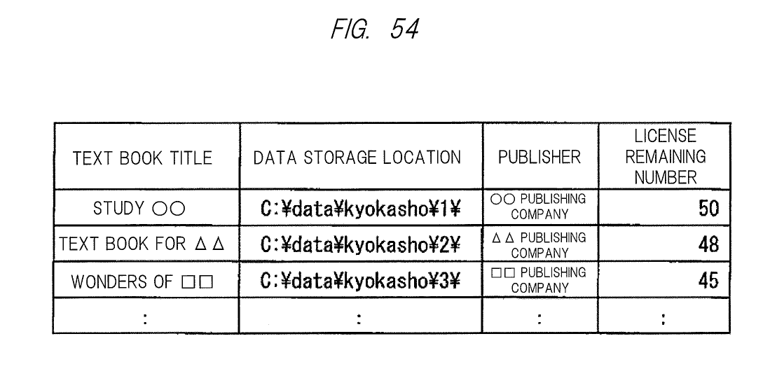

The text book managing table refers to a table for use in managing information relating to the text book data, and FIG. 54 shows one example thereof.

The text book managing table is a table that, for example, specifies text book titles, storage places for the text book data and license data, publishers forming original sites for purchases of the text book data, and the remaining number of the licenses, or the like.

Next, based upon an operation of the administrator or the like, the school server 23 forms a data backup into a medium, such as CD-ROM or the like (S803). If it is found that the data are infected with a virus, the school server 23 deletes the data at once.

Moreover, the school server 23 confirms the product distribution to the publisher server 43 (S804). In response to this, the publisher server 43 submits a price bill to the school server 23 (S805).

Next, the learner's terminal 10 carries out a distribution request for the text book data on the school server 23 (S806).

In response to this, the school server 23 carries out an authentication process on the learner's terminal 10, and in the case when the corresponding learner's terminal 10 is confirmed to be a terminal that is managed by the school, the school server 23 transmits the text book data thereto (S807). At this time, the school server 23 confirms the text book managing table so as to confirm that the license remaining number of the text book relating to the distribution request is not 0. In the case when the license remaining number is 0, the school server 23 informs the learner's terminal 10 of the fact that the number of licenses is insufficient, without transmitting the text book data.

Moreover, the learner's terminal 10 that has received the text book data carries out an installing process of the text book data (S808). Upon completion of the installing process normally, the learner's terminal 10 transmits an install completion notice to the school server 23 (S809). Upon receipt of the install completion notice, the school server 23 carries out a license managing process (S810). More specifically, the school server 23 accesses to the text book managing table, and reduces the license remaining number of the text book relating to the install completion notice by one.

Next, the publisher server 43 accesses to the school server 23, and the publisher server 43 transmits a license managing information request to the school server 23 so as to confirm the license condition (S811). Upon receipt of the request, the school server 23 transmits the license remaining number on the text book managing table to the publisher server 43 (S812). In this manner, the publisher always makes it possible to confirm to the school as to whether or not the license of the text data is used unfairly.

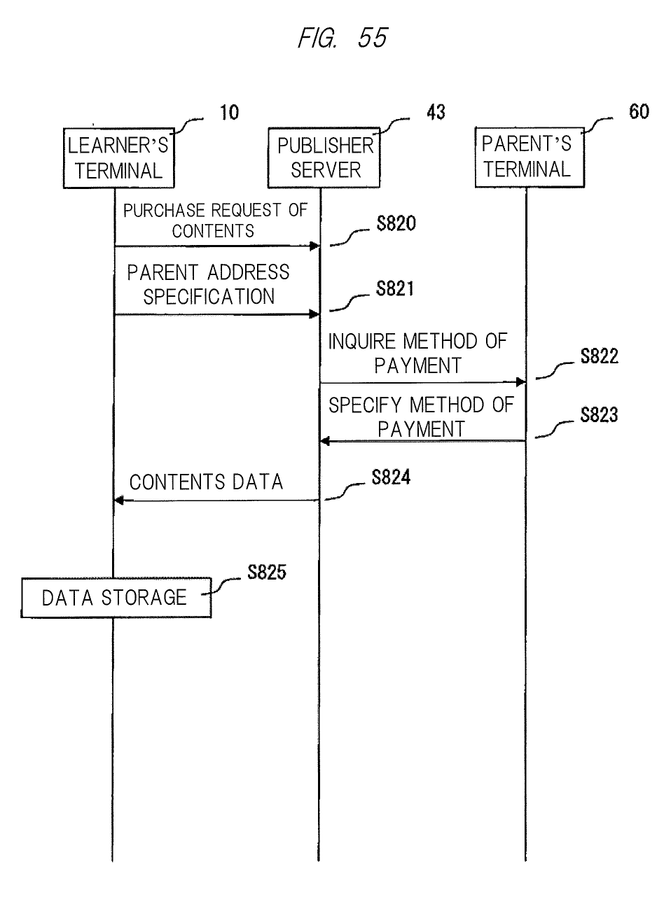

Next, referring to FIG. 55, the following description will discuss a reference book purchasing process in which a learner receives teaching materials that are not necessarily required in classes in school, such as a reference book or the like, from the publisher server 43.

First, based upon an operation by a learner, the learner's terminal 10 accesses to the publisher server 43, selects reference book data that the learner wishes to purchase, and then transmits a purchase request for the corresponding reference book data to the publisher server 43 (S820).

In order to settle a purchase price, an input of the number of a credit card, or the like, is required, and in the case when the learner is, for example, an elementary school student, it is quite possible that the learner does not have a credit card. Therefore, by allowing the parent of the learner to execute the settlement process, it becomes possible to settle the purchase price.

For this reason, the learner's terminal 10 specifies the parent address to the publisher server 43 (S821). In this case, the parent address refers to an address for use in contacting the parent of a learner, and corresponds to, for example, a mail address of a portable telephone used by the parent.

Thereafter, the publisher server 43 inquires the parent address thus received about the method of payment (S822). Upon receipt of the inquiry, the parent's terminal 60 specifies the method of payment based upon an operation by the parent, such as, for example, an input of a credit card number or the like (S823). Then, the publisher server 43 confirms that the credit number is valid, settles the payment, and transmits the reference book data to the learner's terminal 10 (S824). Thereafter, the learner's terminal 10 stores the reference book data in the storage unit 1004 (S825).

Additionally, the license of the reference book data may be managed by the publisher server 43. In this case, the publisher server 43 prepares an ID that can unanimously identify the learner's terminal 10 and a license managing table in which purchased reference data and the ID are described in association with each other.

For example, in the case when, there is any problem in the learner's terminal 10 with the result that all the data are vanished, and the same reference book data are again acquired, the publishing server 43 refers to the license managing table, and the reference book data that have been once purchased in the past are supplied for free. In this manner, since the reference book data once purchased needs not be purchased again, it becomes possible to improve user friendliness.

Moreover, in the license managing table provided in the publisher server 43, together with the reference book data purchased by the learner, a plurality of ID's may be registered as learner's terminals 10 capable of storing the reference book data therein. With this arrangement, even in the case when the learner's terminal 10 is lost, upon trying to again store the reference book data in another learner's terminal 10, since the same reference book data can be obtained for free, it is possible to improve user friendliness.

### Embodiment 14

Next, the following description will explain an embodiment 14 in accordance with the present invention. In the present embodiment, an explanation will be given to an example for carrying out an access limitation. To carry out the access limitation means that the user is prevented from accessing to subject information without having permission.

For example, since a text book includes pages where answers for the questions are written (hereinafter, referred to as “answer pages”), the instructor sometimes wishes to put a limitation so as not to allow the learner to view the answer pages before the learner finishes homework. The present embodiment relates to an example in which, for example, if the learner has a predetermined access key, the answer pages are displayed, while, if the learner does not have the access key, those pages are not displayed. Additionally, in the present embodiment, the same configurations, functions, elements and the like as those of the aforementioned embodiments are used within a required range.

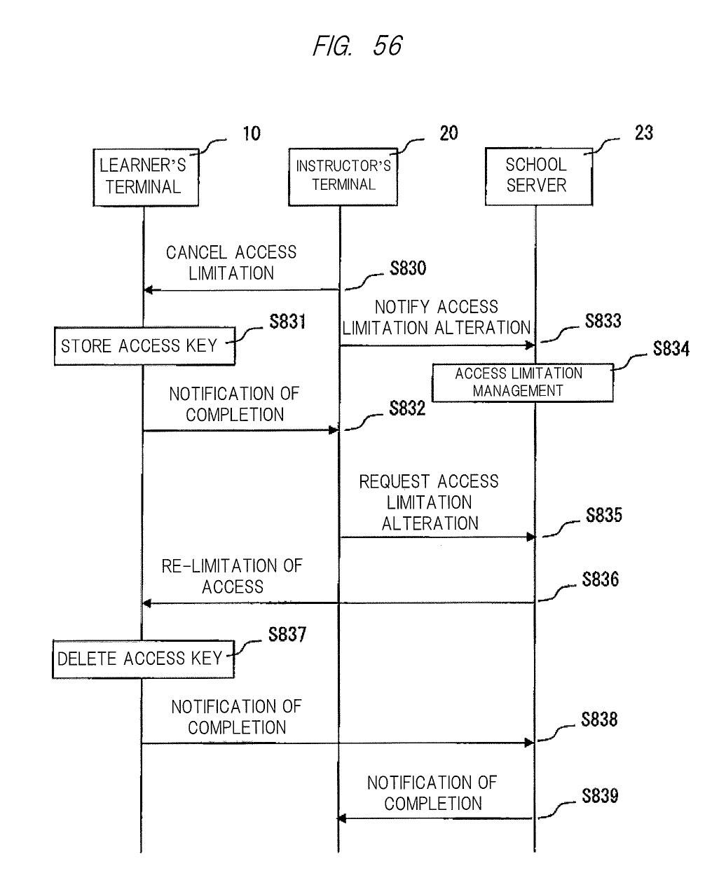

Referring to FIG. 56, the following description will explain one example of the access limitation process of the present embodiment.

First, the instructor's terminal 20 transmits an access limitation releasing request to the learner use terminal 10 (S830). At this time, the access key in association with the text book data is transmitted. Additionally, the access key is generated by the school server 23. Upon receipt of the access key, the learner's terminal 10 stores the access key in the storage unit 1004 (S831). Then, the learner's terminal 10 informs the instructor's terminal 20 of the fact that the storage of the access key has been completed (S832). By inputting the access key, the learner allows the learner's terminal 10 to display portions of a text book that have not been so far viewed.

Moreover, the instructor's terminal 20 informs the access limitation managing table stored in the school server 23 of the fact that the access limitation has been canceled (S833).

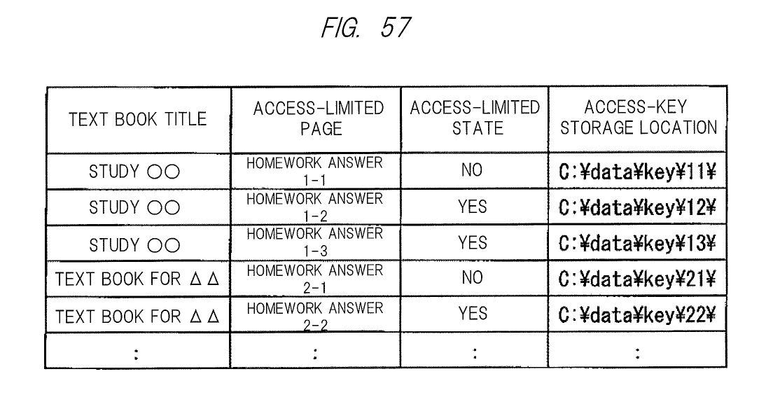

Here, FIG. 57 shows one example of the access limitation managing table. The access limitation managing table refers to a table for managing the state of the access limitation to text book data, and has text book titles, subject pages to be access-limited, the state of the access limitation, and the storage place of the access key or the like, written therein.

Upon receipt of the releasing notice of the access limitation, the school server 23 alters the access limitation managing table from “Yes” to “No” in the access limitation state of the access-limited pages of the corresponding text book (S834).

In this manner, since the instructor's terminal 20 executes the access limitation, the learner can carryout learning processes correctly. Therefore, it is possible to improve user friendliness for the instructor.

Additionally, in the case when the instructor wishes to again put the access limitation, the instructor operates the instructor's terminal 20 so that the instructor's terminal 20 transmits an access-key limitation altering request to the school server 23 (S835). The access-key limitation altering request refers to a request in which by making the currently effective access key invalid, an access key that is newly made valid should be generated. Upon receipt of the access-key limitation altering request, the school server 23 makes the currently effective access key invalid, and generates an access key that is newly made valid so that the notice indicating the fact that the access limitation is again executed is transmitted to the learner's terminal 10 (S836). When the learner's terminal 10 is informed of the fact that the access limitation is again executed, it deletes the access key in accordance with the operation of the learner (S837), and the fact that the deletion has been completed is transmitted to the school server 23 (S838). Moreover, the school server informs the instructor's terminal 20 of the fact that the learner has already deleted the access key that was made invalid (S839).

### Embodiment 15

Next, the following description will explain an embodiment 15 in accordance with the present invention. In the present embodiment, an explanation will be given to a process in which, with respect to questions that are present during a lesson or questions that are present as homework or a test or the like, memos, charts and answers or the like, inputted by the learner by using the learner's terminal 10 are displayed by the instructor's terminal 20 in time series.

More specifically, the present embodiment is applicable when in embodiment 4, the learner's terminal 10 transmits answer data to which answer inputs have been finished to the school server 23 during a test (S417) or when after the completion of the test, it transmits the answer data to the school server 23 (S423). Moreover, the present embodiment is also applicable, when in embodiment 6, the learner's terminal 10 transmits answers of homework to which answer inputs have been finished to the school server 23 during a learning process of the homework (S507).

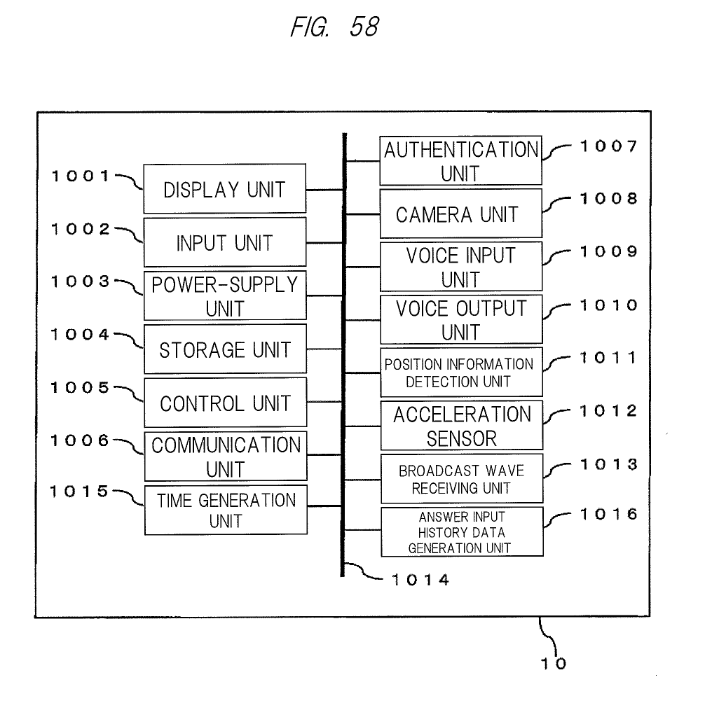

FIG. 58 is a diagram that shows one example of a functional configuration of the learner's terminal 10 in the present embodiment.

Reference numeral 1015 represents a time generation unit that corresponds to a processing unit for generating a clock time that is utilized to confirm the timing at which an answer is inputted by the user. The clock time generated by the time generation unit 1015 may be the absolute current time that cannot be changed by the user, or a relative time calculated from a counter value generated by a CPC or the like of the control unit 1005.

Moreover, since the input unit 1002 of the learner's terminal 10 in the present embodiment is designed on the assumption that a handwriting input is available, it may be prepared as an input device to which a handwriting input is available, such as a touch panel, an electronic pen, or the like, or may be provided with a pointing device such as a mouse, a track ball, or the like.

Reference numeral 1016 represents an answer input history data generation unit, which corresponds to a processing unit in which based upon input data inputted from the input unit 1002 and time information generated by the time generation unit 1015, answer input history data are generated.

FIG. 58 differs from FIG. 2 in that the time generation unit 1015 and the answer input history data generation unit 1016 are added thereto, and based upon input data inputted from the input unit 1002 and time information generated by the time generation unit 1015, the answer input history data generation unit 1016 generates answer input history data, and the answer input history data are transmitted to the school server 23 through the communication unit 1006.

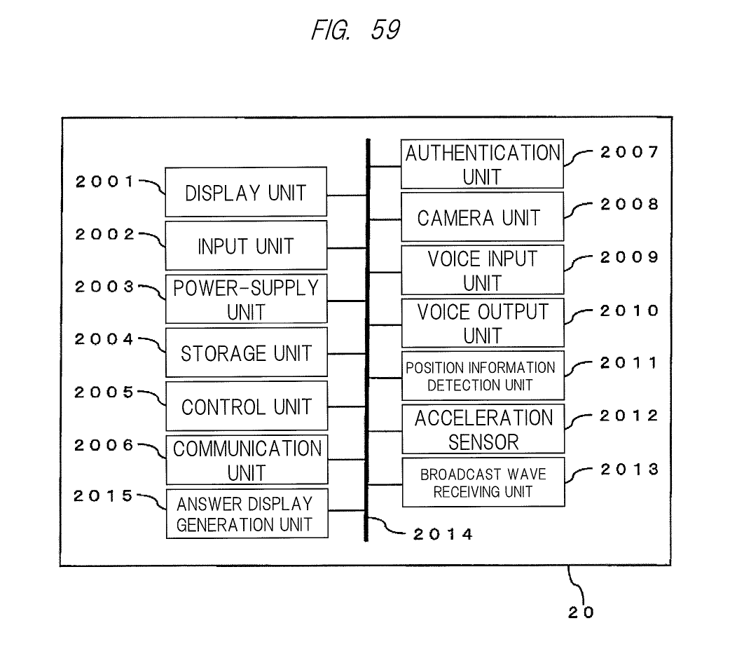

FIG. 59 is a diagram that shows one example of a functional configuration of the instructor's terminal 20 in the present embodiment.

Reference numeral 2015 represents an answer display generation unit, which corresponds to a processing unit for generating display data for use in displaying the answer input history data inputted by the learner's terminal 10 in time series.

FIG. 59 differs from FIG. 3 in that the answer display generation unit 2015 is added thereto, and the answer input history data inputted by the respective learners and obtained from the school server 23 through the communication unit 2006 are processed in the answer display generation unit 2016 so that display data thus generated here are displayed on the display unit 2001.

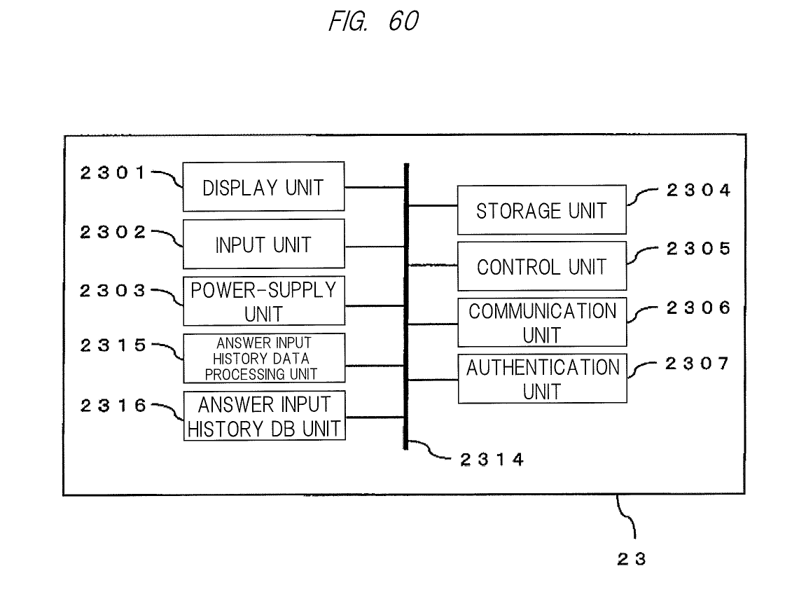

FIG. 60 is a diagram that shows one example of a functional configuration of the school server 23 in the present embodiment.

Reference numeral 2315 represents an answer input history data processing unit, which executes processes in which the answer input history data transmitted from the learner's terminal 10 are stored in an answer input history DB unit 2316, and based upon a request from the instructor's terminal 20, the answer history data are acquired from the answer input history DB unit 2316 and transmitted to the instructor's terminal 20.

Reference numeral 2316 represents the answer input history DB unit for use in storing the answer input history data transmitted from the learner's terminal 10.

FIG. 60 differs from FIG. 6 in that an answer input history data processing unit 2315 and an answer input history DB unit 2316 are added thereto.

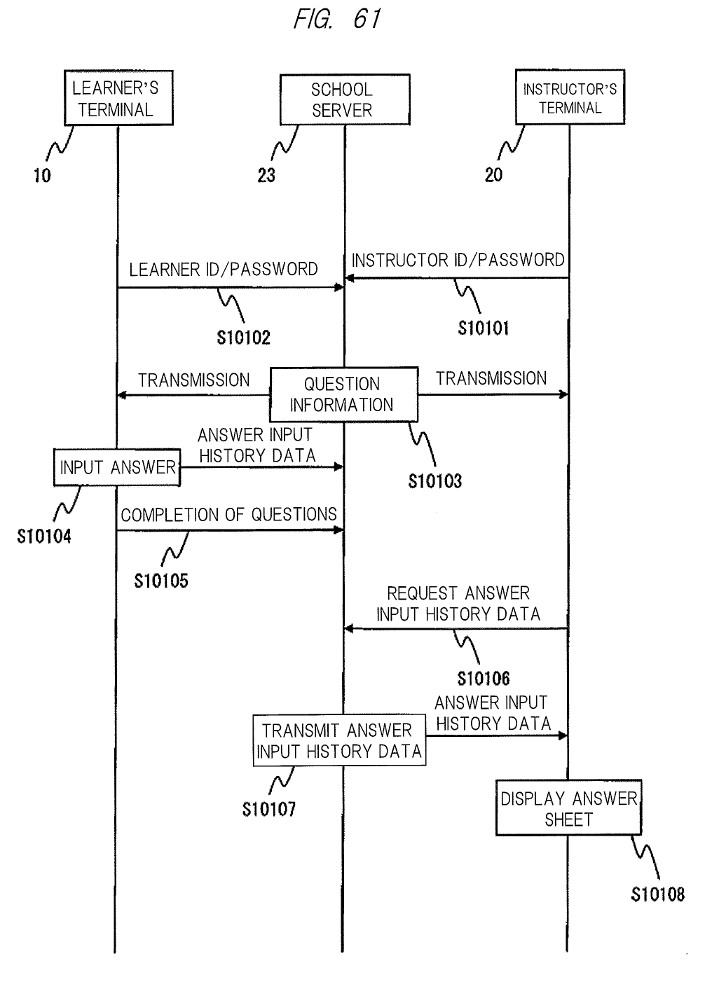

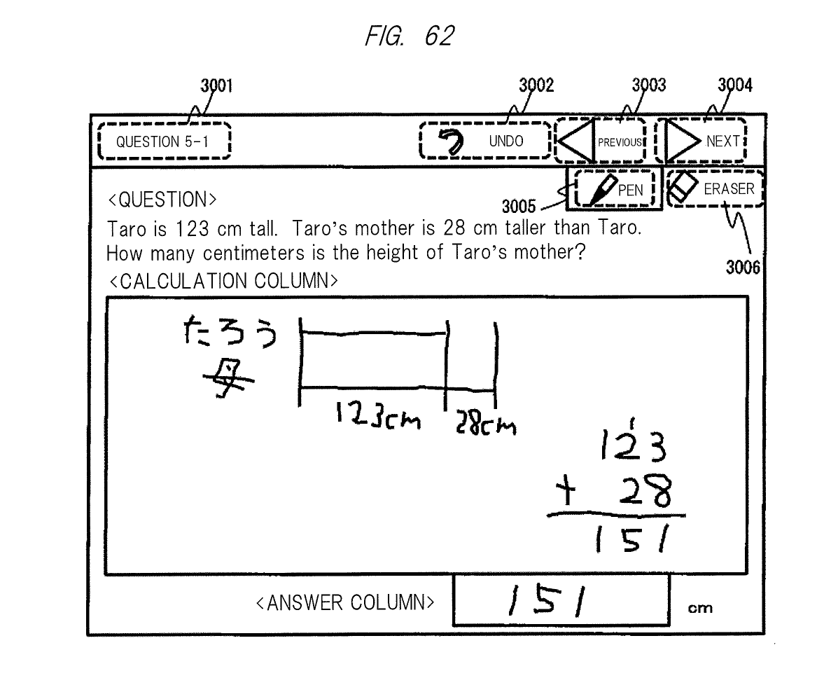

Next, referring to FIGS. 61 and 62, the following description will discuss an answer input history displaying process in which the input history data toward the answer column inputted from the learner's terminal 10 are transmitted to the school server 23 so that based upon the input history data inputted by the learner's terminal 10, the instructor's terminal 20 displays the answer input history data.

Referring to FIG. 61, the following description will explain one example of the answer input history displaying process of the present embodiment.

First, based upon an operation by an instructor, the instructor ID and the instructor ID-use password are inputted to the instructor's terminal 20, and the instructor's terminal 20 is allowed to log-in the school server 23 through the network 2 and the network 22 in the school (S10101).

Based upon an operation of a learner, the learner ID and the learner ID-use password are inputted to the learner's terminal 10, and the learner's terminal 10 is allowed to log-in the school server 23 through the home network 62, the network 2 and the network 22 in the school (S10102).

The school server 23 transmits question information corresponding to the learner ID to the learner's terminal 10 and the instructor's terminal 20 (S10103). Then, based upon the received question information, the learner's terminal 10 displays an answer input screen.

An explanation will be hereinbelow given to the answer input screen displayed on the learner's terminal 10.

FIG. 62 is a diagram that shows one example of the answer input screen of the learner's terminal 10 in the present embodiment. On the upper portion on the left side, a question number 3001 of the currently displayed question is displayed. Moreover, on the upper portion on the right side, icons for use in various operations and inputs are displayed. FIG. 62 shows “return” (Undo) icon 3002 for use in returning to the state one step before (that is, in the case of a handwriting input carried out immediately before, returning to the state before the input of one stroke, and in the case of a drawing or editing operation other than this, returning to the state immediately before the operation), “before” icon 3003 for use in moving to one question before, “next” icon 3004 for use in moving to next question, “pen” icon 3005 for use in a handwriting input, and “eraser” icon 3006 for use in erasing a handwriting input and a graphic drawing. Under these icons, pieces of information (sentences, drawings, arithmetic expressions, etc.) for the question currently given are shown, and below the sentence of the question and the drawings, a calculation column and an answer column corresponding to portions where the learner freely executes handwriting inputs are prepared. In the present embodiment, the calculation column and the answer column are displayed in a divided manner; however, these may be given as one answer column without being divided, or another screen configuration may be prepared in which handwriting inputs are available in all the regions other than the question number 3001 and display portions of operation icons on the upper portion (that is, the display portions of “return” (Undo) icon 3002, “before” icon 3003, “next” icon 3004, “pen” icon 3005 and “eraser” icon 3006).

Next, based upon an operation by the learner, an answer is inputted to the learner's terminal 10 from the answer input screen, and the answer input history data are transmitted to the school server 23 so that the school server 23 successively stores the answer input history data (S10104).

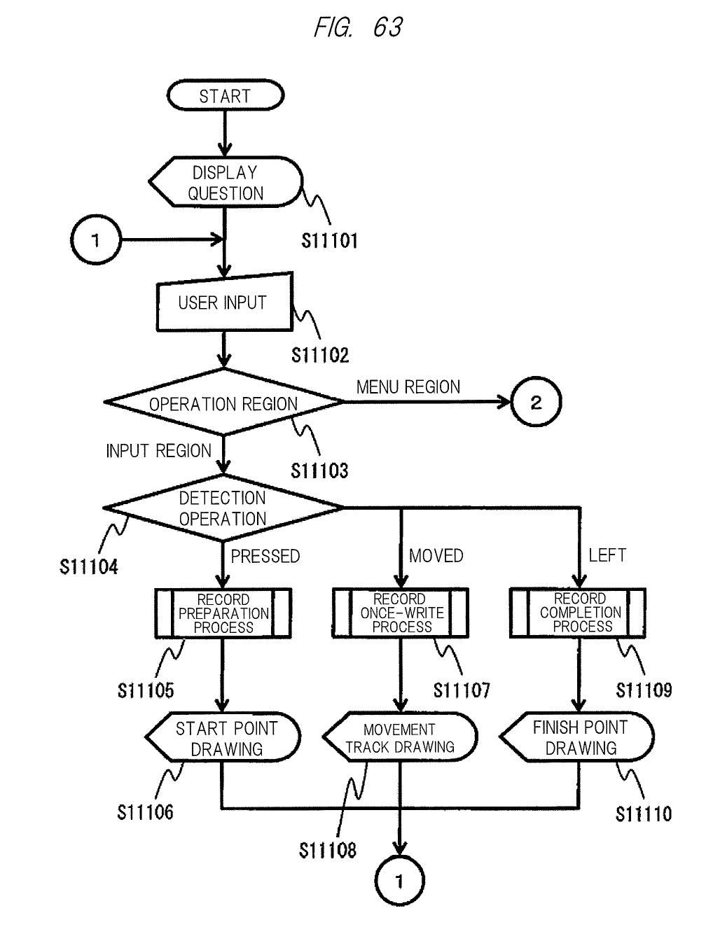

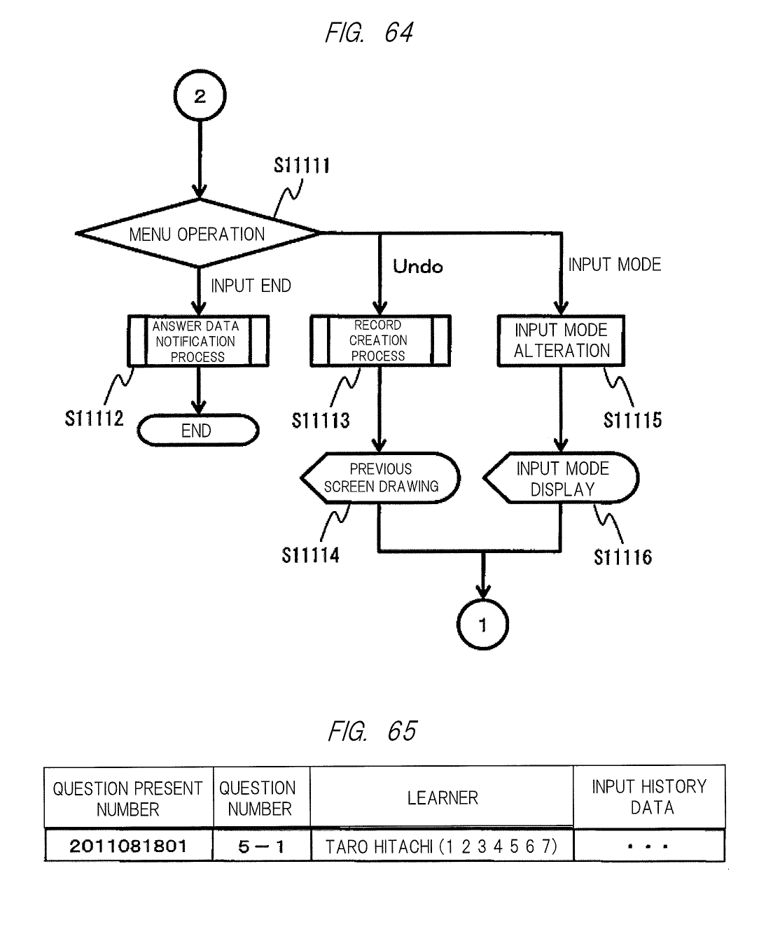

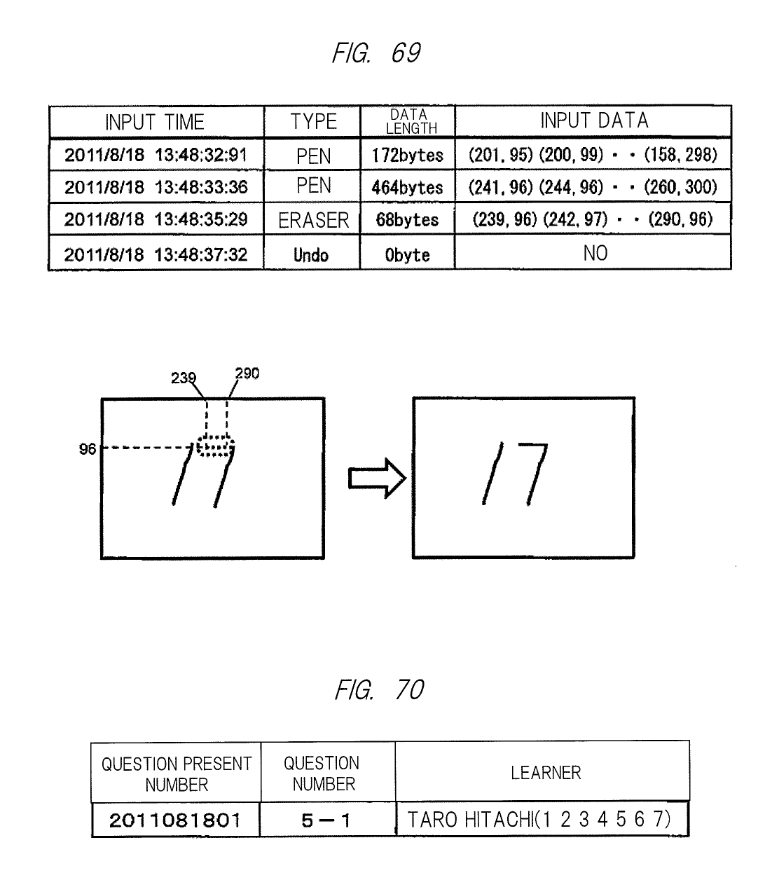

In this case, referring to FIGS. 63, 64, 65, 66, 67, 68 and 69, the following description will discuss the answering process S10104 to be executed by the learner's terminal 10 in detail.

First, the control unit 1005 of the learner's terminal 10 displays the screen explained in FIG. 62 including a question that receives an answer input and operation icons, or the like, on the display unit 1001 of the learner's terminal 10 (S11101).

After completion of the question display on the display unit 1001, the control unit 1005 receives an input from the user through the input unit 1002 (S11102).

Upon receipt of an input from the user, the control unit 1005 determines which region the user input is made at. If the input is made at a portion such as the calculation column, the answer column, or the like, where a handwriting input is freely carried out, the sequence proceeds to step S11104 on the determination that the input has been made in the handwriting input region. Moreover, if the input is made at any one of the icon display area portions (that is, the display region portions, such as “return (Undo)” icon 3002, “before” icon 3003, “next” icon 3004, “pen” icon 3005 and “eraser” icon 3006), which corresponds to an input operation (in the case of a touch device, a touch operation, and in the case of a pointing device, a clocking operation or a pointing movement operation during the clicking), the operation is regarded as a menu operation, and the sequence proceeds to step S11108 (S11103).

In the case when the user input is detected within the input region, the control unit 1005 next refers to the type of the input operation of the user, and calls for an individually different process depending on each of the types (S11104).

In the case when the operation detected at S11104 is “pressed” (that is, in the case of a touch device, the fact that the touch device is touched with a finger is detected, and in the case of a mouse, the fact that the click button is pressed is detected), the answer input history data generation unit 1016 newly forms a record of the input history data that is one configuration element of the answer input history data and carries out an initialization of the record (S11105), the control unit 1005 draws a point at the detected finger position (S11106), and the sequence again returns to S11102 that is an input waiting step from the user.

In the case when the operation detected at S11104 is “moved” (that is, in the case of a touch device, the fact that the position is moved with the touched state being kept is detected, and in the case of a mouse, the fact that the point is moved, with the click button being pressed, is detected), the answer input history data generation unit 1016 once writes the coordinates at a position being touched by the user when the movement is detected as input data (S11107), and draws a straight line connecting the position detected last time to the position detected this time (S11108), and the sequence again returns to S11102 that is an input waiting step from the user.

In the case when the operation detected at S11104 is “left” (that is, in the case of a touch device, the fact that the finger is left from the touch device is detected, and in the case of a mouse, the fact that the click button is left is detected), the answer input history data generation unit 1016 stores the coordinates at a position touched at the last time in the last portion of the input data so that the data size of the input data is stored in “data length” (S11109). Moreover, the control unit 1005 draws a straight line connecting the position detected last time to the position detected this time (S11110), and the sequence again returns to S11102 that is an input waiting step from the user.

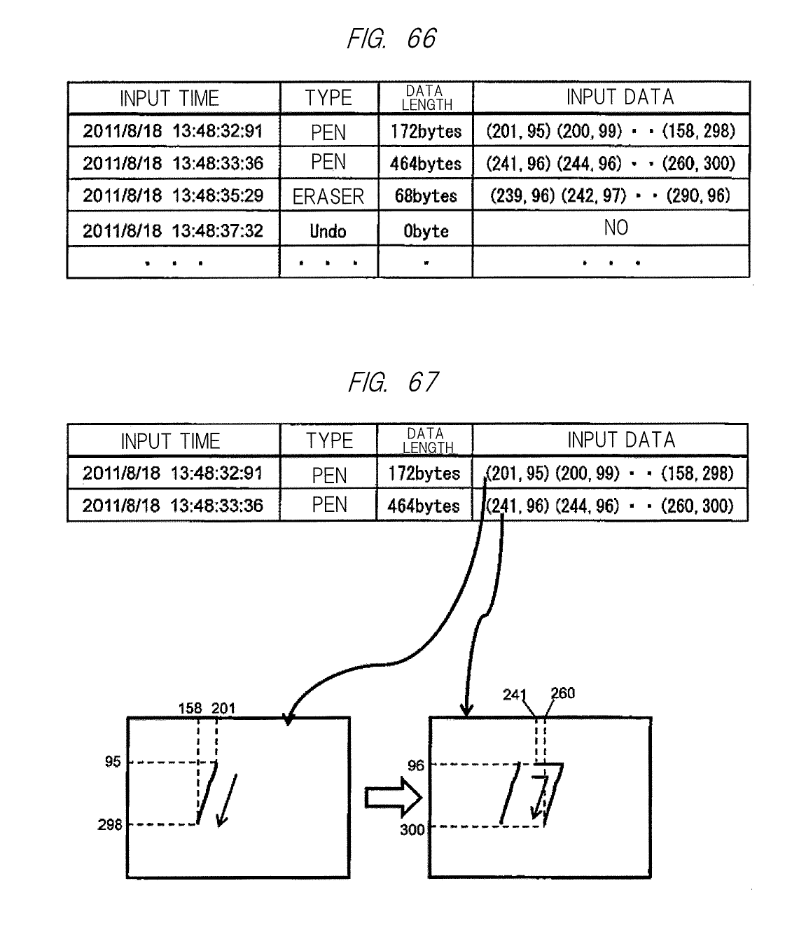

Referring to FIGS. 65 and 66, the following description will discuss a data configuration of the answer input history data.

As shown in FIG. 65, the answer input history data are composed of a question presenting number, a question number, a learner and input history data. The question to be presented consists of one or more questions (quiz), and the question is given as a test, homework, or a practice during a class. Moreover, since there is a case in which completely the same questions are given as in the case of a reexamination, a number that can unanimously identify each of the questions is assigned as the question presenting number. Furthermore, the question number, which is a number for use in specifying which question is concerned among a group of questions that are given, and any number may be used as long as the same question presenting number can identify each of the questions. The learner corresponds to data for use in specifying a learner who inputted an answer, and is prepared as a number, such as a learner ID. Thereafter, the input history data as shown in FIG. 66 are stored.

FIG. 66 represents a configuration of the input history data. The input history data have such a configuration as to maintain one or more records, each composed of “input time” representing the time of an input, “type” representing the type of an input operation, “data length” representing the size of the inputted data and “input data” representing a specific input operation. The “input data” differ from one another depending on the value of “type”, and when the type is “pen”, which represents a handwriting input, the corresponding data are given as an integer value row of an X-coordinate and a Y-coordinate of coordinates formed by a drawn line through which the finger has passed. The coordinates of the present embodiment are prepared as the absolute coordinates in which the pixel located on the uppermost left side of the screen of the display unit 1001 of the learner's terminal 10 is defined as the origin (0, 0) and the pixel located on the lowermost right side of the screen is defined as (1279, 959), with the coordinates on the X-axis in the right direction and the coordinates on the Y-axis in the downward direction being defined as positive. Moreover, the X-coordinate and the Y-coordinate are represented as integers, and with respect to input data, the X-coordinate and the Y-coordinate alternately appear in such a manner as to be indicated by the X-coordinate of the first point, the Y-coordinate of the first point, the X-coordinate of the second point, the Y-coordinate of the second point, and so on, and a data array of integer values is formed with each of the X-coordinates and Y-coordinates being stored as an integer value of 2 bytes. Additionally, in the present embodiment, the absolute coordinates are used as the coordinates; however, data of relative coordinates may be used within a range capable of accepting inputs. Moreover, the coordinates are indicated as integer values; however, decimal fractions may be used.

Next, the following description will discuss the contents of specific processes of the record preparation process S11105, the record once write process S11107 and the record completion process S11109 by exemplifying a case in which, upon writing a figure “1” by the handwriting input, for example, as shown in FIG. 67, first, the finger is put at the coordinates (201, 95), and the finger, as it is, is drawn straightly to the coordinates (158, 298), and the finger is then left.

In the handwriting input, the input is carried out through a sequence in which first, the user touches the screen, and the finger is moved, with the finger being kept in contact with the screen, and the finger is then left from the screen. For this reason, at the time of the handwriting input, when the user touches the screen, the fact of being “pressed” is detected, and thereafter, while the finger is being moved with the finger being kept in contact with the screen, the fact of being “moved” is regularly detected, and when the finger is left from the screen, the fact of being “left” is detected.

Therefore, first, when the finger of the user touches the screen, the fact of being “pressed” is detected, and the record preparation process S11105 is called, and the point of time when the touch of the finger to the input screen is detected is acquired from the time generation unit 1015, with the time being represented by a unit of ms, and the corresponding time is stored in the “input time” of the record of the input history data. Moreover, the input type at that time, that is, the input state at that time is stored as “type”. In the present example, since the input is carried out, with the “pen” icon 3005 being selected, the “type” corresponds to “pen”. Then, the coordinates (201, 95) of the position touched by the finger is stored as “201, 95” as the first data for the input data.

Next, the fact of being “moved” is detected, and the record once write process S11107 is called, and in the case when the position (200, 99) of the finger is found as a position being currently touched, “200, 99” are once written in the last portion of the input data.

Lastly, the fact of being “left” is detected, and the record completion process S11109 is called, and coordinates (158, 298) of the finger corresponding to a position lastly touched are stored as “158, 298” in the last portion of the input data so that the data size of the input data, 172 bytes, which has been so far stored, is stored in the “data length”.

By using the above-mentioned sequence, one record of the input history data by the use of the handwriting input is formed.

Next, the following description will discuss the process S11108 that is called in the case when the operation region is a menu region. As described earlier, in the menu portion of the present embodiment, the icons are displayed, which include “before” icon 3003 and “next” icon 3004 for use in switching questions, “undo” icon 3002 for use in returning to the state one step before and “pen” icon 3005 as well as “eraser” icon 3006 for use in switching the input modes. It is determined which icon of these is pressed (S11108). In the case when “before” icon or “next” icon is pressed so that the answer input is finished, the answer data informing process S11109 is executed. If the “undo” icon is pressed, the record forming process S1110 is executed. Moreover, if the “pen” icon 3005 or “eraser” icon 3006 is pressed, the input mode altering process S11111 is executed.

In the case when the “before” icon 3003 or “next” icon 3004 is pressed, data formed as shown in FIGS. 65 and 66 are converted so as to have a format capable of being transmitted in order to transmit the corresponding data as the answer input history data to the school server 23 through the communication unit 1006 of the learner's terminal 10, and a transferring process to the communication unit 1006 is carried out, thereby completing the present answer input process S10104; thereafter, the same processes are carried out on the question to be next displayed (S11109).

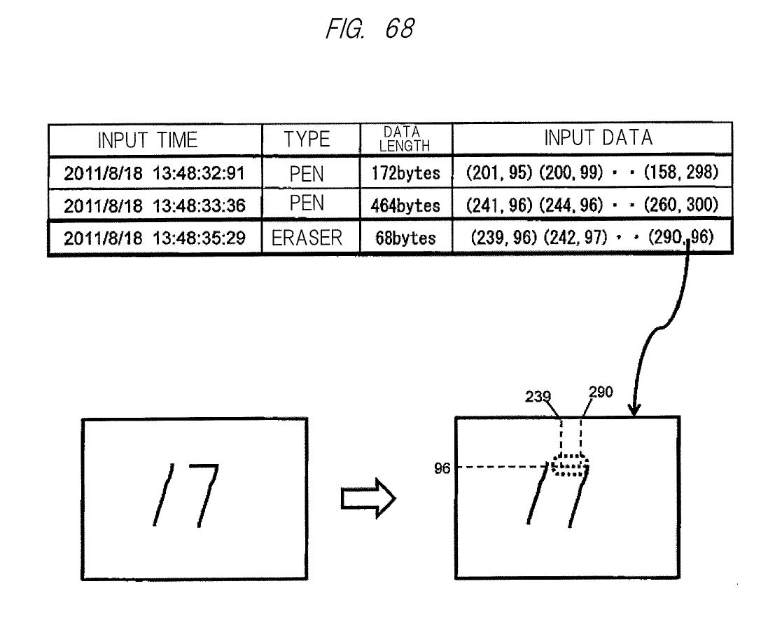

In the case when the “pen” icon 3005 or “eraser” icon 3006 is pressed, the control unit 1005 alters the currently set input mode to the input mode corresponding to the pressed icon, and the sequence returns to S11102 that is an input waiting step from the user (S11111). The input mode immediately after the display of the question is the “pen” mode, and the input process is carried out through the sequence of the handwriting input process as explained before. Even when the “eraser” icon 3006 is pressed so that the “eraser” mode appears, the answer input history data generation unit 1016 generates a record in the same sequence as that of the “pen” mode. Referring to FIGS. 63 and 68, the following description will discuss a process that is used in the case when, as shown in FIG. 68, for example, with “17” being already inputted by the handwriting input, an operation for attempting to erase a side line portion next to “7” is carried out by the use of the “eraser” mode.

Even in the case of the “eraser” mode, when a region touched by the user corresponds to an input region, such as the calculation column or the answer column, the record preparation process S11105, the record once write process S11107 and the record completion process S1109 are executed in accordance with the finger operation of the user.

For example, the following description will discuss a case in which, in order to erase the side line portion, the finger is put on the coordinates indicated by (239, 96), and is then drawn to (290, 96).

First, when the finger touches a portion indicated by coordinates (239, 96), the answer input history data generation unit 1016 sets the point of time obtained by the time generation unit 1015 to “input time” and also sets the data representing the “eraser” mode to the “type”, with 239, 96 being set as data indicating the coordinates first touched by the finger upon inputting data (S11105).

Thereafter, in the case when, while the finger is being laterally moved, the position of the finger next detected corresponds to (242, 97), the answer input history data generation unit 1016 adds “242, 97” to the end portion of the input data (S11106).

Lastly, in the case when the finger is left at a position indicated by (290, 96), the answer input history data generation unit 1016 adds “290, 96” to the end portion of the input data so that “68 bytes” corresponding to the data size of the input data is stored in the “data length”, and the sequence returns to S11102 that is a waiting step for the user input (S11107).

In accordance with the above-mentioned sequence, the operation inputted in the “eraser” mode is also stored as a record. This track portion inputted in the “eraser” mode is displayed, with only the overlapped portions with the results of the handwriting input that has been already made being erased.

In the case when the “return” icon 3002 is pressed, the answer input history data generation unit 1016 sets the point of time obtained by the time generation unit 1015 to “input time” as the time when the fact that the “return” icon 3002 has been pressed is detected, with the “type” being set to “Undo” and the “data length” being set to “0”, so that the input results are reflected to the screen. That is, the inputted track portion is displayed, with only the overlapped portions with the results of the handwriting input that has been already made being erased, and the sequence returns to S11102 that is a waiting step for the user input (S11110).

In accordance with the above-mentioned sequence, the answer input history data are formed in the learner's terminal 10, and transmitted to the school server 23.

Upon completion of answers to all the questions that have been given, the learner's terminal 10 informs the school server 23 of the completion of the questions through the communication unit 1006 (S10105).

In the case when the answer sheet made by the learner is displayed, the instructor's terminal 20 transmits an answer input history data request to the school server 23 through the communication unit 2006 of the instructor's terminal 20 (S10106). As shown in FIG. 70, the answer input history data request to be transmitted from the instructor's terminal 20 is composed of “question presenting number” and “question number” for use in specifying a question, as well as “learner” for use in specifying which learner the answer input history data are requested about.

Upon receipt of the answer input history data request from the instructor's terminal 20, the school server 23 extracts answer input history data that are coincident with all the “question presenting number”, “question number” and “learner” included in the answer input history data request among the answer input history data stored in the answer input history DB unit 2316, and transmits only the corresponding answer input history data to the instructor's terminal 20 (S101017).

Upon receipt of the question data and answer data transmitted from the school server 23 through the communication unit 2006, the instructor's terminal 20 executes an answer sheet display process for generating an answer sheet screen (S10108).

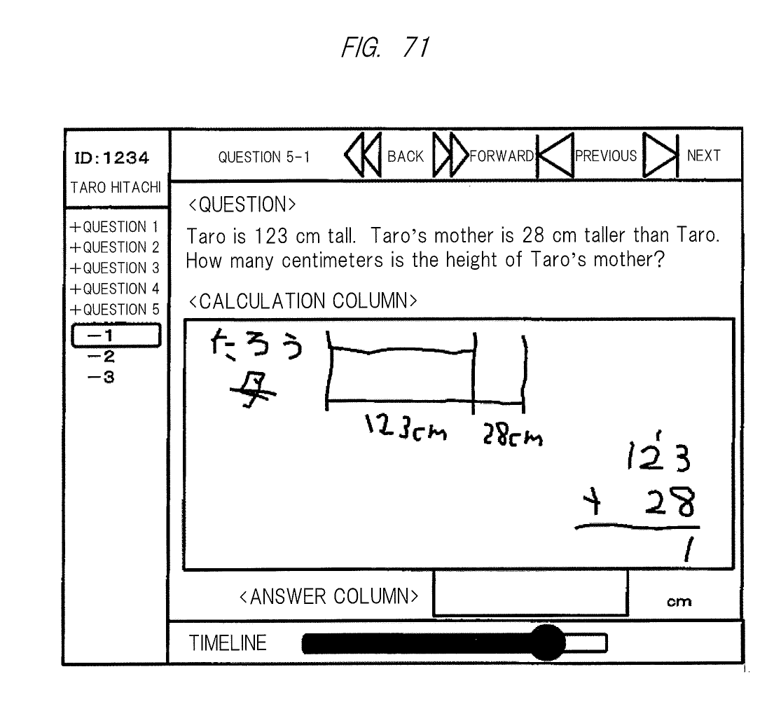

Referring to FIG. 71, the following description will discuss one example of the answer sheet screen generated by the instructor's terminal 20.

In the answer sheet screen displayed on the instructor's terminal 20, the ID and the name of a learner who has submitted the answer sheet are displayed on the upper left portion, and below the portion, a list of a group of questions is displayed in a hierarchical manner. Moreover, the question corresponding to the answer sheet currently displayed is designed to be highlighted.

In the upper center portion of the screen, the question number is displayed, and on the upper portion on the right side of the screen, “next” icon for use in displaying the result of an input of the next operation and “return” icon for use in displaying the state one operation before are displayed as operation icons. Moreover, in the center of the screen, the present question sentence, as well as the calculation column and the answer column inputted by the learner, are displayed. Furthermore, on the lower portion of the screen, such a scroll bar as to show an elapsed time for the answer input relative to the corresponding question is displayed. By moving this scroll bar, the answer input state of the learner for each period of time can be easily switched.

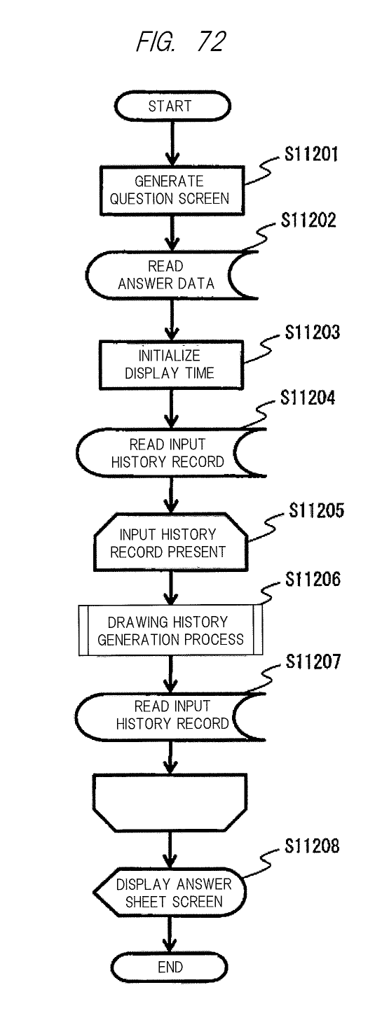

Next, referring to FIG. 72, the following description will discuss a process of the answer sheet display process S10108 in detail.

First, when the answer sheet display process is activated, the answer display generation unit 2015 generates a screen (question screen) other than an answer sheet portion based upon the received question data (S11201).

Next, the answer display generation unit 2015 reads data of a portion prior to the input history data of the received answer data, and confirms whether or not the answer data have been correctly received, or, for example, as to whether or not the question number corresponds to the expected one, or whether or not the learner corresponds to the expected learner (S11202).

Moreover, the answer display generation unit 2015 initializes data for use in calculating the time first inputted and the time that is lastly inputted (S11203).

Thereafter, the answer display generation unit 2015 reads the leading record of the input history data, and when the reading process is succeeded, it sets the first inputted time and the last inputted time as “input time” of the present record. Since each of the records has a variable length size, it carries out reading process of two steps, that is, after once reading a fixed size portion from the “input time” to the “data length”, the remaining “input data” portion is read by referring to the portion of the “data length” (S11204).

If the record can be read from the input history data, the answer display generation unit 2015 executes the input history conversion process S11206 and the input history record reading process S11207, and repeats these processes until reading processes of records are no longer carried out (S11205).

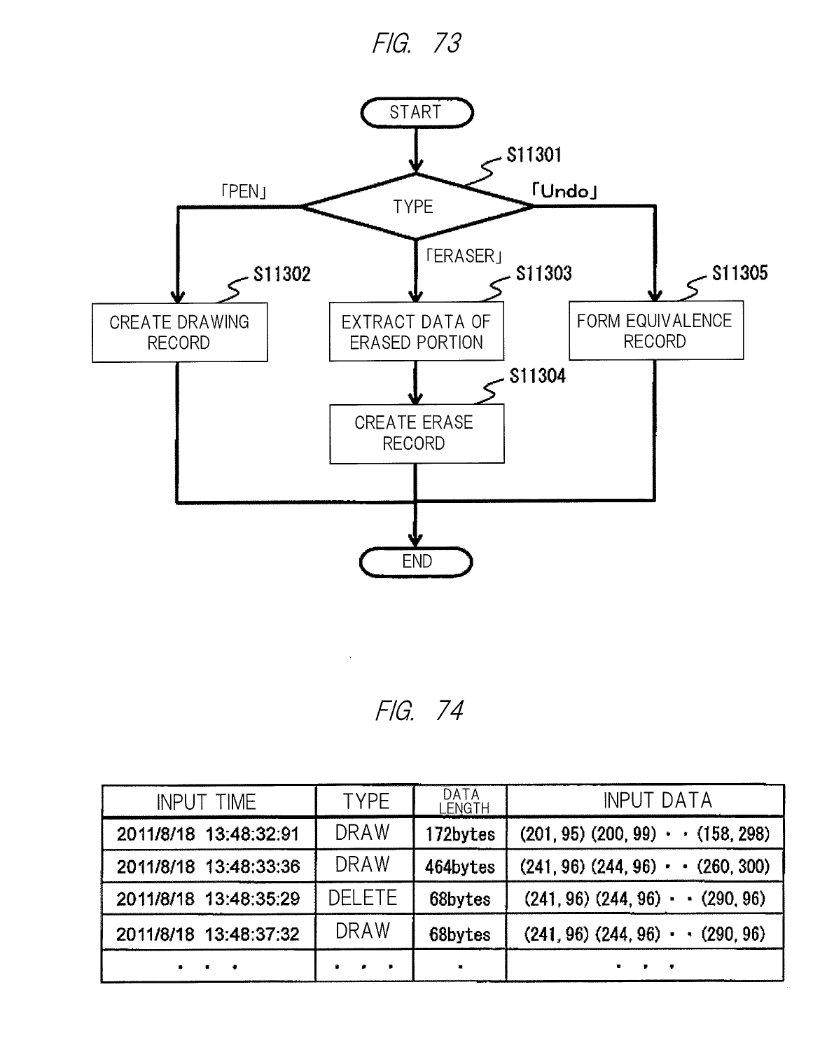

Next, referring to FIGS. 73 and 74, the following description will discuss a drawing history generation process.

In the present process, from the input history record, records of the drawing history data having the same configuration as shown in FIG. 74 are generated. Since the input history data are suitable for forming a screen in the time elapsing direction, but fail to return to the prior screen state because the forming process cannot be carried out without viewing from the first record, a process is prepared for generating the drawing history data having a data configuration suitable for returning to the previous screen. The record of the drawing history data is different from the record of the input history data in that the “type” includes only “drawing” and “deletion”.

First, the answer display generation unit 2015 refers to the “type” of the read record, and different processes are called depending on the values thereof (S11301).

If the “type” is “pen”, the answer display generation unit 2015 reflects the record of the input history data to the screen state, and the “type” is set to “drawing”, with the other “input time”, “data length” and “input data” being set to the same values as those of the record of the input history data, thereby completing the process (S11302).

If the “type” is “eraser”, the answer display generation unit 2015 extracts a portion overlapped with the previous screen state and a trace portion formed by drawing a line with the “eraser” state, that is, an input portion actually erased (S11303).

Moreover, the answer display generation unit 2015 sets the “input time” as the same time as that of the input history data and sets the “type” to the “deletion” so that from the erased portion extracted in S11303, the “data length” and “input data” are generated, thereby completing the process (S11304).

If the “type” is “Undo”, the answer display generation unit 2015 refers to the record of the drawing history data generated one step before, and sets the record value of the input history data as the “input time”, with the “type” being inverted, and the completely same values are set as the “data length” and the “input data”, thereby completing the process (S11305).

Moreover, after executing the drawing history generation process S11206, the answer display generation unit 2015 reads the next record of the input history data, and in the case when the reading process is succeeded, if the acquired “input time” is the time prior to the first inputted time currently maintained, it updates the time, and if the acquired “input time” is the time after the time lastly inputted, the acquired “input time” is set, thereby returning the sequence to the process at S11205 (S11207).

If the reading processes of records are no longer carried out, the answer display generation unit 2015 displays the final answer sheet screen, and by displaying a seek bar (displayed on the lowermost portion in FIG. 71) defining the first input time and the last input time as the start/end, the process is completed (S11208).

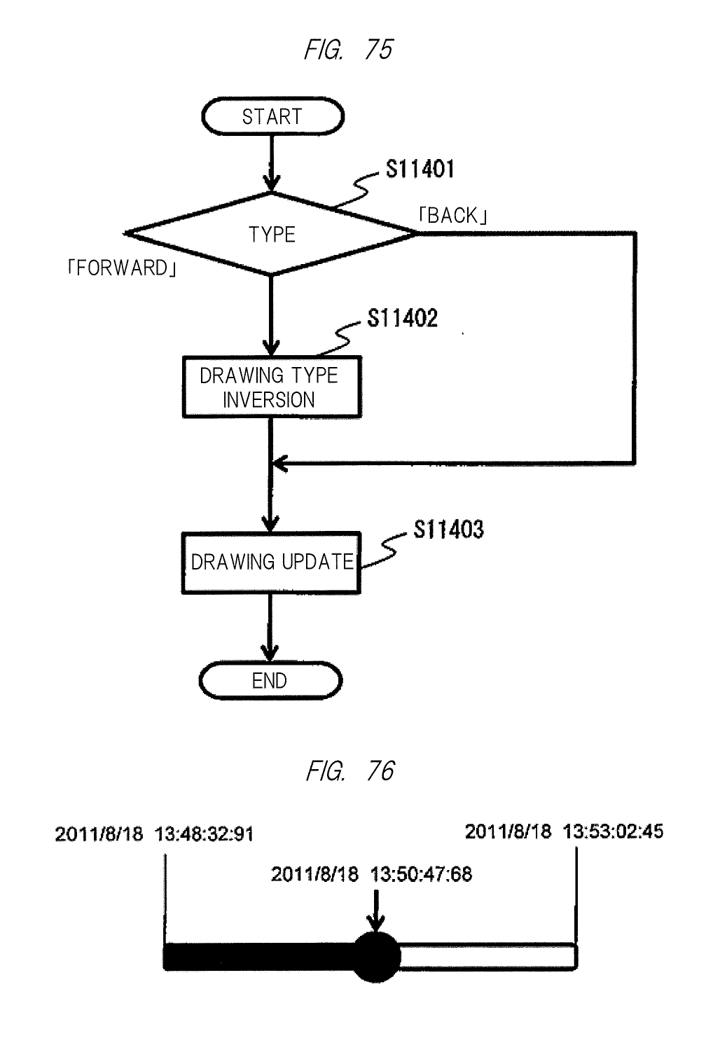

Next, referring to FIG. 75, the following description will discuss an answer sheet display updating process in which, by pressing the “return” icon or “advance” icon on the answer screen thus displayed, an updating process to the input state one step before or the input state one step after is carried out.

First, the answer display generation unit 2015 determines whether the pressed icon is “return” or “advance”. If the “return” is pressed, the answer display generation unit 2015 next executes a drawing type inversion process S11402, and if the “advance” is pressed, it next executes a drawing updating process S11403 (S11401).

If the “return” is pressed, based upon the drawing history data generated in the input history conversion process S1206, the answer display generation unit 2015 inverts the drawing type of the record of the drawing history being executed in the currently displayed screen (in the case of “drawing”, this is changed to “deletion”, while in the case of “deletion”, this is changed to “drawing”), and transmits the resulting data to the next drawing updating process (S11402).

Lastly, in the case when the “type” is “drawing”, the answer display generation unit 2015 additionally carries out a drawing process on the present screen in accordance with the input data based upon the record of the drawing updating data thus transmitted thereto, and in the case when the “type” is “deletion”, it carries out deleting process on the drawing portion corresponding to the input data, thereby completing the process (S11403).

In accordance with the above-mentioned sequence, it is possible to alter the screen into the screen state one step before or into the screen state one step later.

Moreover, in the present embodiment, it is also possible to alter the answer input state by using the seek bar on the lower portion of the screen.

For example, as shown in FIG. 76, in the case when the user touches the right center portion of the seek bar, it is possible to display an answer sheet screen inputted at the point of time, that is, 2011/8/18 13:50:47:68, corresponding to the point of time located just middle of the first answer input time (2011/8/18 13:48:32:91) and the last answer input time (2011/8/18 13:53:02:45).

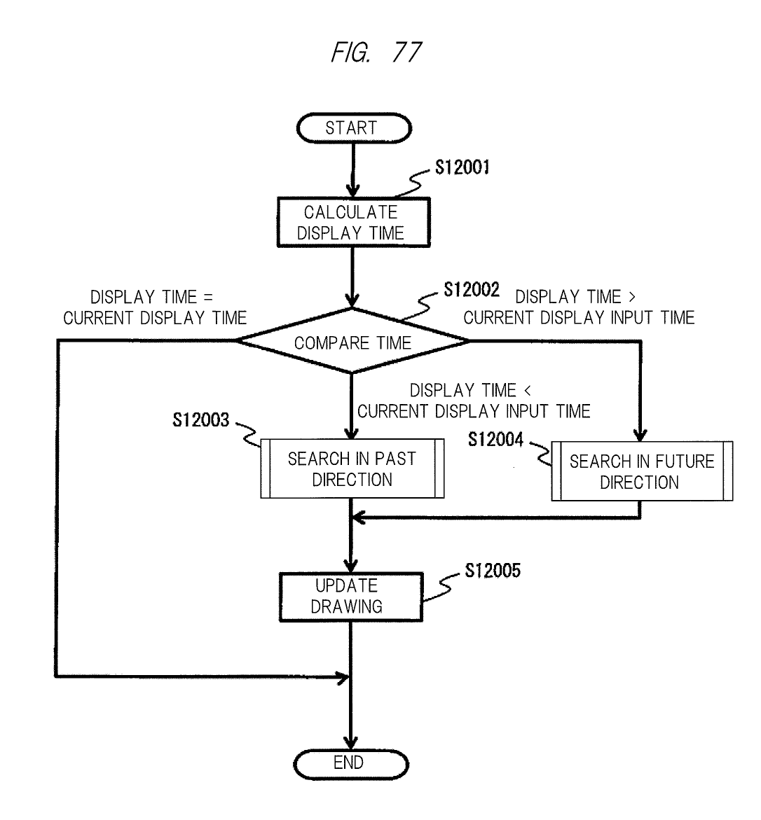

Next, referring to FIG. 77, the following description will discuss an answer sheet display seek updating process in which the answer sheet display is altered in accordance with the position of the seek bar.

The present process is called each time the user operates the seek bar.

First, the answer display generation unit 2015 reads out the position set by the seek bar from the input unit 1002, and acquires which position the seek bar is set. Moreover, the answer display generation unit 2015 calculates the set display time from the acquired position (S12001). Additionally, the calculations of the display time are carried out from the following equation, by defining the display time to be found to T, the length of the seek bar to Ls, the position of the seek bar (obtained when the left end of the seek bar is set to 0, with the right end thereof being set to Ls) to Ps, the time when the answer is first inputted to Ts and the time when the answer is last inputted to Te.

T=Ts+(Te−Ts)×Ps/Ls

Next, the answer display generation unit 2015 compares the display time calculated in S12001 and the present display input time (time set by the seek bar) (S12002).

If the result of the comparison is the same (display time=present display input time), the present process is completed without executing any processes.

If the result of the comparison shows that the present display input time is greater than the display time, the answer display generation unit 2015 executes a retrieving process 12100 in the past direction so as to retrieve any input history corresponding to the display time in the past direction from the record of the drawing history data that are currently displayed.

If the result of the comparison shows that the present display input time is smaller than the display time, the answer display generation unit 2015 executes a retrieving process 12200 in the future direction so as to retrieve any input history corresponding to the display time in the future direction from the record of the drawing history data that are currently displayed.

Then, as the result of the past direction retrieving process 12100 or the future direction retrieving process 12200, in the case when the corresponding record is found, the answer display generation unit 2015 executes the drawing process of the record of the drawing history data so far carried out, after the drawing type has been inverted in the case of returning to the past, in the same manner as in the answer sheet display updating process, so that the resulting process is reflected to the screen (S12005).

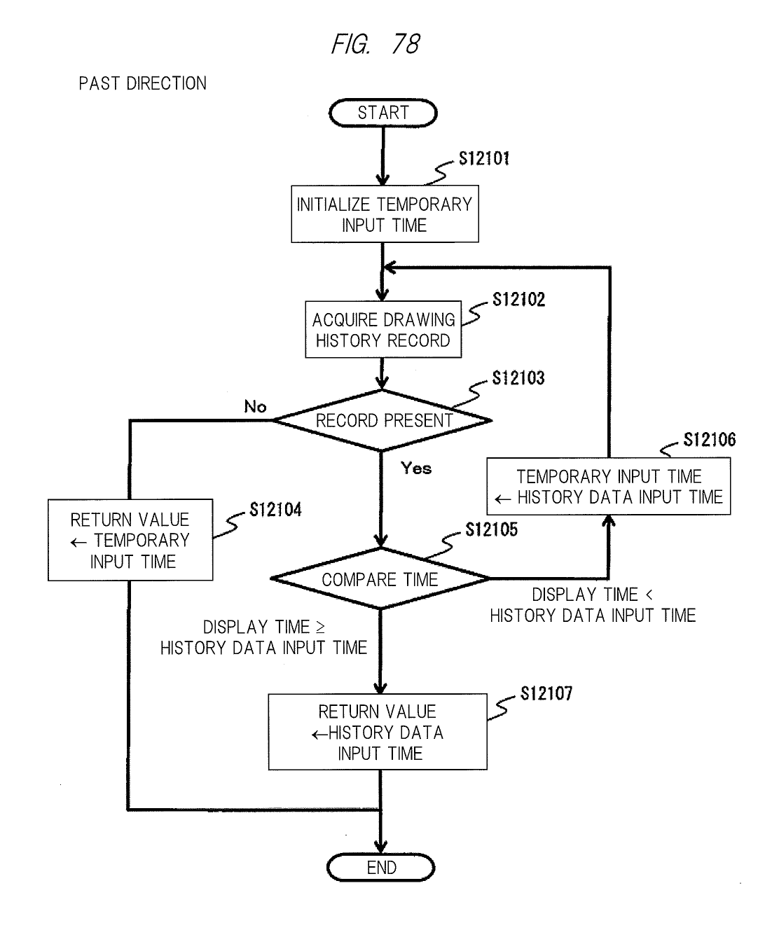

Referring to FIG. 78, the following description will discuss the past direction retrieving process 12100.

First, the answer display generation unit 2015 sets temporary input time to “input time” of the record of the drawing history data that was lastly executed in the answer sheet screen that is currently being displayed (S12101).

Moreover, the answer display generation unit 2015 acquires a record obtained one step before the record of the drawing history data that are currently being referred (S12102), and determines whether or not the record one step before has been acquired (S12103).

If no record one step before is obtained, the answer display generation unit 2015 sets a return value to the temporary input time, thereby completing the present process (S12104).

If the record one step before is obtained, the answer display generation unit 2015 compares the history data input time stored in “input time” of the acquired record and the display time (S12105).

If the result of the comparison of the times shows that the history data input time is greater than the display time, the answer display generation unit 2015 sets the temporary input time to the history data input time, and the sequence returns to the drawing history record acquiring step S12102 (S12106).

If the result of the comparison of the times shows that the history data input time is smaller than the display time, the answer display generation unit 2015 sets a return value to the history data input time, thereby completing the present process (S12107).

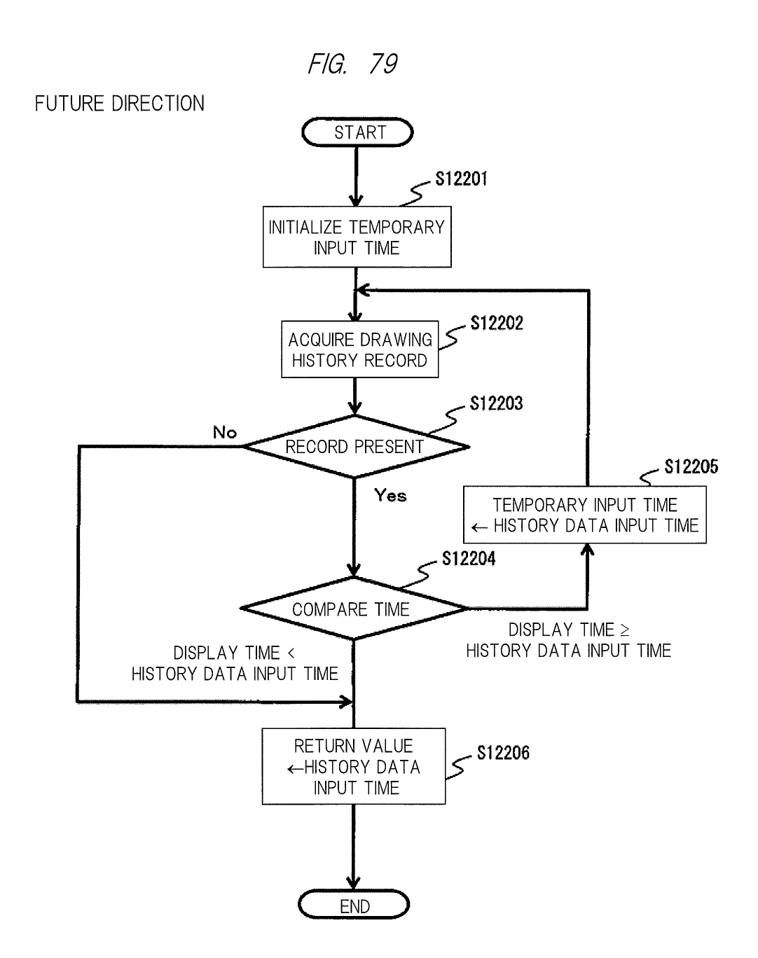

Next, referring to FIG. 79, the following description will discuss the future direction retrieving process 12200.

First, the answer display generation unit 2015 sets temporary input time to “input time” of the record of the drawing history data that was lastly executed in the answer sheet screen, which is currently being displayed (S12201).

Moreover, the answer display generation unit 2015 acquires a record obtained one step later the record of the drawing history data that are currently being referred (S12202), and determines whether or not the record one step later has been acquired (S12203).

If no record one step later is obtained, the answer display generation unit 2015 sets a return value to the temporary input time, thereby completing the present process (S12206).

If the record one step later is obtained, the answer display generation unit 2015 compares the history data input time stored in “input time” of the acquired record and the display time (S12204).

If the result of the comparison of the times shows that the display time is greater than the history data input time, the answer display generation unit 2015 sets the temporary input time to the history data input time, and the sequence returns to the drawing history record acquiring step S12102 (S12205).

If the result of the comparison of the times shows that the display time is less than the history data input time, the answer display generation unit 2015 sets a return value to the temporary input time, thereby completing the present process (S12206).

In accordance with the sequence as described above, based upon the drawing history data, the instructor's terminal 20 updates the answer sheet screen each time the position set by the seek bar is changed.

With this arrangement, by using the seek bar, the instructor is allowed to refer to the answer state freely at a desired point of time so that it is possible to improve user-friendliness for the instructor.

In this manner, the answer input history inputted by the learner through the learner's terminal 10 is stored in the school server 23, and the instructor can confirm the answer input history of the learner through the instructor's terminal 20. Thus, the instructor can confirm how the learner solved the question and made a mistake, or how the learner correctly understood to direct the answer in detail for each of the learners; therefore, the instructor can give an individual instruction more finely, making it possible to improve the learning efficiency of all the learners.

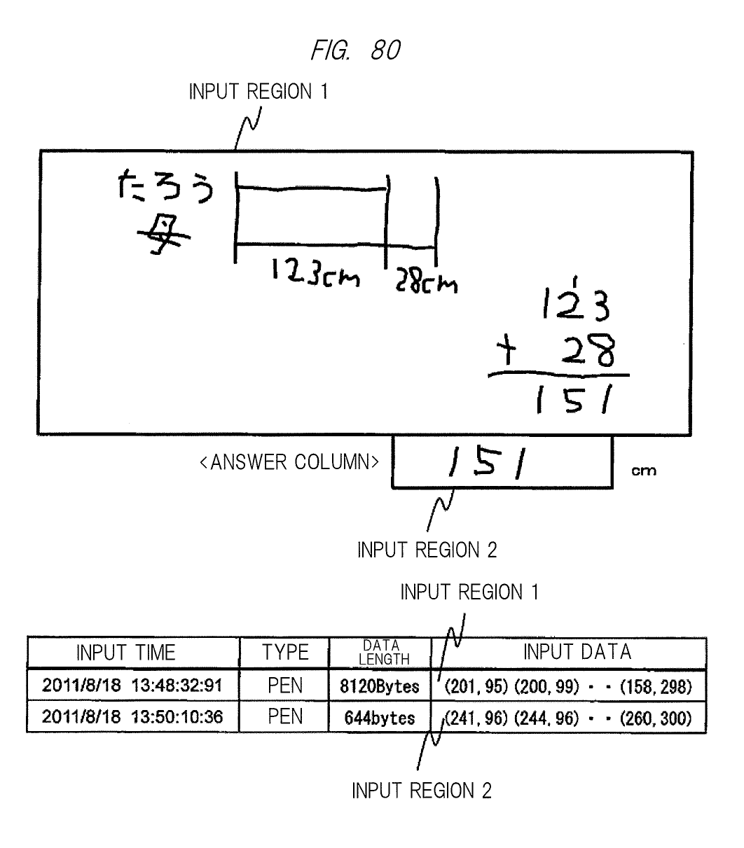

Moreover, the present embodiment has configurations in which data of the handwriting input portion are stored as one record of the input history data for each stroke, and such an operation as to erase by using the “eraser” mode, or as to return to the input state one step before by pressing “Undo” icon 3002 is also stored as the input history data; however, data inputted through the handwriting process may be collected based upon the inputted region (position) so that the handwriting inputs with a plurality of strokes may be gathered into one set of the input history data. For example, as shown in FIG. 80, the resulting method has a configuration in which the region of the calculation column is set to an “input region 1” and the region of the answer column is set to an “input region 2”, and the record of the input history data is generated as the respective input history data including the final result inputted in the input region 1 and the final result inputted in the input region 2. In addition, as a collecting method, input histories prior to specific operations such as periods up to a menu operation and up to an operation icon pressing process are collected into one history, or input histories are gathered as a meaningful set, that is, data are gathered for each stroke, such as a figure or a character by using image and character recognizing processes. The generating process of the input history data of this type may be carried out in the answer input history data generation unit 1016 of the learner's terminal 10, or may be carried out in the answer input history data processing unit 2315 upon storing the answer input history data transmitted from the learner's terminal 10 in the answer input history DE unit 2316 of the school server 23, or may be carried out in the answer input history data processing unit 2315 upon transmitting the answer input history data from the school server 23 to the instructor's terminal 20. By using this configuration, the input history data can be integrated so that the data size of the answer input history data to be generated can be miniaturized and the data size transmitted and received through the network can be consequently reduced; thus, it becomes possible to effectively reduce the load imposed on the network.

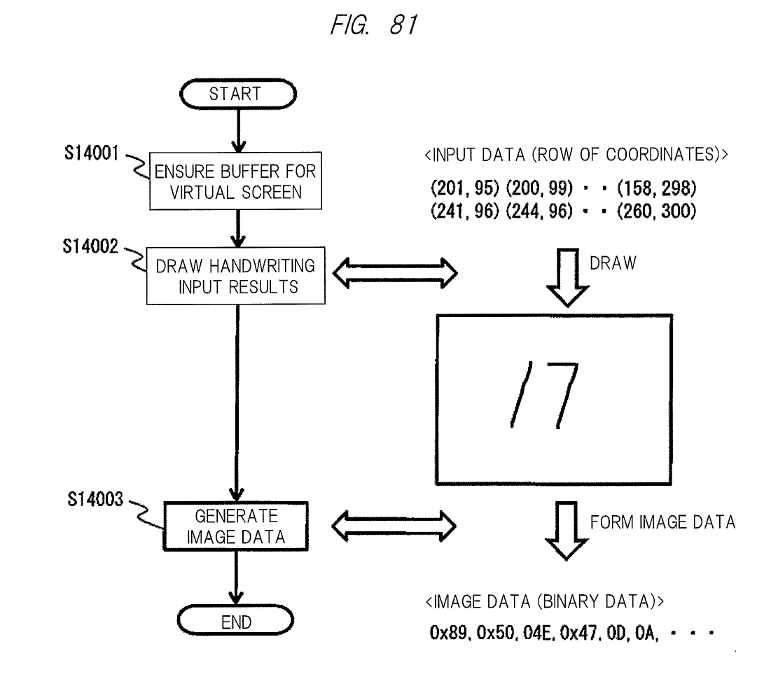

Moreover, in the present embodiment, the input data are represented as rows of coordinates; however, the input data may be maintained not by the rows of coordinates, but by image data derived from the drawing results, and a handwriting input result imaging process for generating the answer input history data may be carried out. In the handwriting result imaging process, as shown in FIG. 81, first, the answer input history data generation unit 1016 maintains a virtual screen buffer serving as a working area in which a conversion into image data is carried out (S14001). Then, based upon data made of rows of coordinates, the answer input history data generation unit 1016 carries out a drawing process on the virtual screen buffer thus maintained (S14002). Moreover, based upon the data stored in the virtual screen buffer, the answer input history data generation unit 1016 carries out a conversion process into image format data, such as PNG (Portable Network Graphics) and JPEG (Joint Photographic Expert Group) (S14003).

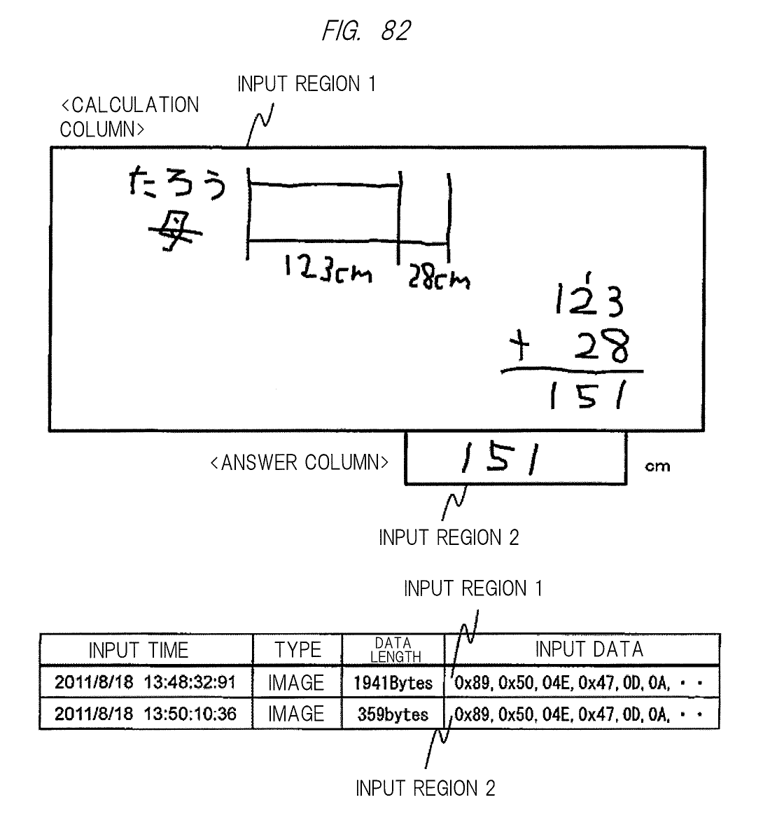

Moreover, as shown in FIG. 82, with respect to image data generated by the handwriting input imaging process, by setting the image data as the “input data” of the input history data, as well as setting an image as the “type”, the “input data” of the input history data can be replaced by image data. With this arrangement, upon collecting the aforementioned plural handwriting inputs into one set, by applying the present handwriting result imaging process, it becomes possible to more effectively reduce input data.

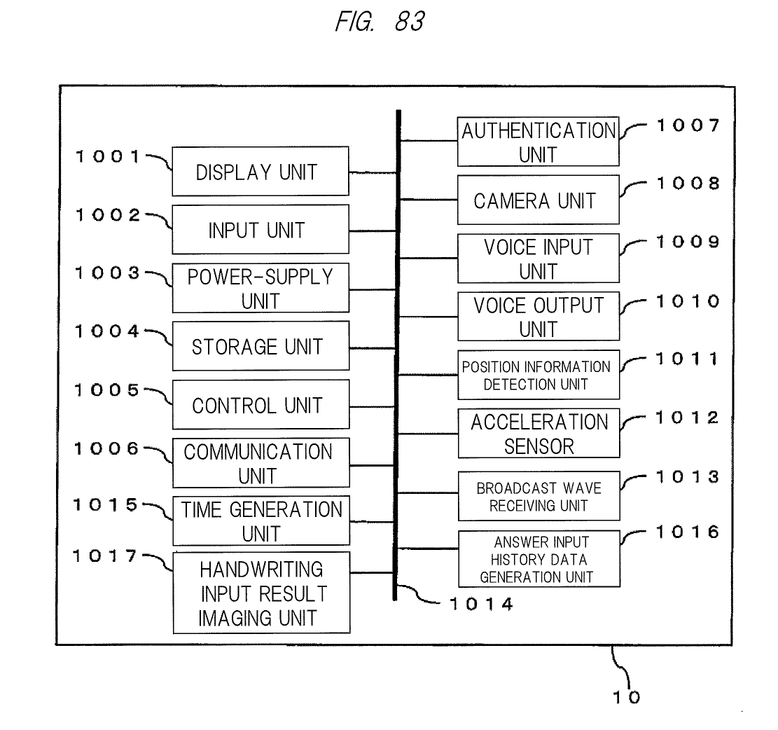

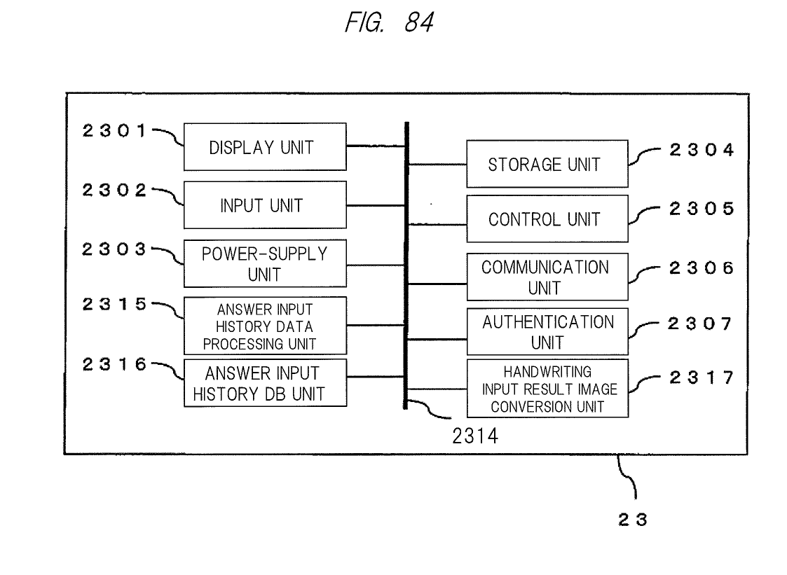

As shown in FIG. 83, the present handwriting input result imaging process may have a configuration in which, by adding the handwriting input imaging unit 1017 to the learner's terminal 10, the handwriting input imaging unit 1017 is used for executing processes, with the corresponding process being called from the answer input history data generation unit 1016. Moreover, as shown in FIG. 84, a configuration may be used in which, by adding a handwriting image conversion unit 2317 to the school server 23, the handwriting input result imaging process is executed by the handwriting image conversion unit 2317 so that upon storing the resulting data in the answer input history DB unit 2316 by using the answer input history data processing unit 2315, the input data may be formed into images by the handwriting image conversion unit 2317 and stored therein, or another configuration may be used in which upon transmitting the answer input history data in response to a request from the instructor's terminal 20, the input data are converted to image data by the handwriting image conversion unit 2317 and transmitted. Since these configurations can reduce the size of the answer input history data, it becomes possible to effectively reduce the load imposed onto the network. Moreover, upon carrying out the handwriting result imaging process in the learner's terminal 10 or upon storing into the answer input history DB unit 2316 in the school server 23, the writing input result imaging process is carried out so that the data size of the answer input history data to be stored in the school server 23 can be reduced, thereby making it possible to effectively realize the method by using less resources.

Moreover, another configuration may be used in which input type information is added to the question information held by the school server 23 so that in accordance with the input type information, the input result imaging process may be applied or may not be applied depending on each of questions. For example, in the case of a dictation question of Chinese characters or a dictation question of alphabets, since the stroke order is important, data for each of the strokes are required; however, in the case of a sentence question of the arithmetic or the like other than these, the detailed order of the strokes is unnecessary upon confirming the degree of understanding of the learner. By using this configuration, it is possible to effectively reduce the data size of answer data, while dealing with all sorts of questions for all subjects.

Additionally, the present invention is not intended to be limited by the above-mentioned respective embodiments, and various modifications may be made therein. For example, the above-mentioned respective embodiments are detailed explanations for use in clarifying the present invention, and are not necessarily limited to a configuration provided with all the configurations explained above. Moreover, one of configurations of a certain embodiment may be replaced by the configuration of another embodiment, or to the configuration of a certain embodiment, a configuration of another embodiment may be added. Furthermore, with respect to one of the configurations of the respective embodiments, another configuration may be added thereto, deleted therefrom, or replaced therewith.

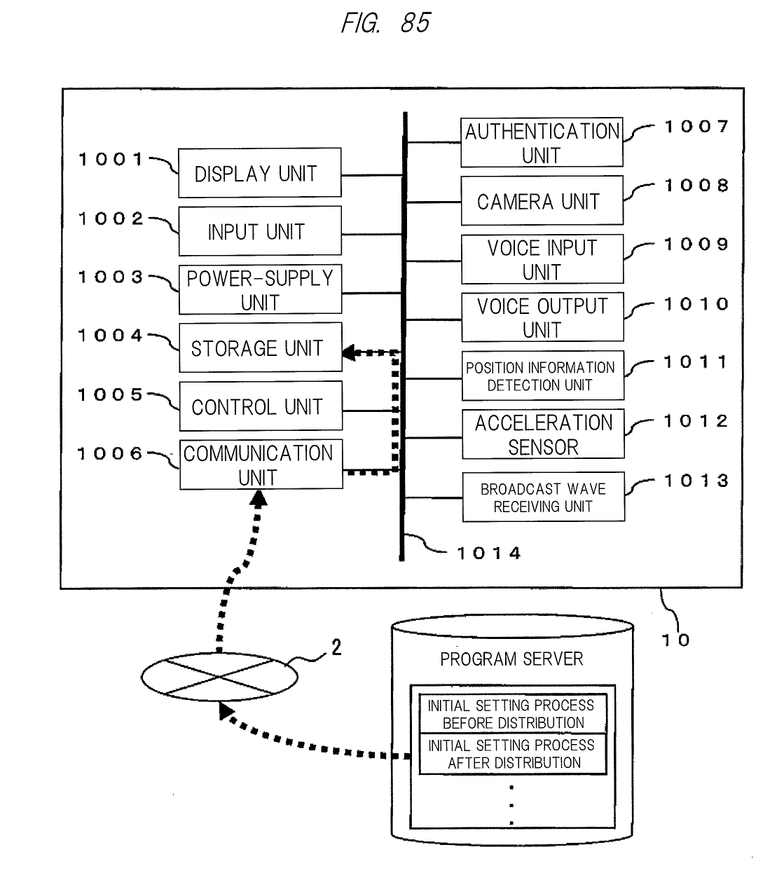

Moreover, with respect to the respective configurations, functions, processing means and the like, one portion or all the portions may be realized by using hardware, for example, by designing them using integrated circuits. Furthermore, the above-mentioned respective configurations, functions and the like may be realized by software by allowing a processor to interpret and execute programs for use in realizing the respective functions. Pieces of information such as programs, tables, files or the like for use in realizing the respective functions may be placed on a recording device, such as a memory, a hard disk, an SSD (Solid State Drive), or the like, or on a recording medium such as an IC card, an SD card, a DVD or the like. Additionally, as shown in FIG. 85, a program or the like for realizing the respective functions may be duplicated in a server or the like, and may be supplied to the learner's terminal 10, the instructor's terminal 20, the electronic blackboard 21 or other terminals, devices and apparatuses, or the like, through a cable and wireless communication line, or the like. In this case, the user can download a necessary program, etc. from the server or the like, by operating a terminal or the like so as to be installed in a storage unit of the terminal, etc.

Moreover, with respect to the control lines and information lines, only those considered to be required for explanations are illustrated, and all the control lines and information lines on products are not necessarily shown. It may be considered that in fact, almost all the configurations are mutually connected to one another.
2 Network
10 Learner's terminal
20 Instructor's terminal
22 Network in school
23 School server
43 Publisher server
53 Administration server
60 Parent's terminal
62 Home network
73 Cram-school server

1. An education supporting system comprising: a learner's terminal to be used by a learner, an instructor's terminal to be used by an instructor and a school server capable of communicating with the learner's terminal and the instructor's terminal,
wherein the learner's terminal includes:
a time-acquiring unit for acquiring time;
an input unit capable of accepting hand-writing input; and
an answer-input history data notifying unit for notifying the school server of the time acquired by the time-acquiring unit and the hand-writing input data inputted thereto through the input unit as answer input history data, and
the school server includes:
an answer input history data storage unit for storing the answer input history data notified by the learner's terminal; and
an answer input history data transmitting unit for transmitting the answer input history data stored by the answer input history data storage unit to the instructor's terminal, and
the instructor's terminal includes an answer screen display unit for displaying a screen at the time of answering in time series based upon the answer input history data transmitted by the answer input history data transmitting unit.

2. The education supporting system according to claim 1, wherein the handwriting input data notified by the answer input history data notifying unit are represented by input data composed of a row of coordinates for each stroke.

3. The education supporting system according to claim 1, wherein the handwriting input data notified by the answer input history data notifying unit are represented as input data derived from an image obtained by a hand-writing input result imaging unit.

4. The education supporting system according to claim 3, wherein the handwriting input data notified by the answer input history data notifying unit are represented by input data composed of a row of coordinates for each stroke, or represented by input data derived from an image obtained by the hand-writing input result imaging unit, depending on types of questions.

5. The education supporting system according to claim 3, wherein the hand-writing input result imaging unit represents input results inputted prior to the next menu operation as image data.

6. The education supporting system according to claim 3, wherein the hand-writing input result imaging unit carries out a dividing process into each of specified regions, and represents the results thereof as image data.

7. The education supporting system according to claim 3, wherein the hand-writing input result imaging unit carries out the dividing process for each of meaningful sets based upon character recognition results, and outputs the resulting data as an image.

8. The education supporting system according to claim 1, wherein, of the answer data stored in the answer input history data storage unit, a hand-writing input data portion is represented as a row of coordinates for each stroke.

9. The education supporting system according to claim 1, wherein, of the answer data stored in the answer input history data storage unit, a hand-writing input data portion is represented as image data obtained by a hand-writing input result image conversion unit.

10. The education supporting system according to claim 9, wherein, of the answer data stored in the answer input history data storage unit, a hand-writing input data portion is represented as a row of coordinates for each stroke, or represented as image data obtained by the hand-writing input result image conversion unit, depending on types of questions.

11. The education supporting system according to claim 9, wherein the hand-writing input result image conversion unit represents input results inputted prior to the next menu operation as image data.

12. The education supporting system according to claim 9, wherein the hand-writing input result image conversion unit carries out a dividing process into each of specified regions, and represents the results thereof as image data.

13. The education supporting system according to claim 9, wherein the hand-writing input result image conversion unit carries out the dividing process for each of meaningful sets based upon character recognition results, and outputs the resulting data as an image.

14. An information terminal capable of displaying question information comprising:
a time-acquiring unit for acquiring time,
an input unit capable of accepting hand-writing input, and
an answer-input history data notifying unit for notifying a server of the time acquired by the time-acquiring unit and the hand-writing input data inputted thereto by the input unit.

15. The information terminal according to claim 14, wherein the handwriting input data notified by the answer input history data notifying unit are represented by a row of coordinates for each stroke as input data.

16. The information terminal according to claim 14, wherein the handwriting input data notified by the answer input history data notifying unit are represented as input data derived from an image obtained by a hand-writing input result imaging unit.

17. An information terminal connected to a server and capable of displaying question information and learner information, the information terminal comprising:
an answer input history data requesting unit for requesting answer input history data corresponding to a specified user to the server;
an answer input history data receiving unit for receiving answer input history data transmitted from the server; and
an answer screen display unit for displaying an answer screen based upon the received answer input history data.

18. The information terminal according to claim 17, wherein the answer screen display unit is allowed to advance or return the history of the inputted answer based upon an operation of the user.

19. The information terminal according to claim 17, wherein the answer screen display unit also displays a seek bar that specifies a desired point of time within a range in which the answer was inputted so that an answer sheet screen during an answering process at the point of time specified by the seek bar is displayed.
